(19) United States
(12) Patent Application Publication
(10) Pub. No.: US 2013/0081146 A1
(43) Pub. Date: Mar. 28, 2013

(54) APPARATUS, SYSTEM, AND METHOD OF CONTROLLING ELECTRONIC DATA AND RECORDING MEDIUM STORING DATA CONTROL PROGRAM

(71) Applicant: Hironori HAKOZAKI, Kanagawa (JP)

(72) Inventor: Hironori HAKOZAKI, Kanagawa (JP)

(73) Assignee: RICOH COMPANY, LTD., Tokyo (JP)

(21) Appl. No.: 13/604,448

(22) Filed: Sep. 5, 2012

(30) Foreign Application Priority Data
Sep. 27, 2011 (JP) 2011-211065

(51) Int. Cl. G06F 21/24

(52) U.S. Cl. 726/28

(57) ABSTRACT

A data control apparatus, a data control system, a data control method, and a data control program stored in a recording medium, are provided each of which allows a user to obtain electronic data stored in a storage apparatus in a data format compatible with a specific apparatus currently operated by the user or specific application of the electronic data that may be requested by the specific apparatus.

### CROSS-REFERENCE TO RELATED APPLICATIONS

This patent application is based on and claims priority pursuant to 35 U.S.C. §119 to Japanese Patent Application No. 2011-211065, filed on Sep. 27, 2011, in the Japan Patent Office, the entire disclosure of which is hereby incorporated herein by reference.

### BACKGROUND

1. Field

The present invention generally relates to a data control apparatus, a data control system, a data control method, and a data control program stored in a recording medium, and more specifically to an apparatus, system, method, and program stored in a recording medium each of which is capable of controlling electronic data available on a network.

2. Background

The recent network systems allow a user to use various services such as infrastructure services, platform development services, application services, or storage services, through a network. For example, the user may store electronic data on the network using data storage services, instead of storing such data in a local memory.

The storage services do not necessarily provide the same services or functions to the user. For example, the storage services include a storage service storing data generated by a user, a storage service storing email data to be transmitted, and a storage service storing image data to be shared by a group of users. Since data formats of the electronic data stored on the network vary, the user may need to convert the electronic data obtained from the network before processing the electronic data. For example, when the user wants to print the electronic data stored on the network, the user may need to convert the electronic data to print data that is applicable to printing, as the electronic data may be stored in a data format that is not interpretable by a printer. In another example, even when the user wants to view the electronic data stored on the network, some devices may not be able to display the electronic data unless application that can interpret a data format of the electronic data is installed.

### SUMMARY

As described above, unless the user is able to use the electronic data stored on the network irrespective of a type or capability of a device currently operated by the user or specific application of the electronic data requested by the user, the user may feel inconvenient to use the data storage services.

In view of the above, one aspect of the present invention is to provide a data control apparatus, a data control system, a data control method, and a data control program stored in a recording medium, each of which allows a user to obtain electronic data stored in a storage apparatus in a data format compatible with a specific apparatus currently operated by the user or specific application of the electronic data that may be requested by the specific apparatus.

According to one aspect of the present invention, a first controller is provided, which communicates with at least a second controller such that the first and second controllers are cooperatively configured to: obtain first authentication information of at least one of a plurality of users from an information processing apparatus through a network; obtain second authentication information of the at least one of the plurality of users using association data indicating an association between first authentication information and second authentication information for each of the plurality of users, the second authentication information being associated with the obtained first authentication information of the at least one of the plurality of users; obtain electronic data associated with the second authentication information of the at least one of the plurality of users using electronic data stored in a storage apparatus; determine a data format of the obtained electronic data, the determined data format of the obtained electronic data being compatible with the information processing apparatus; and control a process of converting the obtained electronic data to cause the obtained electronic data to have the determined data format.

According to one aspect of the present invention, a controller apparatus connected to a storage apparatus that stores electronic data, includes: a network interface configured to obtain first authentication information of the at least one of the plurality of users from an information processing apparatus through a network; and a processor configured to: obtain second authentication information of the at least one of the plurality of users using association data indicating an association between first authentication information and second authentication information for each of the plurality of users, the second authentication information being associated with the obtained first authentication information of the at least one of the plurality of users; obtain electronic data associated with the second authentication information of the at least one of the plurality of users using the electronic data stored in the storage apparatus; determine a data format of the obtained electronic data, the determined data format of the obtained electronic data being compatible with the information processing apparatus; and control a process of converting the obtained electronic data to cause the obtained electronic data to have the determined data format.

According to one aspect of the present invention, a controller apparatus includes: a first network interface configured to exchange data with an authentication apparatus; a second network interface configured to exchange data with a data storage apparatus that stores electronic data; and a first processor configured to share processing with a second processor of the authentication apparatus, each processor performing a portion of the processing so that together the first and second processors are configured to: (1) obtain first authentication information of at least one of a plurality of users from an information processing apparatus through a network; and (2) obtain second authentication information of the at least one of the plurality of users using association data indicating an association between first authentication information and second authentication information for each of the plurality of users, the second authentication information being associated with the obtained first authentication information of the at least one of the plurality of users, wherein the first processor is further configured to share processing with a third processor of the data storage apparatus, each processor performing a portion of the processing so that together the first and third processors are configured to: (3) obtain electronic data associated with the second authentication information of the at least one of the plurality of users using the electronic data stored in the storage apparatus; (4) determine a data format of the obtained electronic data, the determined data format of the obtained electronic data being compatible with the information processing apparatus; and (5) control a process of converting the obtained electronic data to cause the obtained electronic data to have the determined data format.

According to one aspect of the present invention, a data control system includes: at least a first controller and a second controller, the at least first and second controllers configured to communicate such that the at least first and second controllers are cooperatively configured to, obtain first authentication information of at least one of a plurality of users from an information processing apparatus through a network, obtain second authentication information of the at least one of the plurality of users using association data indicating an association between first authentication information and second authentication information for each of the plurality of users, the second authentication information being associated with the obtained first authentication information of the at least one of the plurality of users, obtain electronic data associated with the second authentication information of the at least one of the plurality of users using electronic data stored in a storage apparatus, determine a data format of the obtained electronic data, the determined data format of the obtained electronic data being compatible with the information processing apparatus, and control a process of converting the obtained electronic data to cause the obtained electronic data to have the determined data format.

According to one aspect of the present invention, a data control system includes: a storage apparatus configured to store electronic data; and a controller apparatus connected to the storage apparatus through a network, the controller apparatus including: a network interface configured to obtain first authentication information of the at least one of the plurality of users from an information processing apparatus through the network; and a processor configured to: obtain second authentication information of the at least one of the plurality of users using association data indicating an association between first authentication information and second authentication information for each of the plurality of users, the second authentication information being associated with the obtained first authentication information of the at least one of the plurality of users; obtain electronic data associated with the second authentication information of the at least one of the plurality of users using the electronic data stored in the storage apparatus; determine a data format of the obtained electronic data, the determined data format of the obtained electronic data being compatible with the information processing apparatus; and control a process of converting the obtained electronic data to cause the obtained electronic data to have the determined data format.

According to one aspect of the present invention, a data control system includes: a data receiving device configured to receive first authentication information of at least one of a plurality of users from an information processing apparatus through a network; a first processing device configured to obtain second authentication information of at least one of the plurality of users using association data indicating an association between first authentication information and second authentication information for each of the plurality of users, the second authentication information being associated with the obtained first authentication information of the at least one of the plurality of users; a second processing device configured to obtain electronic data associated with the second authentication information of the at least one of the plurality of users using electronic data stored in a storage apparatus; and a third processing device configured to determine a data format of the obtained electronic data being compatible with the information processing apparatus, and to control a process of converting the obtained electronic data to cause the obtained electronic data to have the determined data format.

According to one aspect of the present invention, a method of controlling electronic data stored in a storage apparatus includes: obtaining first authentication information of the at least one of the plurality of users from an information processing apparatus through a network; obtaining second authentication information of the at least one of the plurality of users using association data indicating an association between first authentication information and second authentication information for each of the plurality of users, the second authentication information being associated with the obtained first authentication information of the at least one of the plurality of users; obtaining electronic data associated with the second authentication information of the at least one of the plurality of users using the electronic data stored in the storage apparatus; determining a data format of the obtained electronic data, the determined data format of the obtained electronic data being compatible with the information processing apparatus; and control a process of converting the obtained electronic data to cause the obtained electronic data to have the determined data format.

According to one aspect of the present invention, a non-transitory recording medium storing a plurality of instructions which, when executed by a processor, cause the processor to perform a method of controlling electronic data stored in a storage apparatus, the method including: obtaining first authentication information of the at least one of the plurality of users from an information processing apparatus through a network; obtaining second authentication information of the at least one of the plurality of users using association data indicating an association between first authentication information and second authentication information for each of the plurality of users, the second authentication information being associated with the obtained first authentication information of the at least one of the plurality of users; obtaining electronic data associated with the second authentication information of the at least one of the plurality of users using the electronic data stored in the storage apparatus; determining a data format of the obtained electronic data, the determined data format of the obtained electronic data being compatible with the information processing apparatus; and control a process of converting the obtained electronic data to cause the obtained electronic data to have the determined data format.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an illustration of a configuration of a data control system according to an example embodiment of the present invention;

FIG. 2 is a schematic block diagram illustrating a hardware structure of one or more computers of any one of a controller apparatus, a data storage apparatus, and an email storage apparatus of the data control system of any one of FIGS. 1, 17, 24, and 31, according to an example embodiment of the present invention;

FIG. 3 is a schematic block diagram illustrating a hardware structure of an image forming apparatus of the data control system of any one of FIGS. 1, 17, 24, and 31, according to an example embodiment of the present invention;

FIG. 4 is a schematic block diagram illustrating a functional structure of the data control system of FIG. 1 including the image forming apparatus, the controller apparatus, and the data storage apparatus, according to an example embodiment of the present invention;

FIG. 5 is a data sequence diagram illustrating operation of authenticating a user, performed by the data control system of FIG. 1, according to an example embodiment of the present invention;

FIGS. 6A to 6D are example screens displayed through the image forming apparatus of FIG. 4;

FIG. 7 is an example data structure of association data managed by the controller apparatus of FIG. 4;

FIG. 8 is an example data structure of electronic data management information, managed by the data storage apparatus of FIG. 4;

FIGS. 9A to 9D are example screens displayed through the image forming apparatus of FIG. 4, when authentication fails.

FIG. 10 is a data sequence diagram illustrating operation of obtaining a list of electronic data, performed by the data control system of FIG. 1, according to an example embodiment of the present invention;

FIG. 11A is an example data structure of application information managed by the controller apparatus of FIG. 4;

FIG. 11B is an example data structure of conversion data list managed by the controller apparatus of FIG. 4;

FIG. 11C is an example data structure of conversion data format information managed by the controller apparatus of FIG. 4;

FIG. 11D is an example data structure of conversion data list managed by the controller apparatus of FIG. 4;

FIG. 12A is a flowchart illustrating operation of determining whether electronic data is convertible to a data format compatible with specific application, performed by the controller apparatus of FIG. 4, according to an example embodiment of the present invention;

FIG. 12B is a flowchart illustrating operation of determining whether electronic data is convertible to a data format compatible with specific application, performed by the controller apparatus of FIG. 4, according to an example embodiment of the present invention;

FIG. 12C is a flowchart illustrating operation of determining whether electronic data is convertible to a data format compatible with specific application, performed by the controller apparatus of FIG. 4, according to an example embodiment of the present invention;

FIGS. 13A and 13B are a data sequence diagram illustrating operation of obtaining electronic data for further processing at the image forming apparatus, performed by the data control system of FIG. 1, according to an example embodiment of the present invention;

FIG. 14 is a data sequence diagram illustrating operation of authenticating a user, performed by the data control system of FIG. 1, according to an example embodiment of the present invention;

FIG. 15 is a data sequence diagram illustrating operation of obtaining a list of electronic data, performed by the data control system of FIG. 1, according to an example embodiment of the present invention;

FIG. 16 is an example data list screen, displayed through the image forming apparatus of FIG. 4;

FIG. 17 is an illustration of a configuration of a data control system according to an example embodiment of the present invention;

FIG. 18 is a schematic block diagram illustrating a functional structure of the data control system of FIG. 17 including an image forming apparatus, a controller apparatus, and an email storage apparatus, according to an example embodiment of the present invention;

FIG. 19 is a data sequence diagram illustrating operation of storing electronic data to be processed, performed by the data control system of FIG. 17, according to an example embodiment of the present invention;

FIG. 20 is an example data structure of email data processed by the data control system of FIG. 17;

FIG. 21 is an example data structure of electronic data management information, managed by the controller apparatus of FIG. 18;

FIG. 22 is a data sequence diagram illustrating operation of obtaining electronic data for further processing at the image forming apparatus, performed by the data control system of FIG. 17, according to an example embodiment of the present invention;

FIG. 23 is an example data structure of association data, managed by the controller apparatus of FIG. 18;

FIG. 24 is an illustration of a configuration of a data control system according to an example embodiment of the present invention;

FIG. 25 is a schematic block diagram illustrating a functional structure of the data control system of FIG. 24 including an image forming apparatus, a controller apparatus, an email storage apparatus, and a data storage apparatus, according to an example embodiment of the present invention;

FIGS. 26A and 26B are a data sequence diagram illustrating operation of authenticating a user, obtaining an electronic data list, and obtaining electronic data, performed by the data control system of FIG. 25, according to an example embodiment of the present invention;

FIG. 27 is an example data structure of association data, managed by the controller apparatus of FIG. 25;

FIG. 28 is a schematic block diagram illustrating a functional structure of the data control system of FIG. 1 including the image forming apparatus, the controller apparatus, and the data storage apparatus, according to an example embodiment of the present invention;

FIGS. 29A and 29B are a data sequence diagram illustrating operation of authenticating a user, performed by the data control system of FIG. 28, according to an example embodiment of the present invention;

FIG. 30 is an example data structure of determination rule information, managed by the controller apparatus of FIG. 28;

FIG. 31 is an illustration of a configuration of a data control system according to an example embodiment of the present invention;

FIG. 32 is a schematic block diagram illustrating a functional structure of the data control system of FIG. 31 including an information processing apparatus, a controller apparatus, and a data storage apparatus, according to an example embodiment of the present invention;

FIGS. 33A and 33B are a data sequence diagram illustrating operation of registering settings information, performed by the data control system of FIG. 31, according to an example embodiment of the present invention;

FIG. 34A is an example login screen, displayed through the information processing apparatus of the data control system of FIG. 31;

FIG. 34B is an example setting screen, displayed through the information processing apparatus of the data control system of FIG. 31;

FIG. 34C is an example screen indicating that registration is completed, displayed through the information processing apparatus of the data control system of FIG. 31;

FIGS. 35A and 35B are an example data structure of settings item information, managed by the controller apparatus of FIG. 32;

FIGS. 36A and 36B are an example data structure of settings information, managed by the controller apparatus of FIG. 32;

FIGS. 37A and 37B are a data sequence diagram illustrating operation of obtaining electronic data, performed by the data control system of FIG. 31, according to an example embodiment of the present invention;

FIG. 38A is an example screen, displayed through the information processing apparatus of the data control system of FIG. 31;

FIG. 38B is an example screen indicating that electronic data is not obtained, displayed through the information processing apparatus of the data control system of FIG. 31;

FIG. 38C is an example screen indicating that electronic data is obtained, displayed through the information processing apparatus of the data control system of FIG. 31;

FIG. 39 is a flowchart illustrating operation of determining electronic data to be processed, performed by the controller apparatus of the data control system of FIG. 32, according to an example embodiment of the present invention;

FIG. 40 is an example data structure of associated device information, managed by the controller apparatus of the data control system of FIG. 32; and

FIG. 41 is a configuration of the data control system of FIG. 17 having the functional structure of FIG. 18, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

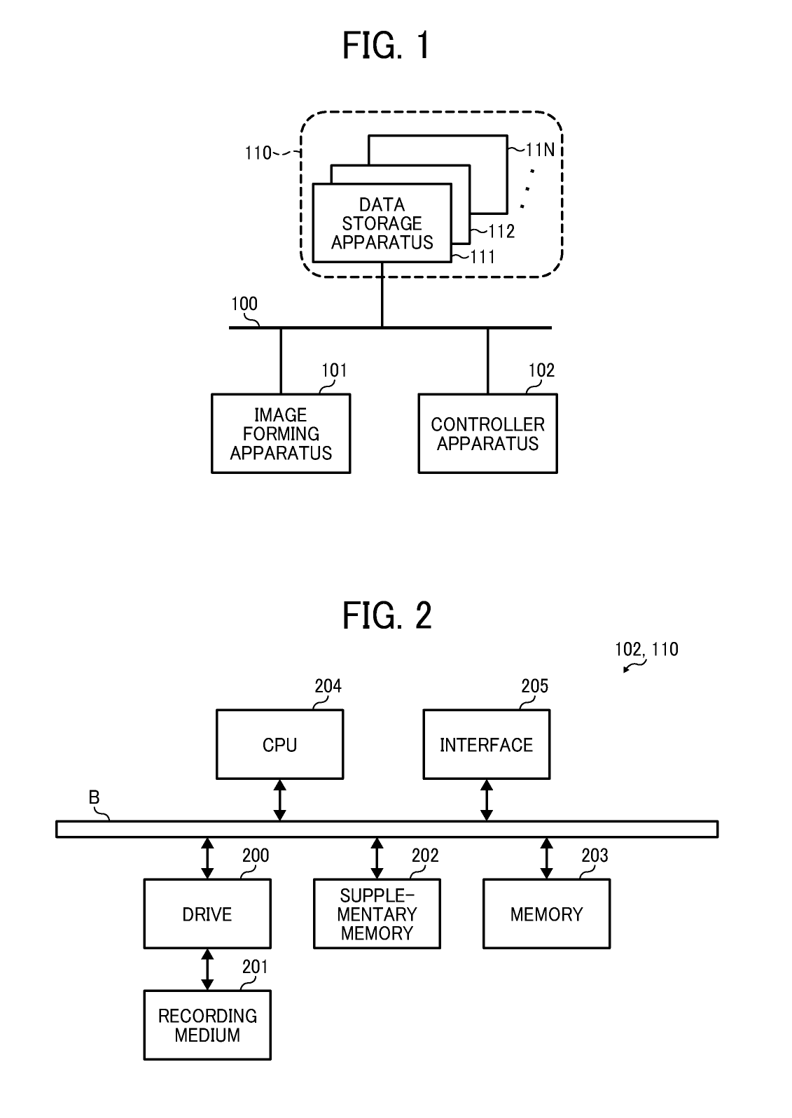

Referring to FIGS. 1 to 16, a data control system is explained according to an example embodiment of the present invention. FIG. 1 illustrates an example configuration of a data control system according to an example embodiment of the present invention. The data control system of FIG. 1 includes one or more image forming apparatuses 101 (collectively referred to as the “image forming apparatus 101”), one or more controller apparatuses 102 (collectively referred to as the “controller apparatus 102”), and one or more data storage apparatuses 111, 112, . . . 11N (collectively referred to as the “data storage apparatus 110”), which are connected through a network 100.

In this data control system, the image forming apparatus 101 and the controller apparatus 102 can be communicated through a network such as a local area network (LAN). The data storage apparatus 110 may be provided on the LAN in the form of cloud services referred to as private cloud. In such case, the data storage apparatus 110 can be communicated with the image forming apparatus 101 and the controller apparatus 102 through the LAN. Alternatively, the data storage apparatus 110 may be provided on a wide area network (WAN) such as the Internet in the form of cloud services referred to as public cloud. In such case, the data storage apparatus 110 can be communicated with the image forming apparatus 101 and the controller apparatus 102 through the WAN such as the Internet. Alternatively, the data storage apparatus 110 and the controller apparatus 102 may be provided on the WAN such that they can be accessed by the image forming apparatus 101 through the WAN. As long as the image forming apparatus 101, the controller apparatus 102, and the data storage apparatus 110 are communicable to transmit or receive data to or from, any network configuration may be applied. Further, to improve the security, a firewall may be provided between a private network (LAN) and a public network (WAN). For simplicity, any desired network configuration of the data control system of FIG. 1 is referred to as the network 100.

In this example, the image forming apparatus 101 is implemented by a multifunctional peripheral (MFP) capable of performing a plurality of functions selected from, for example, the functions of scanning, printing, copying, transmitting or receiving facsimile data, transmitting or receiving image data, and storing image data. Alternatively, the image forming apparatus 101 may be implemented by a printer, a facsimile, a copier, a scanner, or any desired image forming apparatus capable of forming an image based on image data.

The controller apparatus 102 obtains electronic data, which is stored in the data storage apparatus 110, in response to a request received from the image forming apparatus 101. The controller apparatus 102 further transmits, to the image forming apparatus 101, the obtained electronic data having a data format compatible with specific application of the electronic data. The controller apparatus 102 may be implemented by any desired number of devices that together function as a controller that controls electronic data in the data control system.

The data format of electronic data that is compatible with specific application is, for example, print data in case electronic data is to be printed by the image forming apparatus 101. The print data has a data format that allows the image forming apparatus 101 to print an image based on the print data, which may be written in print description language or any desired data format applicable to printing. Under control of the controller apparatus 102, the electronic data that is stored in the data storage apparatus 110 is converted to electronic data having a data format compatible with specific application that may be performed at the image forming apparatus 101, before being transmitted to the image forming apparatus 101. When the electronic data that is stored in the data storage apparatus 110 already has a data format that is compatible with specific application, conversion of data format is not necessary. For example, in case of printing electronic data, if the electronic data stored in the data storage apparatus 110 is print data that can be printed by the image forming apparatus 101, data format conversion is not necessary.

The controller apparatus 102 further controls various operations that may be necessary to complete a sequence of operations including authenticating a user who sends a request, obtaining a list of electronic data that are available, obtaining electronic data in response to a request from the image forming apparatus 101, and transmitting electronic data having a data format compatible with specific application to the image forming apparatus 101.

The data storage apparatus 110, which may be implemented by one or more computers, stores therein electronic data, and transmits electronic data in response to a request received from an information processing apparatus through the network 100. Examples of the information processing apparatus include, but not limited to, a personal computer (PC), portable phone such as smart phone, tablet such as iPad (Registered Trademark), digital camera, any other personal digital assistant (PDA), an image forming apparatus, and any other desired apparatus.

The data storage apparatus 110 may store any desired electronic data that is available to a user, other than electronic data that is transmitted from the user using the information processing apparatus. Further, the data storage apparatus 110 may be provided with additional functions other than the function of storing electronic data.

For example, the data storage apparatus 110 may be additionally provided with the function of authenticating a user such as matching a password input by the user, before transmitting electronic data stored therein to the information processing apparatus or any other apparatus on the network 100. In addition to authenticating based on first authentication information such as the password, the data storage apparatus 110 obtains second authentication information, which may be referred to as determination data, which corresponds to the first authentication information of the user such as the password input by the user. Using the determination data, the data storage apparatus 110 determines whether use of electronic data stored therein is allowed by the user, or use of a specific function of the data storage apparatus is allowed by the user. More specifically, the data control system of FIG. 1 authenticates the user using the first authentication information of the user, and the second authentication information of the user, before allowing the user to access or use the data storage apparatus 110.

FIG. 2 illustrates a hardware structure of the controller apparatus 102 of FIG. 1. As described above referring to FIG. 1, the controller apparatus 102 may be implemented by one or more computers having a hardware structure as illustrated in FIG. 2. The controller apparatus 102 of FIG. 2 includes a drive 200, a supplementary memory 202, a memory 203, a central processing unit (CPU) 204, and an interface 205, which are connected through a bus B.

The drive 200 may be set with a recording medium 201, which stores therein various control programs (“the control program”) to be executed by the CPU 204. When the recording medium 202 is set to the drive 200, the drive 200 reads out the control program stored in the recording medium 201, and installs the read control program onto the supplementary memory 202. Alternatively, the control program may be downloaded from any other device or apparatus, such as a computer, on the network 100 onto the supplementary memory 202 of the controller apparatus 102 through the interface 205. In this example, the drive 200 may be implemented by any desired reading device capable of reading data from the recording medium 201, such as a CD-ROM drive in case the recording medium is a CD-ROM.

The supplementary memory 202 stores the control program, and various data such as file data to be used by the CPU 204. The supplementary memory 202 may be implemented by any desired nonvolatile memory such as a read only memory (ROM) or a hard disk drive (HDD).

The memory 203 may be implemented by any desired volatile memory such as a RAM. Upon receiving an instruction for executing the control program, the memory 203 loads the control program from the supplementary memory 202 onto the memory 203. The CPU 204, such as a microprocessor, executes the control program stored in the memory 203 to cause the computer of FIG. 2 to function as the controller apparatus 102.

The interface 205 allows the controller apparatus 201 to interact with the outside device or apparatus, or with the user. In one example, the interface 205 includes a network interface that allows the controller apparatus 102 to connect to the network 100. In another example, the interface 205 includes a user interface that allows the controller apparatus 102 to interact with the user, such as a display and an input device.

Further, in this example, the data storage apparatus 110 may be implemented by one or more computers each having a hardware structure that is substantially similar to the hardware structure of FIG. 2, except that the supplementary memory 202 stores therein a control program that causes the computer of FIG. 2 to function as the data storage apparatus 110.

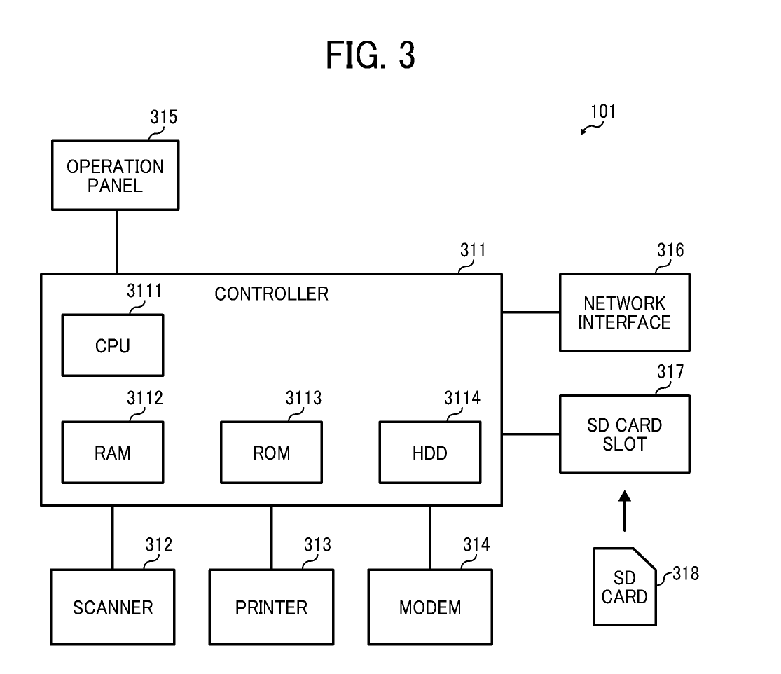

FIG. 3 illustrates a hardware structure of the image forming apparatus 101 of FIG. 1. The image forming apparatus 101 includes a controller 311, a scanner 312, a printer 313, a modem 314, an operation panel 315, a network interface 316, and a SD card slot 317. To the SD card slot 317, a SD card 318 may be inserted.

The controller 311 includes a CPU 3111, a random access memory (RAM) 3112, a read only memory (ROM) 3113, and a hard disk drive (HDD) 3114. The ROM 3113 stores therein various control programs (“control program”) and/or data to be used in cooperation with the control program. The RAM 3112 functions as a memory area to which the control program is loaded, or a work area used for the loaded control program. The CPU 3111 executes the control program loaded onto the RAM 3112 to perform various functions or operations according to the control program. The HDD 3114 stores therein the control program or various data to be used for the control program.

The scanner 312 scans an original document into image data. The printer 313 forms an image onto a recording sheet based on print data, which may be generated from the image data. The modem 314 allows the image forming apparatus 101 to connect with a telephone line such as a public switched telephone network. The modem 314 is used to transmit or receive facsimile data to or from the outside apparatus through the telephone line.

The operation panel 315 includes an input device such as one or more keys (“hard keys”), each of which may be selected by a user to input a user instruction, and a display device such as a liquid crystal display (LCD). The display device of the operation panel 315 may display various data including, for example, an image such as a thumbnail image of image data input to the image forming apparatus 101, and information regarding an operation state of the image forming apparatus 101. The display device of the operation panel 315 may be implemented by a touch panel screen, which allows the user to input a user instruction through a screen displayed by the display device.

The network interface 316 allows the image forming apparatus 101 to connect with a wired or wireless network such as a LAN of the network 100. The network interface 316 may be implemented by, for example, a network interface card.

The SD card slot 317 allows the image forming apparatus 101 to read out various data from the SD card 318, which may be inserted to the SD card slot 317. For example, the image forming apparatus 101 may read a control program stored in the SD card 318 to load the read program, in addition to or in alternative to the control program stored in the ROM 3113.

In alternative to using the SD card 318, any desired recording medium such as a CD-ROM or universal serial bus (USB) memory may be used. In such case, the SD card 317 may be replaced with any desired reading device specific to a type of the recording medium.

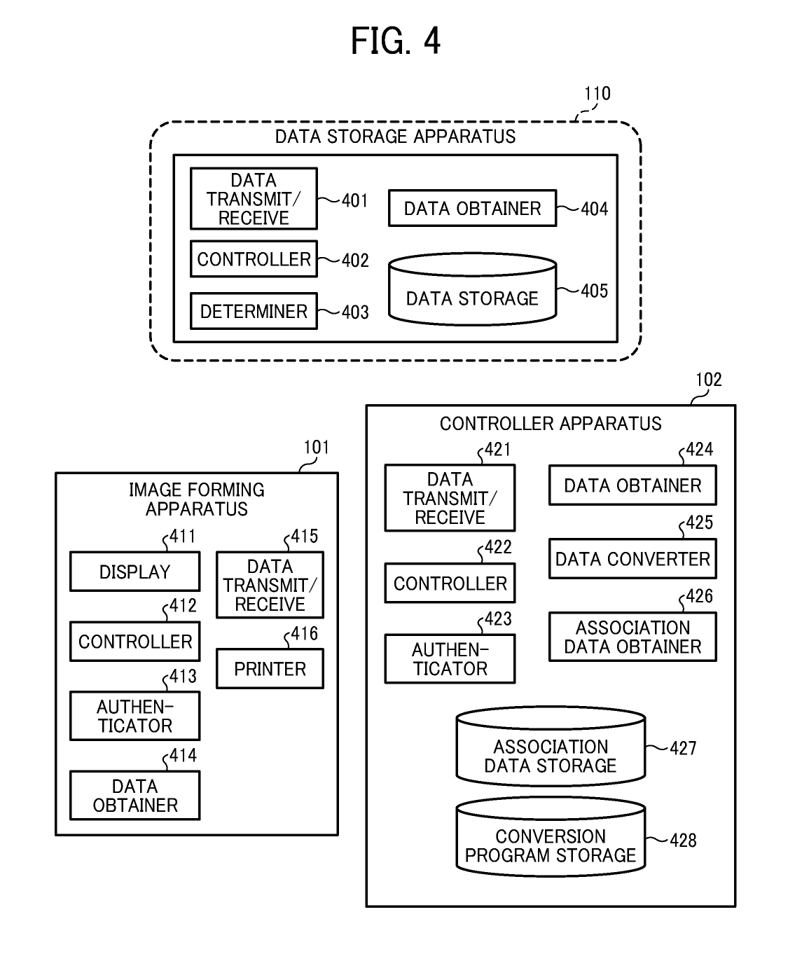

FIG. 4 illustrates a functional structure of the image forming apparatus 101, the controller apparatus 102, and the data storage apparatus 110 of the data control system of FIG. 1 according to an example embodiment of the present invention.

The image forming apparatus 101 includes a display 411, a controller 412, an authenticator 413, a data obtainer 414, a data transmit/receive 415, and a printer 416. These units or devices that are shown in FIG. 4 correspond to a plurality of modules, which are executed according to an instruction of the CPU 3111 (FIG. 3) that is generated according to the control program being loaded from the ROM 3113 or HDD 3114 onto the RAM 3112, in cooperation with one or more hardware circuits or devices of the image forming apparatus 101.

The display 411 may be implemented by the display device of the operation panel 315, which performs operation under control of the CPU 3111. The display 411 displays a screen, which allows the user to select or use various functions provided by the image forming apparatus 101. The functions provided by the image forming apparatus 101 include, not only those functions that can be performed by the image forming apparatus 101 using its devices, but also those functions that can be performed by the image forming apparatus 101 in cooperation with the other outside devices or apparatuses. For example, the image forming apparatus 101 may request the other apparatus to perform specific processing to provide services to the user via the image forming apparatus 101.

Further, in this example, the user at the image forming apparatus 101 may input information through the display 411 using the touch panel screen displayed by the display 411. Alternatively, the user at the image forming apparatus 101 may input information using the hard keys of the operation panel 315 or a keyboard connected to the image forming apparatus 101. The display 411 accepts information input by the user, and transmits the received information to the controller 412.

The controller 412, which corresponds to the controller 311 (FIG. 3), controls processing performed by various devices in the image forming apparatus 101. For example, the controller 412 sends a processing request to a specific device, or controls processing in response to a response received from the specific device.

The authenticator 413 may be implemented by the controller 311, or instructions processed by the controller 311, for example, in cooperation with the input device of the operation panel 315, the network interface 316, or the SD card slot 317. The authenticator 413 authenticates a user using authentication information such as user identification information that identifies a user. More specifically, the authenticator 413 sends an authentication request to the controller apparatus 102 through the data transmit/receive 415, which requests the controller apparatus 102 to authenticate the user using authentication information received from the user.

The data obtainer 414 may be implemented by the controller 311, for example, in cooperation with the network interface 316. The data obtainer 414 requests the controller apparatus 102 to provide a list of electronic data stored in the data storage apparatus 110, or electronic data stored in the data storage apparatus 110 and having a data format compatible with specific processing. The image forming apparatus 101 is able to perform specific processing such as printing using the electronic data obtained from the data storage apparatus 110 via the controller apparatus 102.

The data transmit/receive 415 may be implemented by the network interface 316. The data transmit/receive 415 transmits or receives various data or information to or from the other device or apparatus through the network 100.

The printer 416, which corresponds to the printer 313, performs printing based on print data, which may be received from the other apparatus via the data obtainer 414.

The controller apparatus 102 includes a data transmit/receive 412, a controller 422, an authenticator 423, an electronic data obtainer 424, a data converter 425, an association data obtainer 426, an association data storage 427, and a conversion program storage 428. These units or devices that are shown in FIG. 4 correspond to a plurality of modules, which are executed according to an instruction of the CPU 204 (FIG. 2) that is generated according to the control program being loaded from the supplementary memory 202 onto the memory 203, in cooperation with one or more hardware circuits or devices of the controller apparatus 102. For example, electronic data obtaining application, which may be stored in the supplementary memory 202 and loaded onto the memory 203, may be executed by the CPU 204 to cause the controller apparatus 102 to have the data obtainer 424.

Alternatively, these units or devices that are shown in FIG. 4 may correspond to a plurality of modules of one or more apparatuses that are distributed over a network. In such case, at least a part of the control programs may be executed by a processor of the controller apparatus 102 to perform various functions.

The data transmit/receive 421, which may be implemented by the interface 205, transmits or receives various data or information to or from the other devices or apparatuses through the network 100.

The controller 422, which corresponds to the CPU 204, controls processing performed by various devices in the controller apparatus 102. For example, the controller 422 sends a processing request to a specific device, or controls processing in response to a response received from the specific device.

The authenticator 423 may be implemented by the CPU 204, or instructions processed by the CPU 204, for example, in cooperation with the interface 205. The authenticator 423 authenticates a user using authentication information received from an information processing apparatus such as the image forming apparatus 101. More specifically, the authenticator 423 determines whether the authentication information received from the image forming apparatus 101 matches authentication information stored in a memory such as the association data storage 427. When it is determined that the received authentication information matches the stored authentication information, the authenticator 423 sends a response with an authentication result indicating that authentication is successful. When it is determined that the received authentication information does not match the stored authentication information, the authenticator 423 sends a response with an authentication result indicating that authentication fails.

The electronic data obtainer 424 may be implemented by the CPU 204, for example, in cooperation with the interface 205. In one example, the electronic data obtainer 424 obtains electronic data stored in the data storage apparatus 110. In another example, the electronic data obtainer 424 generates a list of electronic data that are available to the user based on information regarding the electronic data, and transmits the electronic data list to an information processing apparatus such as the image forming apparatus 101 for display to the user.

The data converter 425 may be implemented by the CPU 204 in cooperation with a conversion program available to the controller apparatus 102. Assuming that the controller apparatus 102 receives a request from the image forming apparatus 101, the data converter 425 converts the electronic data received from the data storage apparatus 110 to electronic data having a data format compatible with processing to be performed by the image forming apparatus 101. When the electronic data received from the data storage apparatus 110 already has a data format compatible with processing to be performed by the image forming apparatus 110, data format conversion may not be performed.

The association data obtainer 426 uses authentication information received from an information processing apparatus such as the image forming apparatus 101 to obtain determination data, which is associated with the received authentication information, from association data stored in the association data storage 427. The association data obtainer 426 may be implemented by the CPU 204.

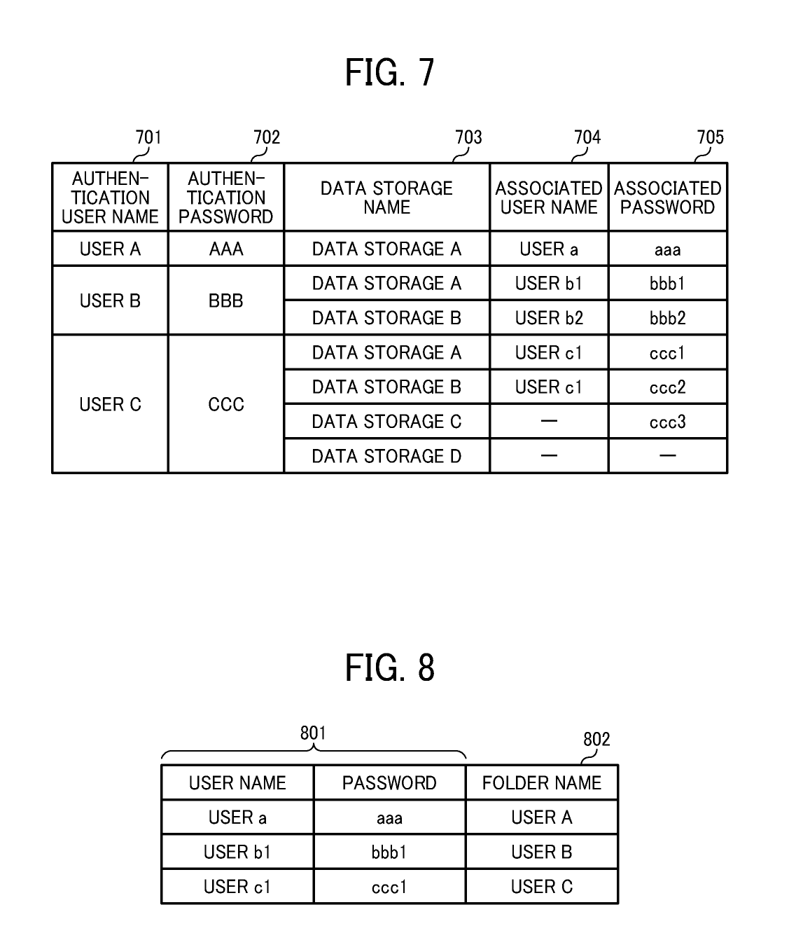

The association data storage 427, which may be implemented by a memory such as the supplementary memory 202, stores the association data indicating the association between authentication information and determination data. Examples of association data stored in the association data storage 427 will be explained below, for example, referring to FIG. 7.

The conversion program storage 428, which may be implemented by a memory such as the supplementary memory 202, stores various conversion programs to be used for converting a data format of electronic data, and information used for determining a data format of the electronic data to be transmitted.

The data storage apparatus 110 includes a data transmit/receive 401, a controller 402, a determiner 403, a stored data obtainer 404, and a data storage 405. These units or devices that are shown in FIG. 4 correspond to a plurality of modules, which are executed according to an instruction of the CPU 204 (FIG. 2) that is generated according to the control program being loaded from the supplementary memory 202 onto the memory 203, in cooperation with one or more hardware circuits or devices of the data storage apparatus 110.

The data transmit/receive 401, which may be implemented by the interface 205, transmits or receives various data or information to or from the other devices or apparatuses through the network 100.

The controller 402, which corresponds to the CPU 204, controls processing performed by various devices in the data storage apparatus 110. For example, the controller 402 sends a processing request to a specific device, or controls processing in response to a response received from the specific device.

The determiner 403, which may be implemented by the CPU 204, determines whether to permit the data storage apparatus 110 to obtain electronic data using the stored data obtainer 404 or perform the other functions of the data storage apparatus 110, based on the determination data received from the data transmit/receive 401.

The stored data obtainer 404, which may be implemented by the CPU 204, obtains electronic data from the data storage 405 under control of the determiner 403.

The data storage 405 stores one or more files of electronic data, and may be implemented by a memory such as the supplementary memory 202 or the recording medium 201. The data storage 405 may further store electronic data management information, which may be used for managing the stored electronic data using the determination data that is associated with the authentication information of the user. The electronic data management information is registered or managed by each storage data service, such as by each of the data storage apparatuses 110.

The data storage apparatus 110, which provides the storage service, may allow the user to view or edit electronic data stored in the data storage apparatus 110, in addition or in alternative to allowing the user to print electronic data stored in the data storage apparatus 110. The functions of the data storage apparatus 110 may thus depend on specific services provided by the data storage apparatus 110.

For example, the services provided by the data storage apparatus 110 include a storage service that stores electronic data generated using various types of application such as document data, an email storage service that stores email data transmitted by a user, a storage service that stores electronic data to be shared among a plurality of users, etc.

In this example, it is assumed that the data storage apparatus 110 is provided with at least the function of transmitting electronic data stored in the data storage apparatus 110 to the outside apparatus. More specifically, the determiner 403 determines whether the determination data received from the outside apparatus matches determination data stored in a memory such as the data storage 405. When it is determined that the received determination data matches the stored determination data, the determiner 403 sends a response with a result indicating that use of a function of the data storage apparatus 110 by the outside apparatus is allowed. When it is determined that the received determination data does not match the stored determination data, the determiner 403 sends a response with a result indicating that use of the function of the data storage apparatus 110 by the outside apparatus is not allowed.

The data storage apparatus 101 may not be provided with the determiner 403, depending on the storage services provided by the data storage apparatus 101. The controller apparatus 102 manages information indicating the requirements of each data storage apparatus 110 in obtaining electronic data stored in the data storage apparatus 101. For example, the controller apparatus 102 manages information indicating whether specific data such as determination data is required by a specific data storage apparatus 110 to request for electronic data, and sends the determination data to the data storage apparatus 110 when the information indicates that the determination data is required.

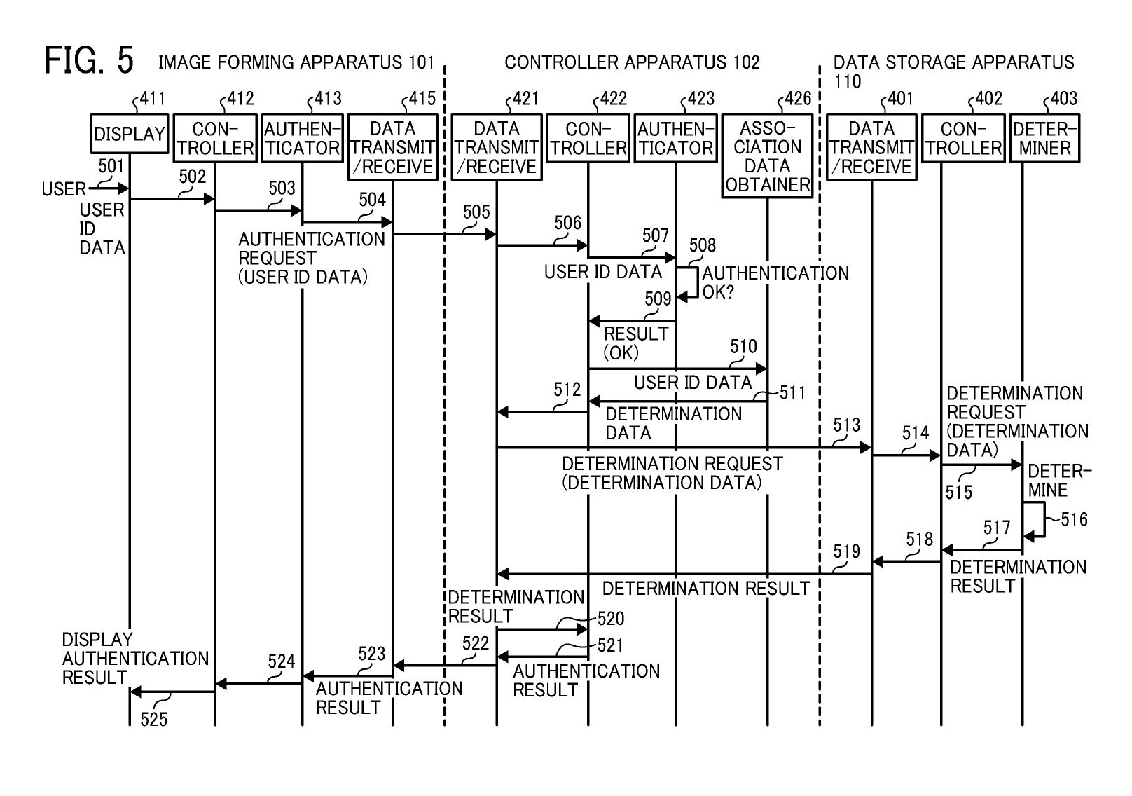

Referring now to FIG. 5, operation of authenticating a user, performed by the data control system of FIG. 1, is explained according to an example embodiment of the present invention. More specifically, operation of FIG. 5 is performed by one or more processors of the data control system of FIG. 1, such as the CPU 3111 of the image forming apparatus 101, the CPU 204 of the controller apparatus 102, and the CPU 204 of the data storage apparatus 110. Further, the CPU 204 of the controller apparatus 102 executes authentication program to function as the authenticator 423. The CPU 204 of the data storage apparatus 110 executes determination program to function as the determiner 403.

In this example, when the image forming apparatus 101 is not logged on by a specific user, the display 411 of the image forming apparatus 101 displays thereon a login screen to allow a user to input authentication information of the user. Examples of time when the user is not logged on include, but not limited to, time when the power of the image forming apparatus 101 is turned on, time when the image forming apparatus 101 is executed, or time when the image forming apparatus 101 is switched to a normal operation mode from an energy save mode. Further, in this example, identification information of the user (“user identification information”) is used as the authentication information, which is used to authenticate the user who uses the services provided by the data control system.

At S501, the user inputs user identification information (“USER ID DATA”) through the login screen displayed by the display 411.

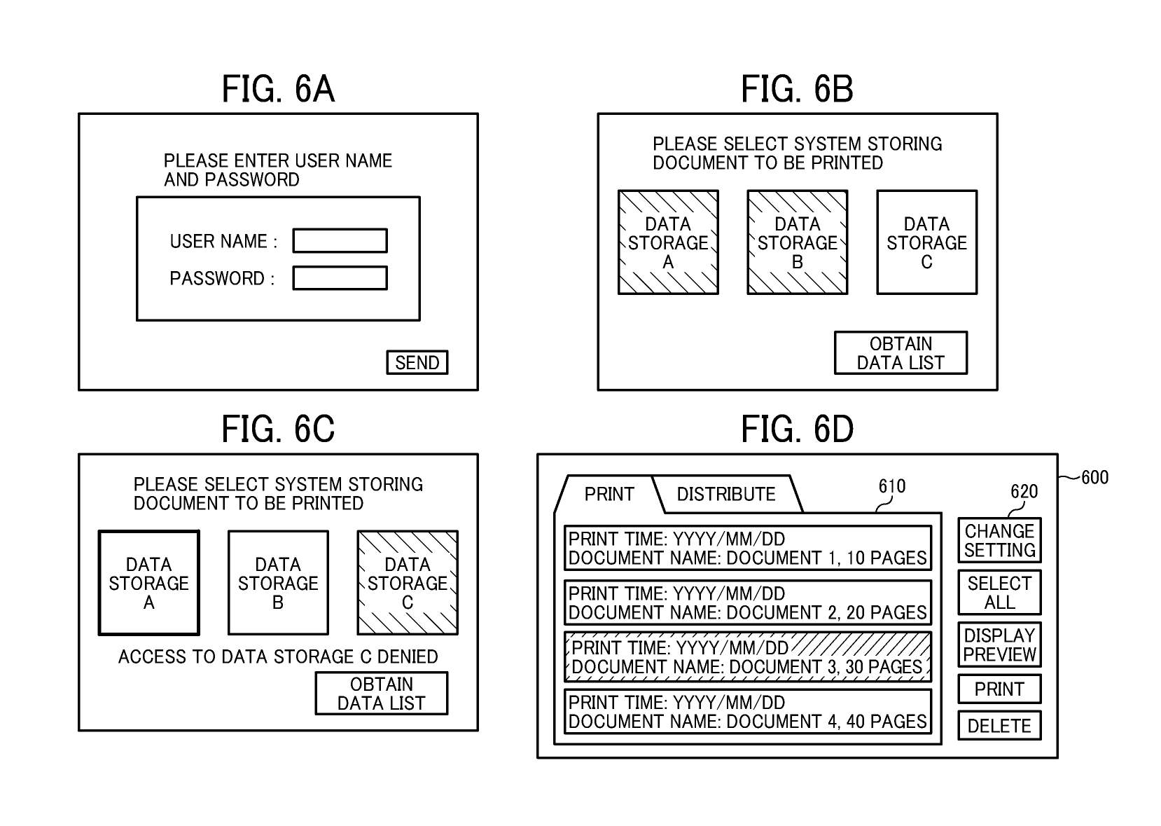

FIG. 6A illustrates an example login screen displayed by the image forming apparatus 101. The user inputs a user name and a password, which may be collectively referred to as user identification information, through the login screen of FIG. 6A. The user identification information, however, is not limited to a combination of the user name and the password. For example, any one of the user name and the password, or any other information such as a user ID assigned to the user may be used as the user identification information that identifies a user.

The user may input the user identification information using a key of the image forming apparatus 101 such as hard keys of the operation panel 315 or soft keys that are displayed onto the display device of the operation panel 315, or hard or soft keys of an input device that is connected to the image forming apparatus 101 such as a keyboard. The image forming apparatus 101 may obtain the user identification information in various other ways. For example, the user may insert a recording medium in which the user identification information is stored, such as the SD card 318, to a reading device such as the SD card slot 317 of the image forming apparatus 101. The reading device reads out the user identification information from the recording medium provided by the user. Alternatively, any biological characteristics of the user, which may be read out by a reading device, may be input to the image forming apparatus 101 as the user identification information.

At S502, the display 411 transmits the user identification information input by the user to the controller 412. At S503, the controller 412, which receives the user identification information, transmits the received user identification information to the authenticator 413 to request for authentication of the user.

At S504, the authenticator 413 transmits an authentication request to the controller apparatus 102 through the data transmit/receive 415 to request the controller apparatus 102 to authenticate the user using the user identification information. In alternative to requesting the controller apparatus 102 for authentication, at S504, the authenticator 413 may authenticate the user based on comparison between the received user identification information and user identification information stored in a memory.

At S506, the data transmit/receive 421 of the controller apparatus 102 transmits the authentication request, which is received from the image forming apparatus 101, to the controller 422. At S507, the controller 422 transmits the authentication request that is received from the data transmit/receive 421 to the authenticator 423 to request for authentication based on the user identification information. At S508, the authenticator 423 authenticates the user based on the received user identification information. More specifically, the authenticator 423 determines whether the received user identification information matches any authentication information that is stored in the association data storage 427.

FIG. 7 illustrates an example data structure of association data indicating the association between authentication information and determination data, which is stored in the association data storage 427. In FIG. 7, the association data storage 427 stores therein an authentication user name 701, authentication password 702, data storage name 703, associated user name 704, and associated password 705, which are associated with one another for each user that is registered in the data control system of FIG. 1.

The associated data may be previously stored in the association data storage 427. For example, at least a part of the association data may be transmitted to the controller apparatus 102 from an information processing apparatus operated by the user through the network 100. Alternatively, the controller apparatus 102 may obtain at least a part of the association data from the data storage apparatus 110 or any other information processing apparatus on the network 100.

The authentication user name 701 and the authentication password 702 are used for user authentication by the controller apparatus 102. The authentication user name 701 and the authentication password 702 may be collectively referred to as the user identification information, which is one example of the authentication information. The data storage name 703 is identification information that uniquely identifies a data storage apparatus 110 storing electronic data, such as a name uniquely assigned to the data storage apparatus 110. The associated user name 704 and the associated password 705 collectively function as determination data, which is used to determine whether use of a specific function of the data storage apparatus 110 is allowed by the user identified by the associated user identification information. For example, it is determined whether access to the data storage apparatus 110 specified by the data storage name 703 is allowed by the user identified by the associated user identification information, or use of specific function or electronic data that can be provided by the data storage apparatus 110 specified by the data storage name 703 is allowed by the user identified by the associated user identification information.

As long as the determination data can be used to determine whether use of the data storage apparatus 110 is allowed by the user, any desired data or information may be used as the determination data. Further, as illustrated in FIG. 7, for each one of the authentication user name 701 indicating a user, a plurality of combinations of the data storage name 703 and the determination data (the associated user name 704 and the associated password 705) may be set. For example, as illustrated in case of the user B and the user C of FIG. 7, a number of combinations may be determined based on a number of data storage apparatuses 110 that the user has registered for use. Further, the authentication user name 701 and the associated user name 704 of a user may have a value that is identical. Similarly, the authentication password 702 and the associated password 705 of a user may have a value that is identical.

In FIG. 7, the value “- (hyphen)” indicates that data is not set such that it has a “NULL” value, as the corresponding data storage apparatus 110 does not require such determination data. For example, the data storage apparatus 110 with the data storage name “C” does not require the associated user name 704 to determine whether the user is allowed to access or use a specific function of the data storage apparatus 110.

Referring back to FIG. 5, at S508, the authenticator 423 of the controller apparatus 102 refers to the association data stored in the associated data storage 427 to determine whether there is any data entry of the authentication user name 701 and the authentication password 702, which matches the user name and the password of the user identification information received at S507. When the association data includes the authentication user name 701 and the authentication password 702, which match the user name and the password of the received user identification information, at S509, the authenticator 423 sends a response to the controller 422 with an authentication result indicating that authentication is successful. When the association data does not include the authentication user name 701 and the authentication password 702, which match the user name and the password of the received user identification information, at S509, the authenticator 423 sends a response to the controller 422 with an authentication result indicating that authentication fails. FIG. 5 shows that the authentication result indicates that authentication is successful.

Alternatively, at S508, the authenticator 423 may authenticate a user using the authentication information stored in an authentication information memory. The authentication information memory stores the authentication user name 701 and the authentication password 702 in association with each other for each of the registered users of the data control system of FIG. 1. For example, the authentication information memory may be provided separately from the association data memory 417 in a manner that is accessible from the authenticator 423. Alternatively, the association data memory 417 may be classified into a data area that stores the authentication information (the authentication user name 703 and the authentication password 702), and a data area that stores the data storage name 703 and the determination data (the associated user name 704 and the associated password 705), as long as two different types of data stored in different data areas can be associated.

At S510, when the authentication result received from the authenticator 423 indicates that authentication is successful, the controller 422 requests the association data obtainer 426 to obtain the data storage name 703 and the determination data (the associated user name 704 and the associated password 705), which are respectively associated with the user identification information that is used for authentication at S508, using the association data stored in the associated data storage 427.

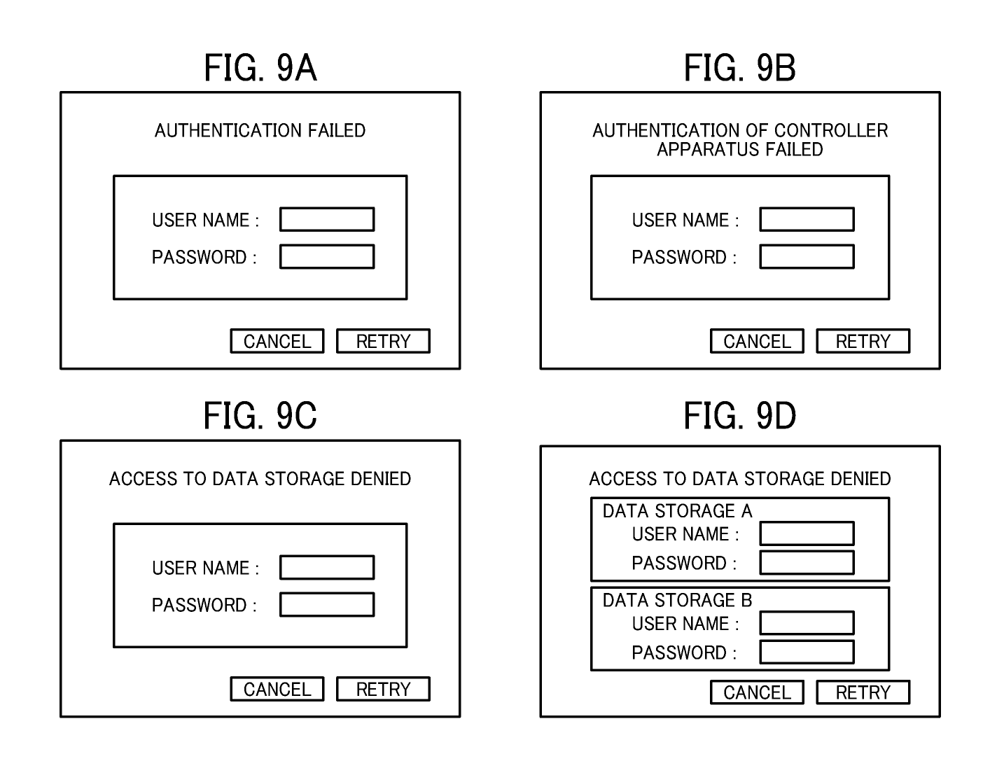

Alternatively, at S510, when the authentication result received from the authenticator 423 indicates that authentication fails, the controller 422 sends the authentication result indicating that authentication fails to the image forming apparatus 101 via the data transmit/receive 421. The image forming apparatus 101, which receives the authentication result indicating that authentication fails, causes the display 411 to display an error screen such as a screen illustrated in FIG. 9A.

At S511, the association data obtainer 426 searches the association data, which is stored in the association data storage 427, using the user identification information received from the controller 422 as a search key, to obtain data storage name 703 and determination data that are respectively associated with the received user identification information. The obtained data storage device name 703 and determination data are transmitted to the controller 422. More specifically, the data storage device name 703 is identification information that identifies a data storage apparatus 110 that stores electronic data for use by the user specified by the user identification information. The determination data including the associated user name 704 and the associated password 705 is used to determine whether the user specified by the user identification information is allowed to access or use the data storage apparatus 110.

At S512 and S513, the controller 422, which receives the data storage device name 703 and the determination data, transmits a request (“determination request”) for determining whether a specific function of the data storage apparatus 110 specified by the received data storage device name 703 is allowed to be performed based on the received determination data, to the data storage apparatus 110 that is specified by the data storage name 703 through the data transmit/receive 421.

In this example, the determination request requests the data storage apparatus 110 to determine whether execution of a specific function of the data storage apparatus 110 is allowed using the determination data. The specific function of the data storage apparatus 110 includes, for example, transmitting electronic data stored in the data storage apparatus 110 to the user or transmitting information regarding the stored electronic data to the user.

At S514, the data transmit/receive 401 of the data storage apparatus 110 transmits the received determination request to the controller 402. At S515, the controller 402 transmits the received determination request to the determiner 403, together with the determination data.

At S516, the determiner 403 determines whether execution of the specific function of the data storage apparatus 110 is allowed based on the determination data, using the electronic data management information stored in the data storage 405.

FIG. 8 illustrates an example data structure of the electronic data management information, which is stored in the data storage 405 of the data storage apparatus 110. As illustrated in FIG. 8, the electronic data management information includes determination data 801 and a folder name 802, which are associated with each other. The determination data 801 includes a user name and a password, which are used for user authentication by the data storage apparatus 110. More specifically, the user name and the password of the determination data 801 respectively correspond to the associated user name 704 and the associated password 705 of the association data of FIG. 7 for the same data storage apparatus 110. In this example illustrated in FIG. 8, the electronic data management information for the data storage “A” is shown. The folder name 802 is identification information that uniquely identifies a folder storing electronic data for the user. For example, the data storage apparatus 110 stores electronic data to be used by the user within a folder having the folder name 802 that is associated with the determination data of the user.

In alternative to managing electronic data by folder, electronic data may be managed in various other ways such that the electronic data management information does not have to be provided with the folder name 802, for example, when electronic data is not managed using the folder. In such case, in one example, the electronic data management information of FIG. 8 may only store the determination data 801, which is capable of identifying a specific user. In another example, any data that specifies one or more electronic data files accessible by the user, out of a plurality of electronic data files stored in the data storage apparatus 110, may be stored in association with the determination data 801 such as, for example, a path to specific electronic data accessible by the user.

Referring back to FIG. 5, at S516, the determiner 403 determines whether there is any determination data 801 of the electronic data management information, which matches the determination data received from the controller 402 at S515.

When it is determined that there is determination data 801 of the electronic data management information, which matches the received determination data, the determiner 403 generates a determination result indicating that use of the specific function of the data storage apparatus 110 is allowed by the user, and transmits the determination result to the controller 402. When it is determined that there is no determination data 801 of the electronic data management information that matches the received determination data, the determiner 403 generates a determination result indicating that use of the specific function of the data storage apparatus 110 is not allowed by the user, and transmits the determination result to the controller 402.

At S518, the controller 402 transmits the determination result, which is received from the determiner 403, to the data transmit/receive 401. At S519, the data transmit/receive 401 transmits the received determination result to the controller apparatus 102.

At S520, the data transmit/receive 421 of the controller apparatus 102 transmits the determination result, which is received from the data storage apparatus 110 at S519, to the controller 422. At S521 and S522, the controller 422 transmits an authentication result, which is generated based on the received determination result, to the image forming apparatus 101 through the data transmit/receive 421.

More specifically, at S521 and S522, when the determination result received from the data storage apparatus 110 indicates that use of the specific function of the data storage apparatus 110 is allowed, the controller 422 transmits an authentication result indicating that authentication is successful. When the determination result received from the data storage apparatus 110 indicates that use of the specific function of the data storage apparatus 110 is not allowed, the controller 422 transmits an authentication result indicating that authentication fails.

Assuming that the controller apparatus 102 receives a plurality of determination results from respective data storage apparatuses 110 for the user specified by the user identification information, the controller 422 generates an authentication result indicating that authentication is successful when at least one determination result indicating that use of the specific function is allowed is received from the corresponding data storage apparatus 110. When all of the determination results received from the respective data storage apparatuses 110 each indicate that use of the specific function is not allowed, the controller 422 generates an authentication result indicating that authentication fails. The controller 422 may determine whether authentication succeeds or fails in various other ways.

Assuming that authentication of the user using the user identification information is successful at S508, but the authentication result of S521 indicates that authentication fails as none of the determination results indicates that use of the specific function of the data storage apparatus 110 is allowed, the controller 422 of the controller apparatus 102 may report the image forming apparatus 101 that authentication fails based on the determination result indicating that use of the specific function is not allowed. With this information, the image forming apparatus 101 is able to know why authentication fails. For example, when the authentication result fails, the image forming apparatus 101 is able to know whether authentication by the authenticator 423 of the controller apparatus 102 based on the user identification information fails, or authentication fails based on determination by the determiner 403 of the data storage apparatus 110 using the determination data.

At S523, the data transmit/receive 415 of the image forming apparatus 101 transmits the received authentication result to the authenticator 413. At S524, the authenticator 413 transmits the authentication result to the controller 412.

When the received authentication result indicates that authentication is successful, at S525, the controller 412 causes the display 411 to display a screen illustrated in FIG. 6B or 6C, and the operation ends. When the received authentication result indicates that authentication fails, at S525, the controller 412 causes the display 411 to display an authentication result indicating that authentication fails, and the operation ends in error.

FIG. 9 illustrates example screens each indicating that authentication fails, which may be displayed by the display 411 of the image forming apparatus 101. The screen of FIG. 9A indicates that authentication fails. The screen of FIG. 9B indicates that authentication fails based on an authentication result of the authenticator 423 of the controller apparatus 102. The screen of FIG. 9C indicates that authentication fails based on a determination result of the determiner 403 of the data storage apparatus 110. The screen of FIG. 9D indicates that authentication fails based on a determination result of the determiner 403 of the data storage apparatus 110. As illustrated in FIGS. 9B, 9C, and 9D, the display 411 displays different screens, depending on the specific point at which authentication fails. The user is able to know that authentication failure is caused by either the authentication process at the controller apparatus 102, or the determination process at the data storage apparatus 110.

Referring back to FIGS. 9A and 9B, the user at the image forming apparatus 101 may enter a user name and a password in the respective fields and presses the “RETRY” key. The image forming apparatus 101 sends the user name and the password, which are entered by the user, to the controller apparatus 102 to request for authentication using the entered user name and password. The controller apparatus 102, which receives the authentication request, causes the authenticator 423 to authenticate the user using the user name and the password.

Referring back to FIG. 9C, the user at the image forming apparatus 101 may enter a user name and a password in the respective fields and presses the “RETRY” key. Since authentication at the data storage apparatus 110 fails, it is assumed that the user enters a user name and a password for the data storage apparatus 110, which may be referred to as the associated user name 704 and the associated password 705 of the determination data. The image forming apparatus 101 sends the user name and the password, which are entered by the user, to the controller apparatus 102. The controller apparatus 102 determines that authentication failure is caused at the determination process performed by the data storage apparatus 110. The controller apparatus 102 sends the user name and the password as the determination data to the data storage apparatus 110 to request for determining whether use of a specific function is allowed using the determination data. The data storage apparatus 110, which receives the determination data, determines whether use of a specific function of the data storage apparatus 110 is allowed to generate a determination result.

The controller apparatus 102 receives the determination result from the data storage apparatus 110 in response to the determination request. When the determination result indicates that use of the specific function of the data storage apparatus 110 is allowed by the user, the controller apparatus 102 sends an authentication result indicating that authentication is successful to the image forming apparatus 101. Further, when the determination result indicating that use of the specific function is allowed is received, the controller apparatus 102 may update the association data stored in the association data storage 427 so as to replace the determination data (the associated user name 704 and the associated password 705), which is previously stored in association with the authentication user name 701 and the authentication password 702 that are authenticated by the authenticator 423, with the user name and the password that are newly obtained from the user. Accordingly, the determination data, which is now authenticated, is stored in association with the authentication information for the data storage apparatus 110 that is allowed for access.

When the determination result indicates that use of the specific function of the data storage apparatus 110 is not allowed, the controller apparatus 102 sends an authentication result indicating that authentication fails to the image forming apparatus 101 together with information indicating the data storage apparatus 110 that generates the determination result. The information indicating the data storage apparatus 110 may be a data storage name assigned to the data storage apparatus 110. For example, the image forming apparatus 101 causes the display 411 to display a screen of FIG. 9D to indicate one or more specific data storage apparatuses 110 that the user fails to access.

When the user enters a user name and a password in the respective fields, which are displayed for the data storage “A”, through the display 411, and presses the “RETRY” key, the image forming apparatus 101 sends an authentication request including the data storage name, the user name, and the password, to the controller apparatus 102. The controller apparatus 102 sends a determination request to the data storage apparatus 110 specified by the received data storage name “A”, to request for determination using the received user name and password. Similarly, the user may enter a user name and a password in the respective fields, which are displayed for the data storage “B”, and presses the “RETRY” key to cause the image forming apparatus 110 to send an authentication request including the data storage name, the user name, and the password, to the controller apparatus 102. The controller apparatus 102 sends a determination request to the data storage apparatus 110 specified by the received data storage name “B”, to request for determination using the received user name and password.

In the above-described example, the screen of FIG. 9C does not indicate a specific data storage apparatuses 110 that is not allowed for access by the user. Alternatively, the screen of FIG. 9C may further display information indicating a specific data storage apparatus 110 that the user is denied to access or use a specific function. When there is more than one such data storage apparatus 110, the image forming apparatus 110 may arbitrarily select one data storage apparatus 110.

Further, in the above-described example, the screen of FIG. 9D is displayed after the user fails to access the data storage apparatus 110 even with the user name and the password input through the screen of FIG. 9C. Alternatively, the image forming apparatus 101 may cause the display 411 to display the screen of FIG. 9D in alternative to the screen of FIG. 9C, especially, when more than one data storage apparatus 110 sends a determination result indicating that use of a specific function of the data storage apparatus 110 is not allowed.

When the authentication result indicates that authentication result is successful, the display 411 of the image forming apparatus 101 displays a screen such as a screen of FIG. 6B. The screen of FIG. 6B displays a list of data storage apparatuses 110 each of which returns a determination result indicating that use of a specific function of the data storage apparatus 110 is allowed by the user. In this example illustrated in FIG. 6B, a plurality of data storage apparatuses 110 is available for use by the user. Alternatively, for example, in case of the user A of FIG. 7, only one data storage apparatus 110 may be displayed based on the determination result.

The user at the image forming apparatus 101 is able to select one or more desired data storage apparatuses 110 from the data storage apparatuses 110 that are displayed on the screen of FIG. 6B, and presses the “OBTAIN DATA LIST” key. The image forming apparatus 101 accepts a request for obtaining a list of electronic data (“data list request”) stored in the selected data storage apparatus 110. In FIG. 6B, it is assumed that the data storage apparatus “A” and the data storage apparatus “B” are selected, while the data storage apparatus “C” is unselected. In such case, the image forming apparatus 101 accepts a data list request for electronic data stored in the data storage apparatuses “A” and “B”.

In the above-described example, the image forming apparatus 101 may automatically accept a data list request for electronic data stored in the data storage apparatus 110, without displaying the screen of FIG. 6B to the user, for example, when there in only one data storage apparatus 110 that the user can access or use its function. In such case, the controller apparatus 102 may perform operation of authenticating a user and operation of obtaining an electronic data list at once. In this manner, the user at the image forming apparatus 101 only needs to enter user identification information to cause the image forming apparatus 101 to display an electronic data list available to the user.

In alternative to displaying the screen of FIG. 6B, which lists one or more data storage apparatuses 110 that are available for use, the image forming apparatus 101 may display a screen of FIG. 6C. The screen of FIG. 6C further includes information indicating a data storage apparatus 110 that the user is denied for access or use. In FIG. 6C, the data storage apparatus “C” cannot be selected such that it is displayed in dark color such as gray. The screen of FIG. 6C further includes a message indicating that access to the data storage apparatus “C” is not allowed by the user based on the determination result. Further, the screen of FIG. 6C indicates that the data storage apparatus “A” is selected (shown in bolded borderline), while the data storage apparatus “B” is unselected.

Alternatively, the data storage apparatus “C” may be displayed in a manner such that it can be selected by the user. In case the user selects the data storage apparatus “C”, the image forming apparatus 101 may cause the display 411 to switch to the screen of FIG. 9C to request the user to enter a user name and a password for the data storage apparatus “C”.

Further, as long as the user is logged onto the data control system of FIG. 1, the controller apparatus 102 does not have to repeat the user authentication process every time the user requests for an electronic data list.

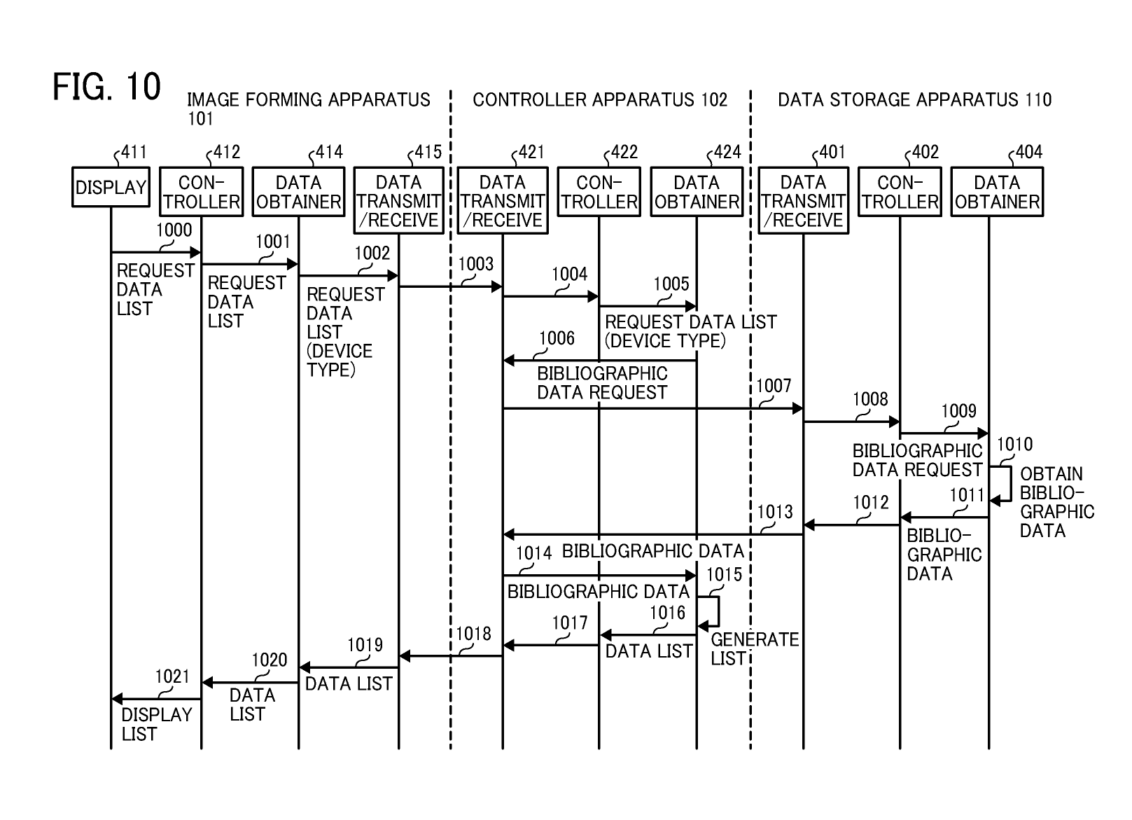

FIG. 10 is a data sequence diagram illustrating operation of obtaining a list of electronic data stored in the data storage apparatus 110, performed by the data control system of FIG. 1, according to an example embodiment of the present invention. More specifically, operation of FIG. 10 is performed by one or more processors of the data control system of FIG. 1, such as the CPU 3111 of the image forming apparatus 101, the CPU 204 of the controller apparatus 102, and the CPU 204 of the data storage apparatus 110. Operation of FIG. 10 may be performed when the user authentication process of FIG. 5 is successful. Further, in this example, it is assumed that the screen of FIG. 6B is displayed to the user. Further, the CPU 204 of the controller apparatus 102 executes data obtaining program, such as electronic data obtaining application, to function as the electronic data obtainer 424. The CPU 204 of the data storage apparatus 110 executes data obtaining program to function as the data obtainer 404.

At S1000, when the user selects the “OBTAIN DATA LIST” key of the screen illustrated in FIG. 6B while selecting the data storage apparatus 110, the display 411 transmits a request for obtaining a list of electronic data (“data list request”) that can be obtained from the selected data storage apparatus 110 to the controller 412. In this example, it is assumed that the user selects one data storage apparatus 110. Further, it is assumed that the user has already logged in the data control system as described above referring to FIG. 5, such that inputting of the user identification information is not necessary.

At S1001, the controller 412 transmits a data list request for obtaining a list of electronic data to the data obtainer 414. At S1002 and S1003, the data obtainer 414, which receives the data list request, transmits the data list request for obtaining a list of electronic data, and device type information indicating a type of the apparatus sending the request, to the controller apparatus 102 through the data transmit/receive 415. In this example, the device type information indicates that a type of the apparatus is an image forming apparatus.

At S1004, the data transmit/receive 421 of the controller apparatus 102 transmits the data list request, which is received from the image forming apparatus 101, to the controller 422. At S1005, the controller 422 transmits the data list request to the data obtainer 424, together with the device type information.

At S1006 and S1007, the data obtainer 424 transmits a request for obtaining bibliographic data (“bibliographic data request”) for the electronic data stored in the selected data storage apparatus 110, to the selected data storage apparatus 110 through the data transmit/receive 421, based on the received data list request.

At S1008, the data transmit/receive 401 of the data storage apparatus 110 transmits the bibliographic data request, which is received from the controller apparatus 102, to the controller 402. At S1009, the controller 402 transmits the bibliographic data request to the stored data obtainer 404.

At S1010, the stored data obtainer 404 specifies a folder that is associated with the determination data using the electronic data management information stored in the data storage 405 to obtain bibliographic data of electronic data stored in the specified folder, in response to the bibliographic data request. In this example, the bibliographic data includes information related to electronic data that is stored by a user using the data storage apparatus 110. Examples of the bibliographic data include, but not limited to, a data format of electronic data, property information of electronic data such as a file name, a title, an author name, a creation date/time, and a last updated date/time, and a number of pages of electronic data. The bibliographic data may be used to uniquely identify specific electronic data.

The electronic data stored in the data storage apparatus 110 may be managed in various other ways, in alternative to managing the electronic data using a user name and a password as illustrated in FIG. 8. For example, the electronic data may be managed using a password. In such case, in order to access electronic data stored in the data storage apparatus 110, the user may enter a password to cause the password to be transmitted to the data storage apparatus 110. When the password entered by the user matches a password assigned to electronic data, the data storage apparatus 110 allows the user to access the electronic data. If the electronic data is to be managed using the password, the data storage apparatus 110 does not have to manage all of data items of the electronic data management information of FIG. 8. Rather, the data storage 405 manages a password in association with the electronic data. Further, in such case, the associated data storage 427 of the controller apparatus 102 stores the password as the determination data of the association data.

Alternatively, the electronic data stored in the data storage apparatus 110 may be managed using a user name of the user who stores the electronic data. Further, the electronic data stored in the data storage apparatus 110 may be accessed by more than one user, for example, by using a user name or a password that can be shared by a group of users.

Referring back to FIG. 10, at S1011, the stored data obtainer 404 transmits the obtained bibliographic data of electronic data to the controller 402. At S1012 and S1013, the controller 402 transmits the received bibliographic data to the controller apparatus 102 through the data transmit/receive 401.

At S1014, the data transmit/receive 421 of the controller apparatus 102 transmits the received bibliographic data to the electronic data obtainer 424. At S1015, the electronic data obtainer 424 generates a data list based on the received bibliographic data.

The electronic data stored in the data storage apparatus 110 may be processed in various ways, depending on capabilities or functions of a specific apparatus that processes the electronic data. For example, if the electronic data is to be processed by a personal computer (PC), the electronic data may be edited or displayed at the PC. In another example, if the electronic data is to be processed by an image forming apparatus such as an MFP, the electronic data may be used for printing. Since application of the electronic data may depend on a type of a specific apparatus that processes the electronic data, it is preferable for the controller apparatus 102 to generate a list of electronic data while considering a device type of a specific apparatus that requests for data list.

Further, it may be preferable for the controller apparatus 102 to determine a data format of the electronic data to be processed by the specific apparatus, depending on capabilities or functions of the specific apparatus. For example, it is assumed that the electronic data is created by Microsoft PowerPoint (Trademark), and stored in a data format applicable to PowerPoint application. Assuming that the user desires to view the electronic data using the PC, which is installed with PowerPoint, the electronic data can be displayed by the PC. When the user desires to view the electronic data using the MFP, which is not installed with PowerPoint, the electronic data having a data format applicable to PowerPoint may not be correctly displayed through the MFP. In such case, the MFP may need to convert the data format of the electronic data to display a file of the electronic data through an operation panel of the MFP. It is thus preferable to convert a data format of the electronic data to be processed by a specific apparatus, based on application of the electronic data while taking into account capabilities or functions of the specific apparatus. The user at the specific apparatus is not expecting to see any electronic data listed in the data list, which has a data format that cannot be processed by the specific apparatus.

In view of the above, at S1015, the electronic data obtainer 424 of the controller apparatus 102 determines various applications of the electronic data that may be available at the image forming apparatus 101, based on the device type information received from the image forming apparatus 101. The electronic data obtainer 424 generates a list of electronic data that can be converted to various data formats depending on the determined applications.

In this example, the device type information includes information regarding a device type of a specific apparatus that requests for a list of electronic data stored in the data storage apparatus 110. For example, the device type information specifies whether the specific apparatus is an image forming apparatus having the printing function, a terminal such as a PC having the function of editing electronic data, or a portable terminal device such as a smart phone having the function of web browsing. The device type information is used to determine the capabilities or functions that may be available at the specific apparatus. Based on the capabilities or functions of the specific apparatus, applications (uses) of the electronic data may be specified.

The controller apparatus 102 generates a list of electronic data that are available for use, depending on various applications that are determined based on the device type information of the specific apparatus. More specifically, the electronic data list may specify a data format that is applicable to specific application, for each of the determined applications. The electronic data list may further specify an original, or unconverted, data format of electronic data stored in the data storage apparatus 110. The original data format of electronic data can be specified based on the bibliographic data that is obtained from the selected data storage apparatus 110.

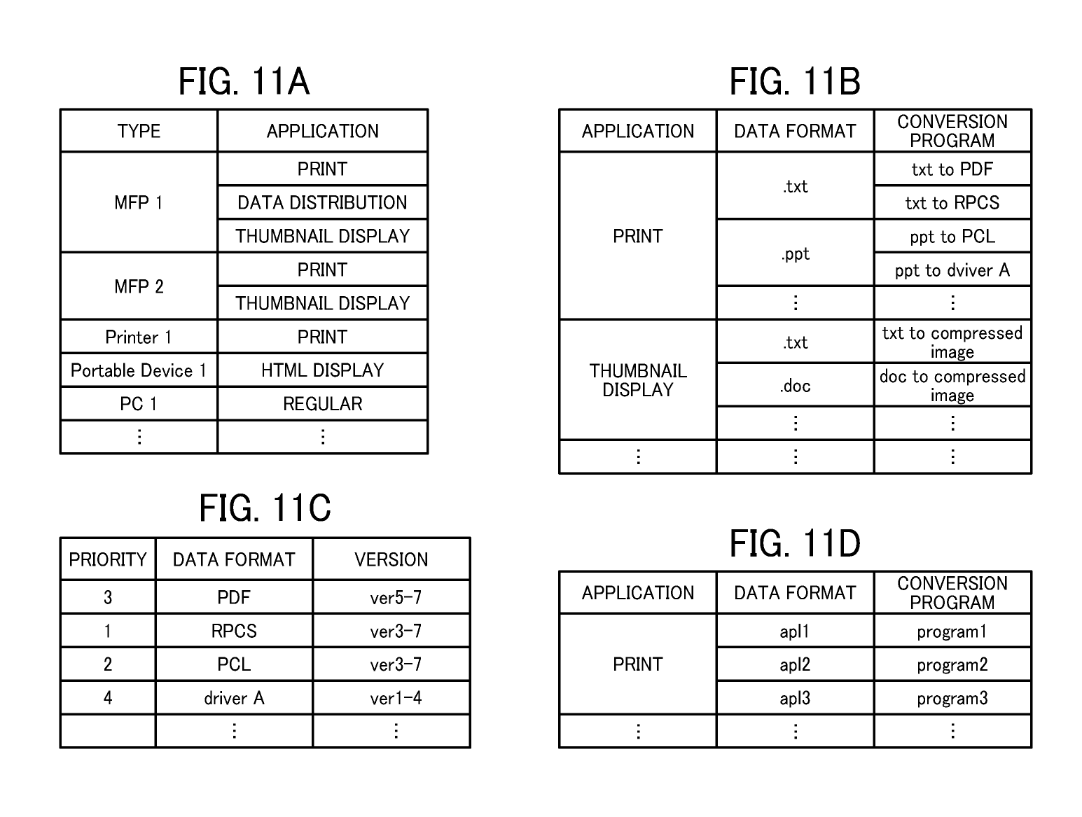

More specifically, in this example, the electronic data obtainer 424 refers to application information (FIG. 11A) stored in the conversion program storage 428 to obtain applications of electronic data for a specific apparatus specified by the device type information received from the image forming apparatus 101. Assuming that the device specific information indicates that the specific apparatus, or the image forming apparatus 101, is the MFP 1, the electronic data obtainer 424 determines that applications are print, data distribution, and thumbnail display.

For example, it is assumed that an electronic data list is generated for the print application. The controller apparatus 102 determines whether the converter 425 is able to convert a data format of electronic data to a data format applicable to the print application, using a conversion data list (FIG. 11B) stored in the conversion program storage 428. Based on a determination result, the controller apparatus 102 generates an electronic data list such that electronic data having a data format that cannot be converted to print data is excluded from the data list or displayed differently from electronic data having a data format that can be converted to print data. If the electronic data that cannot be converted is displayed in the electronic data list together with the electronic data that can be converted, it would be difficult for the user to recognize which electronic data is printable or not printable. For this reasons, the electronic data list displays electronic data that is convertible differently from electronic data that is not convertible.

The original data format of the electronic data is obtained using the bibliographic data of the electronic data. For example, an extension code included in the file name of the electronic data may be obtained from the bibliographic data. The extension code indicates a specific data format of electronic data, which may depend on specific application that creates the electronic data. If the file name ends with “.txt”, the electronic data is text data. If the file name ends with “.ppt” or “.pptx”, the electronic data is PowerPoint data. Other examples of extension code include, but not limited to, gif, ps (postscript), exe, doc, xls, and jpg. In this example, the data format of electronic data is to be converted to print data to be compatible with print application.

The electronic data obtainer 424 determines whether electronic data can be converted to print data, based on the bibliographic data of the electronic data and the conversion data list of the conversion program storage 428. When it is determined that the electronic data cannot be converted, the electronic data obtainer 424 removes the electronic data from the electronic data list to be transmitted such that the electronic data that cannot be converted is not displayed to the user. Alternatively, the electronic data that cannot be converted may be displayed differently from the electronic data that can be converted, such as by adding additional information indicating that the electronic data is not convertible.

FIG. 11A illustrates an example data structure of the application information stored in the conversion program storage 428. FIG. 11B illustrates an example data structure of the conversion data list stored in the conversion program storage 428.

The table of FIG. 11A stores device type information indicating a device type of an apparatus, and applications of electronic data that are available at the apparatus, in association with each other to form application information of electronic data. For example, for the apparatus with a device type “MFP1”, “print” application, “data distribution” application, and “thumbnail display” application are available. For the apparatus with a device type “MFP2”, “print” application and “thumbnail display” application are available. For the apparatus with a device type “Printer1”, “print” application is available. For the apparatus with a device type “Portable device 1”, “HTML display” application is available. For the apparatus with a device type “PC1”, “regular” application is available. The “regular” application causes electronic data to be transmitted to the apparatus “PC1” without converting a data format, based on assumption that the PC is usually provided with various application programs. Using the application information, the controller apparatus 102 is able to determine one or more applications of electronic data, which may be requested by a specific apparatus.

The conversion data list of FIG. 11B manages convertible data format information indicating a data format of electronic data that can be converted by a conversion program of the controller apparatus 102. More specifically, the conversion data list of FIG. 11B stores specific application of electronic data, an original data format of electronic data, and information indicating a conversion program that is capable of converting the electronic data from the original data format to a data format applicable to specific application. For example, the conversion program “txt to PDF” converts electronic data from a text format to a PDF format. The conversion program “txt to RPCS” converts electronic data from a text format to a PRCS (Trademark) format. Using the conversion data list of FIG. 11B, the controller apparatus 102 specifies one or more conversion programs that can convert a data format of electronic data to a data format applicable to specific application, which is determined for the specific apparatus using the application information of FIG. 11A.

The conversion program storage 428 may further include conversion data format information in the form of table of FIG. 11C. The table of FIG. 11C stores, for each of available data formats of electronic data, version information indicating one or more types of the image forming apparatuses that can process electronic data having the data format, and priority information indicating a priority level assigned to the data format, in association with one another to form conversion data format information for the print application. For example, in case of electronic data having a PDF format, the image forming apparatus 101 having the version of 5, 6, or 7 is capable of processing the electronic data having the PDF format. The version information may be included in the device type information of the image forming apparatus 101, which is transmitted from the image forming apparatus 101.

Using the conversion data format information of FIG. 11C, the controller apparatus 102 may further narrow down a number of conversion programs that are selected using the conversion data list of FIG. 11B, based on information indicating a version or capability of the specific apparatus that can process the electronic data having a specific data format. In this manner, the controller apparatus 102 is able to specify one or more conversion programs, depending on the specific apparatus. While the conversion data format information of FIG. 11C is prepared for the print application, the conversion data format information can be generated for any other type of application specified by the application information of FIG. 11A.

The information stored in the conversion program storage 428 may be managed in various other ways. For example, the conversion data list of FIG. 11B may have a data structure as illustrated in FIG. 11D, if one conversion program can be specified using an original data format of electronic data and a data format applicable to specific application. The conversion data list of FIG. 11D stores specific application of electronic data, an original data format of the electronic data, and a conversion program that can convert the electronic data from the original data format to a data format applicable to the specific application, in association with one another.

As described above, at S1005, the electronic data obtainer 424 of the controller apparatus 102 obtains the device type information, which includes version information, from the image forming apparatus 101 that sends the data list request. Using the application information of FIG. 11A, the electronic data obtainer 424 obtains one or more applications that match the device type information to determine one or more applications of the electronic data. At S1014, the electronic data obtainer 424 obtains the bibliographic data of the electronic data to specify an original data format of the electronic data. Based on a data format applicable to the determined application and the original data format, the electronic data obtainer 424 specifies one or more conversion programs that can convert the data format of the electronic data, using the conversion data list of FIG. 11B or 11D. The electronic data obtainer 424 may further select a conversion program that can convert the electronic data to a data format, which can be processed by the image forming apparatus 101 having the specific version. To further narrow down a number of conversion programs, the electronic data obtainer 424 may select a data format based on the priority level.

For example, assuming that the device type information of the image forming apparatus 101 is “MFP1” and the version information of the image forming apparatus 101 is “ver 4”, the controller apparatus 102 specifies the print application, the data distribution application, and the thumbnail display application. Further, it is assumed that an original data format of the electronic data is text, i.e., “.txt”, based on the bibliographic data of the electronic data. In order to generate a data list for the print application, the controller apparatus 102 specifies the conversion program that converts from txt to PDF, and the conversion program that converts from txt to PRCS. Since the data format that can be processed by the image forming apparatus 101 having the version information “ver 4” is “PRCS”, the controller apparatus 102 selects a conversion program that can convert from txt to PRCS.

Assuming that the image forming apparatus 101 has version information “ver 2”, since none of the data formats “PDF” and “PRCS” can be processed by the image forming apparatus 101, the controller apparatus 102 determines that the electronic data is not convertible to print data.

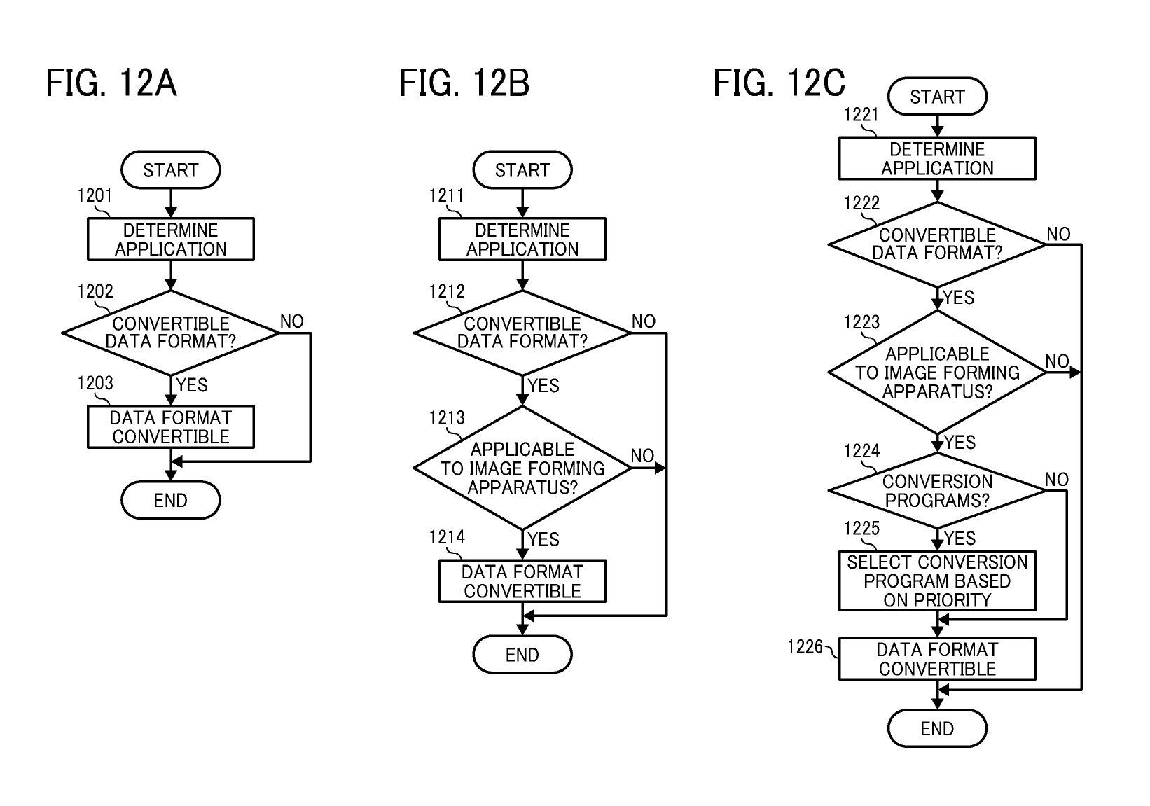

FIGS. 12A to 12C are flowcharts each illustrating operation of determining whether electronic data is convertible to have a data format compatible with specific application, performed by the controller apparatus 102, according to example embodiments of the present invention. Any one of operations of FIGS. 12A to 12C may be performed by the electronic data obtainer 424 of the controller apparatus 102, for example, at S1015 of FIG. 10. For example, the electronic data obtainer 424 may include an application determiner that determines one or more applications of electronic data, a conversion determiner that determines whether one or more conversion programs that can convert the electronic data are available, and a data list generator that generates an electronic data list of electronic data.

Referring to FIG. 12A, at S1201, the electronic data obtainer 424 refers to the application information of FIG. 11A to determine whether there is any device type information, which matches device type information transmitted from the image forming apparatus 101. When it is determined that there is the device type information that matches the received device type information, the electronic data obtainer 424 obtains information indicating one or more specific applications, which are stored in association with the device type information. S1201 may be performed by the application determiner.

At S1202, the electronic data obtainer 424 obtains an original data format of electronic data stored in the selected data storage apparatus 110 from the bibliographic data of the electronic data, and determines whether the original data format of the electronic data is convertible to a data format compatible with specific application determined at S1201. More specifically, the electronic data obtainer 124 refers to a conversion data list stored in the conversion program storage 428, such as the conversion data list of FIG. 11D, to determine whether there is any data format in the “data format” field that matches the original data format of the electronic data. When there is any data format in the conversion data list that matches the original data format (“YES” at S1202), at S1203, the electronic data obtainer 424 determines that the electronic data is convertible by the data converter 425 using the corresponding conversion program, and the operation ends.

When there is no data format in the conversion data list that matches the original data format (“NO” at S1202), the electronic data obtainer 424 determines that the electronic data is not convertible by the data converter 425, and the operation ends. S1202 and S1203 may be performed by the conversion determiner.

Operation of FIG. 12A is performed for each file of electronic data that is stored in the selected data storage apparatus 110, which is available to the user. Information regarding such electronic data can be recognized based on the bibliographic data obtained from the selected data storage apparatus 110.

Referring to FIG. 12B, S1211 and S1212 are performed in a substantially similar manner as described above referring to S1201 and S1202 of FIG. 12A.

When there is no data format in the conversion data list that matches the original data format (“NO” at S1212), the electronic data obtainer 424 determines that the electronic data is not convertible by the data converter 425, and the operation ends.

When there is any data format in the conversion data list that matches the original data format (“YES” at S1212), the electronic data obtainer 424 determines that the electronic data is convertible by the data converter 425 using the corresponding conversion program, and the operation proceeds to S1213.

At S1213, the electronic data obtainer 424 refers to the conversion data format information of FIG. 11C to determine whether there is any version information that matches the version information of the image forming apparatus 101 that is received. When there is at least one version information that matches the version information of the image forming apparatus 101, the electronic data obtainer 424 determines whether a data format that is associated with the matched version information matches a converted data format of the electronic data. The converted data format of the electronic data is a data format of the electronic data after being converted by the conversion program. When the data format of the version information matches the converted data format, the electronic data obtainer 424 determines that the converted data format can be processed by the image forming apparatus 101 (“YES” at S1213), and the operation proceeds to S1214. At S1214, the electronic data obtainer 424 determines that the electronic data is convertible by the data converter 425, and the operation ends.

At S1213, when there is no version information that matches the version information of the image forming apparatus 101, or when there is no data format of the matched version information that matches a converted data format of the electronic data, the electronic data obtainer 424 determines that the converted data format cannot be processed by the image forming apparatus 101 (“NO” at S1213), and the operation ends. The electronic data obtainer 424 determines that the electronic data is not convertible by the data converter 425. S1213 and S1214 may be performed by the conversion determiner.

The electronic data obtainer 424 of the controller apparatus 102 may obtain the version information of the image forming apparatus 101 when the electronic data obtainer 424 receives the data list request at S1005, for example, together with the data list request. Alternatively, the electronic data obtainer 424 may obtain the version information of the image forming apparatus 101, after the electronic data obtainer 424 obtains the bibliographic data at S1014. The electronic data obtainer 424 may obtain the version information at any desired time before performing generation of a data list at S1015, or before performing S1213.

Referring to FIG. 12C, S1221, S1222, and S1223 are performed in a substantially similar manner as described above referring to S1211, S1212, and S1213 of FIG. 12B.

When there is any data format in the conversion data list that matches the original data format (“YES” at S1222), the electronic data obtainer 424 determines that the electronic data is convertible by the data converter 425 using the corresponding conversion program, and the operation proceeds to S1223. Further, at S1222, the electronic data obtainer 424 specifies one or more conversion programs capable of converting the electronic data to have a data format compatible with specific application determined at S1221, using the conversion data list.

At S1223, when the electronic data obtainer 424 determines that the converted data format of the electronic data can be processed by the image forming apparatus 101 based on the version information of the image forming apparatus 101 (“YES” at S1223), the operation proceeds to S1224. More specifically, at S1223, the electronic data obtainer 424 may select one or more conversion programs using the version information, out of the conversion programs that are determined at S1222.

At S1224, the electronic data obtainer 424 determines whether there is more than one conversion program capable of converting the electronic data to the data format that can be processed by the image forming apparatus 101.

For example, referring to FIGS. 11B and 11C, it is assumed that the electronic data obtainer 424 determines that the original data format “.txt” of the electronic data can be converted to a data format “PDF” or a data format “PRCS” to be processed by the image forming apparatus 101 having version information ver 4 to ver 7 for printing. Since the data converter 425 can convert the electronic data using the “txt to PDF” conversion program or the “txt to PRCS” conversion program, there is more than one conversion program capable of converting the electronic data to have a data format compatible with specific application.

When there is more than one conversion program (“YES” at S1224), the operation proceeds to S1225. At S1225, the electronic data obtainer 424 refers to the priority information of the conversion data format information (FIG. 11C) to select one of the conversion programs that can convert the electronic data to a data format and is assigned with the highest priority level. For example, the electronic data obtainer 424 selects the “txt to PRCS” conversion program, as the priority level assigned to the PRCS data format is higher than that of the PDF data format.

At S1226, the electronic data obtainer 424 determines that the electronic data is convertible to a data format that is compatible with specific application using the conversion program selected at S1225, and the operation ends.

At S1224, when there is only one conversion program capable of converting the electronic data to a data format that can be processed by the image forming apparatus 101 (“NO” at S1224), the operation proceeds to S1226 without performing S1225. At S1226, the electronic data obtainer 424 determines that the electronic data is convertible to a data format compatible with specific application using the conversion program, and the operation ends.

In alternative to performing S1225 of selecting the conversion program according to priority information at S1015, S1225 may be performed at any other desired time before performing data format conversion. For example, one conversion program may be selected when the electronic data is to be converted to have a data format compatible with specific application. It is, however, preferable to determine one conversion program that is capable of converting the electronic data when generating an electronic data list, since printing conditions such as printing parameters may differ according to a data format of print data.

The printing conditions specify various printing parameters used for printing such as whether the print data is to be printed in color or monochrome, whether print data of more than one page is to be aggregated into one page of recording sheet, whether the print data is subjected for double-sided printing or single-sided printing, or whether post processing such as stapling or punching is to be applied, etc. The image forming apparatus 101 may allow the user to set various printing conditions, after selecting specific electronic data to be printed from the electronic data list.

The printing conditions may differ depending on a data format. For example, in case of print data in PRCS, the printing conditions such as color, monochrome, aggregated, double-sided, staple, and punch can be set. In case of print data in PDF, the printing conditions such as monochrome and double-sided can be set.

If the conversion program capable of converting the electronic data format to a specific data format is selected when or before the electronic data list is generated, the controller apparatus 102 is able to determine a plurality of items of the printing conditions that can be selected by the user in printing the electronic data having the specific data format. The controller apparatus 102 may include such information regarding the printing conditions that can be selected, in the electronic data list.

Referring back to FIG. 10, at 51016, the electronic data obtainer 424 transmits the electronic data list generated at S1015 to the controller 422. At S1017 and S1018, the controller 422 transmits the electronic data list to the image forming apparatus 101 via the data transmit/receive 421.

At S1019, the data transmit/receive 415 of the image forming apparatus 101 transmits the received electronic data list to the data obtainer 414. At S1020, the data obtainer 414 transmits the received electronic data list to the controller 412.

At S1021, the controller 412, which receives the electronic data list, transmits the electronic data list to the display 411 to cause the display 411 to display a data list screen based on the electronic data list, and the operation ends.

FIG. 6D illustrates an example data list screen 600 to be displayed by the display 411 of the image forming apparatus 101. As illustrated in FIG. 6D, the data list screen 600 includes a first display area 610 and a second display area 620. The first display area 610 lists electronic data files each having a data format that can be converted to a data format compatible with specific application, for each of specific applications. For each electronic data file that is listed in a tab indicating specific application, the first display area 610 displays information regarding the electronic data file such as a title, an author name, and a number of pages. The second display area 620 displays a plurality of keys each allowing the user to input an instruction, which includes a “Change Setting” key, a “Select All” key, a “Display Preview” key, a “Print” key, and a “Delete” key.

The user at the image forming apparatus 101 may select any one of the electronic data listed in the first display area 610 as electronic data subjected for processing. The user may further select any one of the keys, or buttons, that are displayed in the second display area 620 to request the image forming apparatus 101 to perform an instruction specified by the selected key on the electronic data subjected for processing. The image forming apparatus 101 performs specific processing on the selected electronic data according to the instruction input by the user.

The “Change Setting” key allows the user to set various printing conditions in printing the electronic data. When the “Change Setting” key is selected, the display 411 switches the data list screen of FIG. 6D to a change settings screen to allow the user to set various printing conditions such as color or monochrome, aggregated, double-sided or single-sided, stapling, or punching.

The “Select All” key causes all electronic data files that are displayed in the first display area 610 to be selected.

The “Display Preview” key displays a preview image of the selected electronic data file, which is selected from a list of electronic data files that are displayed in the first display area 610. The selected electronic data file may be one or more electronic data files.

The “Print” key instructs printing of the selected electronic data file, which is selected from a list of electronic data files that are displayed in the first display area 610. The selected electronic data file may be one or more electronic data files.

The “Delete” key instructs deletion of the selected electronic data file, which is selected from a list of electronic data files that are displayed in the first display area 610. The selected electronic data file may be one or more electronic data files.

As described above, the electronic data list to be displayed through the display 411 may only include a list of electronic data having a data format that can be converted to a data file compatible with specific application. Alternatively, the electronic data list may further include a list of electronic data having a data format that cannot be converted to a data file compatible with specific application at least by the controller apparatus 102.

When the electronic data that is not convertible is listed in the first display area 610, the user may not be able to select some of the keys displayed in the second display area 620 while selecting the electronic data that is not convertible. For example, the “Delete” key can be selected so as to delete the selected electronic data that is not convertible, but the “Print” key and the “Change Setting” key cannot be selected as the electronic data cannot be converted to print data suitable for printing at the image forming apparatus 101.

To help the user to easily recognize whether the electronic data is convertible or not convertible, that is, whether the electronic data is printable or not printable, the data list display screen 600 may further include information indicating whether each electronic data file listed in the first display area 610 is printable or not printable. Further, some keys displayed in the second display area 620 may be caused to be unselectable, when the user selects the electronic data that is not printable. In this manner, the user can instantly recognize that some of the functions are not allowed.

In the above-described example, it is assumed that the controller apparatus 102 generates and sends an electronic data list for one or more specific applications that may be available to the image forming apparatus 101. Alternatively, the controller apparatus 102 may only generate and send an electronic data list for specific application, which is requested by the image forming apparatus 101. For example, the image forming apparatus 101 may send specific application information indicating specific application of electronic data to the controller apparatus 102 when requesting an electronic data list.

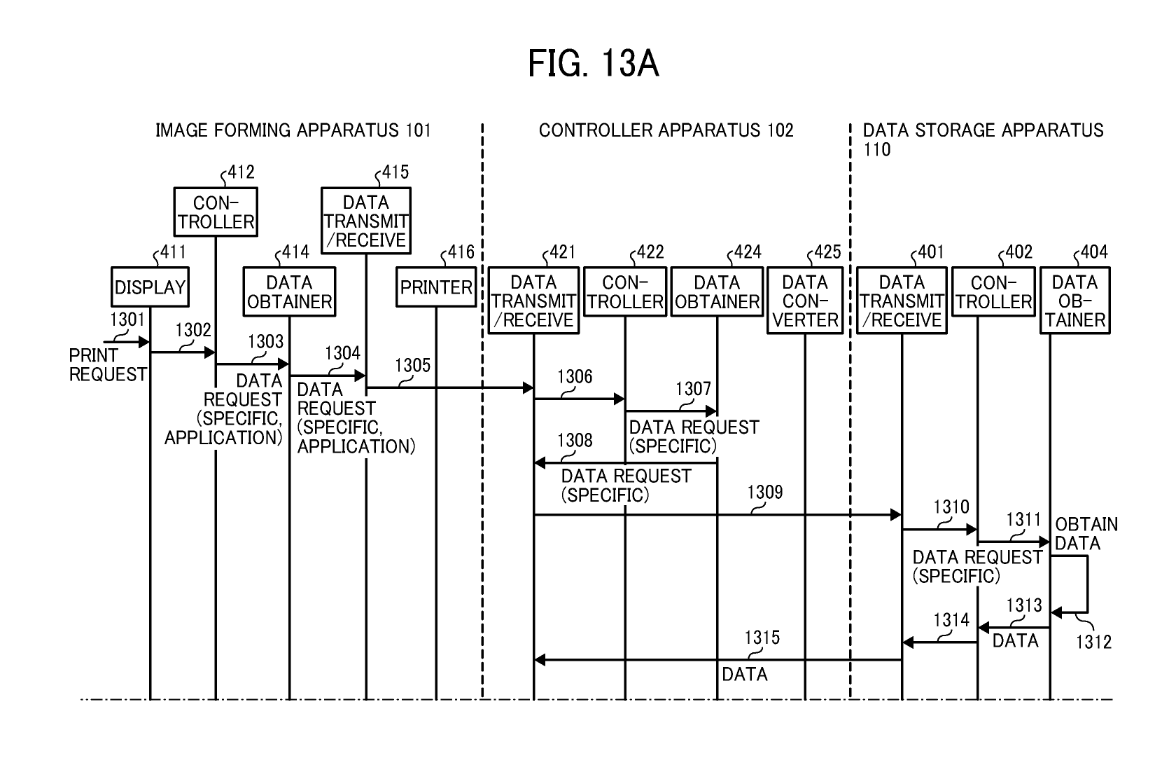

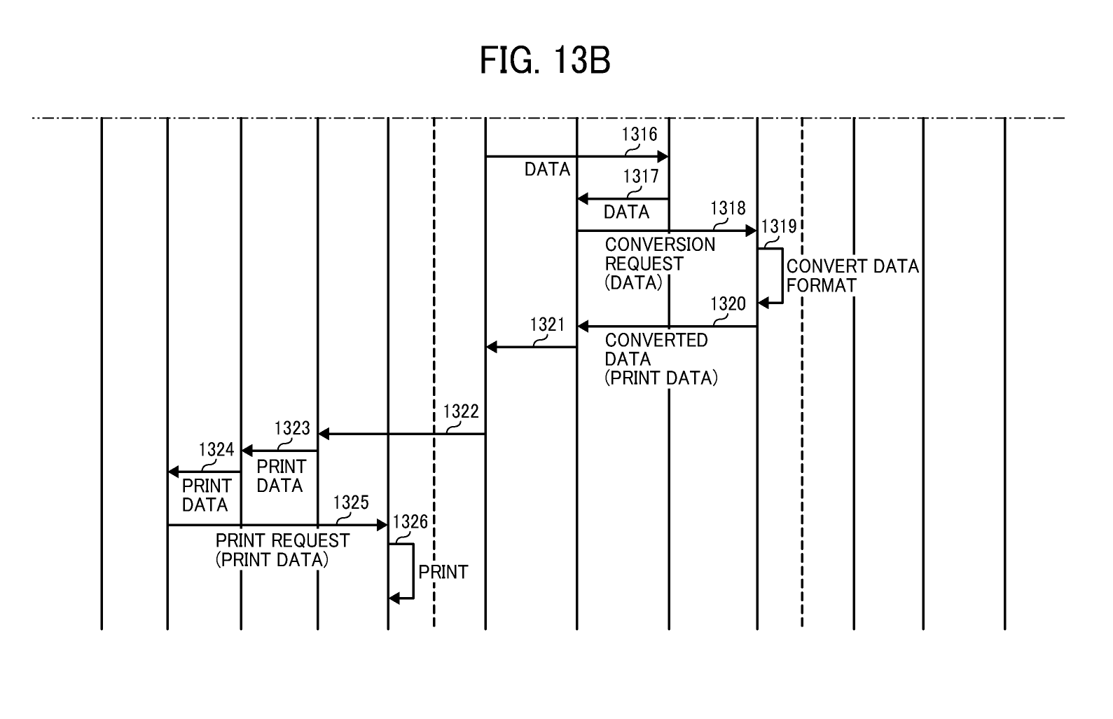

FIGS. 13A and 13B are a data sequence diagram illustrating operation of printing electronic data stored in the selected data storage apparatus 110, performed by the data control system of FIG. 1, according to an example embodiment of the present invention. More specifically, operation of FIG. 13 is performed by one or more processors of the data control system of FIG. 1, such as the CPU 3111 of the image forming apparatus 101, the CPU 204 of the controller apparatus 102, and the CPU 204 of the data storage apparatus 110. Further, in the following example, it is assumed that the data list screen 600 of FIG. 6D is displayed to the user through the display 411 of the image forming apparatus 101, in response to the user request for obtaining a data list for the data storage apparatus 110 that is input through the screen of FIG. 6B after the user authentication process. Further, the CPU 204 of the controller apparatus 102 executes data obtaining program, such as electronic data obtaining application, to function as the electronic data obtainer 424. The CPU 204 of the data storage apparatus 110 executes data obtaining program to function as the data obtainer 404.

At S1301, referring back to FIG. 6D, the user selects one file of the electronic data from a list of electronic data files displayed in the first display area 610, and selects the “Print” key displayed in the second display area 620 to request printing of the selected electronic data file.

At S1302, the display 411, which accepts the user request for printing, transmits a print execution request (“print request”) to the controller 412, together with data specific information of the selected electronic data such as identification information that uniquely identifies the selected electronic data. For example, a file name of the electronic data may be used.

At S1303, the controller 412 transmits a request for obtaining the selected electronic data (“data request”) to the data obtainer 414, together with application specific information and the data specific information. The application specific information indicates specific application that is requested by the user, such as printing in this example. The data specific information indicates the selected electronic data subjected for processing, such as the identification information that uniquely identifies the selected electronic data.

At S1304 and S1305, the data obtainer 414 sends the data request to the controller apparatus 102 through the data transmit/receive 415.

At S1306, the data transmit/receive 421 of the controller apparatus 102 transmits the received data request to the controller 422. At S1307, the controller 422 transmits the data request for obtaining the electronic data, to the electronic data obtainer 424. At S1308 and S1309, the electronic data obtainer 424 transmits the data request to the data storage apparatus 110 through the data transmit/receive 421, together with the bibliographic data of the selected electronic data. The bibliographic data for the selected electronic data may be obtained using the data specific information received from the image forming apparatus 101. In this example, a part of the bibliographic data such as only the file name may be transmitted.

At S1310, the data transmit/receive 401 of the data storage apparatus 110 transmits the data request to the controller 402. At S1311, the controller 402 requests the stored data obtainer 404 to obtain the selected electronic data, based on the received data request. At S1312, the stored data obtainer 404 obtains the selected electronic data, which can be specified using the bibliographic data that is received from the controller 402, from the data storage 405.

At S1313, the stored data obtainer 424 transmits the obtained electronic data to the controller 402. At S1314 and S1315, the controller 402 transmits the obtained electronic data to the controller apparatus 102 through the data transmit/receive 401.

At S1316 of FIG. 13B, the data transmit/receive 421 of the controller apparatus 102 transmits the received electronic data to the electronic data obtainer 424. At S1317, the electronic data obtainer 424 transmits the obtained electronic data to the controller 422.

At S1318, the controller 422 transmits a conversion request to the data converter 425, which requests the data converter 425 to convert the electronic data received from the data storage apparatus 110 to print data compatible with specific application specified by the application specific information, together with the obtained electronic data to be processed.

At S1319, the data converter 425 calls a conversion program that converts the electronic data to print data, which is previously selected from among the conversion programs stored in the conversion program storage 428. Using the conversion program, the data converter 425 converts the electronic data to print data having a data format that can be printed by the image forming apparatus 101. The converted data format is a data format that is previously determined when generating the electronic data list for the print application.

Further, when the data request received from the image forming apparatus 101 includes printing condition information indicating the printing conditions of the print data, the data converter 425 generates the print data according to the printing condition information that is requested. When the data request does not include such printing condition information, the data converter 425 generates the print data according to default printing condition information that is previously set at the controller apparatus 102.

The default printing condition information may be set irrespective of a specific data format of electronic data. Alternatively, the default printing condition information may be set according to a specific data format of electronic data. For example, the default printing condition information for the electronic data having the “.txt” data format may be set such that the print data is generated in monochrome, double-sided, and “2in1” aggregated (indicating that 2 pages of print data is printed on one page of recording sheet). The default printing condition information for the electronic data having the “.ppt” data format may be set such that the print data is generated in color and double-sided.

At S1320, the data converter 425 transmits the converted electronic data, i.e., the print data to the controller 422.

At S1321 and S1322, the controller 422, which receives the print data from the data converter 425, transmits the print data to the image forming apparatus 101 through the data transmit/receive 421.

In case the electronic data that is received from the data storage apparatus 110 already has a data format that can be printed by the image forming apparatus 101, the data converter 425 does not have to convert the data format of the electronic data. In such case, S1318 to S1320 does not have to be performed such that the controller 422 transmits the unconverted electronic data that is received at S1317 to the image forming apparatus 101 via the data transmit/receive 421 at S1321, as the converted electronic data (or the print data in this example).

At S1323, the data transmit/receive 415 of the image forming apparatus 101 transmits the received print data to the data obtainer 414. At S1324, the data obtainer 414 transmits the received print data to the controller 412 in response to the data request received from the controller 412.

At S1325, the controller 412 transmits the received print data to the printer 416 to request printing of the print data in response to the print request received from the display 411 at S1301. At S1326, the printer 416 prints the print data to output a printed image, in response to the print request, and the operation ends.

In the above-described example illustrated in FIG. 13, it is assumed that the user requests to print the selected electronic data. Alternatively, the user may instruct the image forming apparatus 101 to perform various other operations as described above referring to FIG. 6D. In one example, when the user requests the image forming apparatus 101 to display a preview image of the selected electronic data by selecting the “Display Preview” key of the data list screen of FIG. 6D, at S1303, the controller 412 transmits application specific information indicating that preview display of the selected electronic data, and data specific information indicating the selected electronic data to the controller apparatus 102. S1301 to S1324 may be performed in a substantially similar manner as described above in case of requesting printing of the electronic data, except that the electronic data is converted to have a data format compatible with the display application. At S1325 and S1326, the controller 412 causes the display 411 to display a preview image of the electronic data, and the operation ends.

In another example, when the user requests the image forming apparatus 101 to delete the selected electronic data by selecting the “Delete” key of the data list screen of FIG. 6D, at S1303, the controller 412 transmits application specific information indicating that deletion of the selected electronic data, and data specific information indicating the selected electronic data to the controller apparatus 102. S1301 to S1311 may be performed in a substantially similar manner as described above in case of requesting printing of the electronic data. At S1312, the stored data obtainer 404 deletes the selected electronic data stored in the data storage 405. At S1313 to S1315, the stored data obtainer 404 transmits a response reporting deletion of the selected electronic data to the controller apparatus 102 via the data transmit/receive 401. The controller apparatus 102 sends the response indicating deletion of the selected electronic data to the image forming apparatus 101, and the operation ends.

In another example, when the user requests the image forming apparatus 101 to distribute the selected electronic data by selecting a “TRANSMIT” key, which may be displayed by the data list screen of FIG. 6D when the tab “DISTRIBUTE” is selected, at S1303, the controller 412 transmits application specific information indicating that distribution of the selected electronic data, and data specific information indicating the selected electronic data to the controller apparatus 102. S1301 to S1321 may be performed in a substantially similar manner as described above in case of requesting printing of the electronic data, except that the electronic data is converted to have a data format compatible with the distribution application. Instead of transmitting the converted electronic data to the image forming apparatus 101, the controller 422 of the controller apparatus 102 may cause the data transmit/receive 421 to transmit the electronic data to a destination apparatus specified by the user at the image forming apparatus 101. The controller apparatus 102 may receive information regarding the destination apparatus together with a request for distributing the electronic data.

As described above referring to FIGS. 2 to 13, the user at the image forming apparatus 101 is able to use the electronic data stored in the data storage apparatus 110 to perform processing such as obtaining an electronic data list, obtaining electronic data in a data format compatible with specific application, and printing or deleting the obtained electronic data, etc.

Further, in the above-described example, the controller apparatus 102 obtains the bibliographic data of the electronic data stored in the data storage apparatus 110, from the data storage apparatus 110 in response to the data list request received from the image forming apparatus 101 to cause the image forming apparatus 110 to display a list of electronic data based on the bibliographic data. When the data request for requesting specific processing of selected electronic data is received, the controller apparatus 102 obtains the selected electronic data from the data storage apparatus 110, and sends the selected electronic data to the image forming apparatus 101 for further processing. When transmitting the selected electronic data, the controller apparatus 102 may convert a data format of the electronic data compatible with the specific application, i.e., the specific processing, to be applied to the selected electronic data.

Alternatively, the controller apparatus 102 may obtain all files of electronic data that are included in the electronic data list from the data storage apparatus 110, in response to the data list request, together with the bibliographic data of electronic data, and stores the obtained electronic data files in a memory. For example, any desired memory of the controller apparatus 102 illustrated in FIG. 2 may function as an electronic data storage. When the controller apparatus 102 receives the data request for requesting selected electronic data from the image forming apparatus 101, the controller apparatus 102 may transmit the selected electronic data, which is obtained from the memory functioning as the electronic data storage, to the image forming apparatus 101 for further processing. In obtaining the electronic data files that are listed in the electronic data list, the controller apparatus 102 may only obtain the electronic data files that are convertible from the data storage apparatus 110.

In the above-described example illustrated in FIG. 13, it is assumed that the user requests the image forming apparatus 101 to process electronic data stored in one data storage apparatus 110. Alternatively, the user may request the image forming apparatus 101 to process any desired number of electronic data files stored in more than one data storage apparatus 110.

For example, the user may request the data control system of FIG. 1 to transmit electronic data using a portable phone such as a smart phone. In such case, the controller apparatus 102 determines specific application based on the device type information indicating the portable device 1 (FIG. 11A), and converts electronic data to have a data format compatible with the determined application such as “html display”. Accordingly, the user does not have to worry about a data format of electronic data, when storing the electronic data in the data control system or when requesting electronic data to be processed, no matter what device type is used to log in the data control system.

While performing operation of authenticating a user as described above referring to FIG. 5, at S501 to S511, it is assumed that a plurality of sets of data storage name 703, associated user name 704, and associated password 705 is obtained for the user, based on the user identification information input by the user and the association data stored in the association data storage 427 (FIG. 7). In such case, the controller 422 of the controller apparatus 102 requests each one of the plurality of data storage apparatuses 110 specified by the data storage name 703 to determine whether use of a specific function of the data storage apparatus 110 is allowed by the user using each determination data, for example, by performing S512 to S520 for each one of the data storage apparatuses 110 specified by the data storage name 703. At S521, the controller 422, which receives a plurality of determination results, generates an authentication result indicating whether authentication succeeds or fails. As described above referring to FIG. 5, in this example, the authentication result indicating that authentication is successful is generated when at least one determination result indicates that use of the specific function of the data storage apparatus 110 is allowed. However, in the following examples, it is assumed that the controller 422 generates an authentication result indicating that authentication is successful, based on a plurality of determination results that are received from a plurality of data storage apparatuses 110, each indicating that use of the specific function of the data storage apparatus 110 is allowed. In such case, at S525, the display 411 of the image forming apparatus 101 displays a screen of FIG. 6B or FIG. 6C, which displays a plurality of data storage apparatuses 110 that are available for use by the user.

Using the screen of FIG. 6B or FIG. 6C, the user at the image forming apparatus 101 may send a request for obtaining an electronic data list as described above referring to FIG. 10. More specifically, in this example, it is assumed that the user selects all of the data storage apparatuses 110 that are listed to request for an electronic data list for each one of the data storage apparatuses 110. In such case, at S1005, the electronic data obtainer 424 of the controller apparatus 102 sends a request for obtaining bibliographic data to each one of the data storage apparatuses 110 such that S1006 to S1014 are performed for each one of the data storage apparatuses 110. At S1014, the electronic data obtainer 424 obtains the bibliographic data of electronic data stored in each one of the data storage apparatuses 110.

At S1015, the electronic data obtainer 424 generates an electronic data list, which lists one or more electronic data files that are stored in the data storage apparatuses 110 using the bibliographic data. At S1016, the electronic data obtainer 424 sends the electronic data list to the controller 422. In the electronic data list, information regarding each one of the electronic data files, which may be generated using at least a part of the bibliographic data, is associated with a specific data storage apparatus 110 that stores the electronic data. Further, the electronic data list may be stored in a memory of the controller apparatus 102. At S1021, the display 411 of the image forming apparatus 101 may display an electronic data list, which lists one or more electronic data files that are available for further processing in a manner such that the user is able to know which electronic data file is stored in which data storage apparatus 110.

Referring back to FIG. 13, at S1301, the user may send a request for printing more than one electronic data. At S1307, the electronic data obtainer 424 of the controller apparatus 102 sends a request for obtaining selected electronic data to each one of the data storage apparatuses 110 storing the selected electronic data, through the data transmit/receive 421, to obtain the selected electronic data from the respective data storage apparatuses 110. More specifically, S1307 to S1316 are performed for each one of the data storage apparatuses 110 storing selected electronic data. At S1318, the controller 422 further sends a request for converting a data format of the selected electronic data to the data converter 425 such that the converted electronic data is transmitted to the image forming apparatus 101. In this case, the controller 422 determines whether data format conversion is necessary for each one of the selected electronic data files.

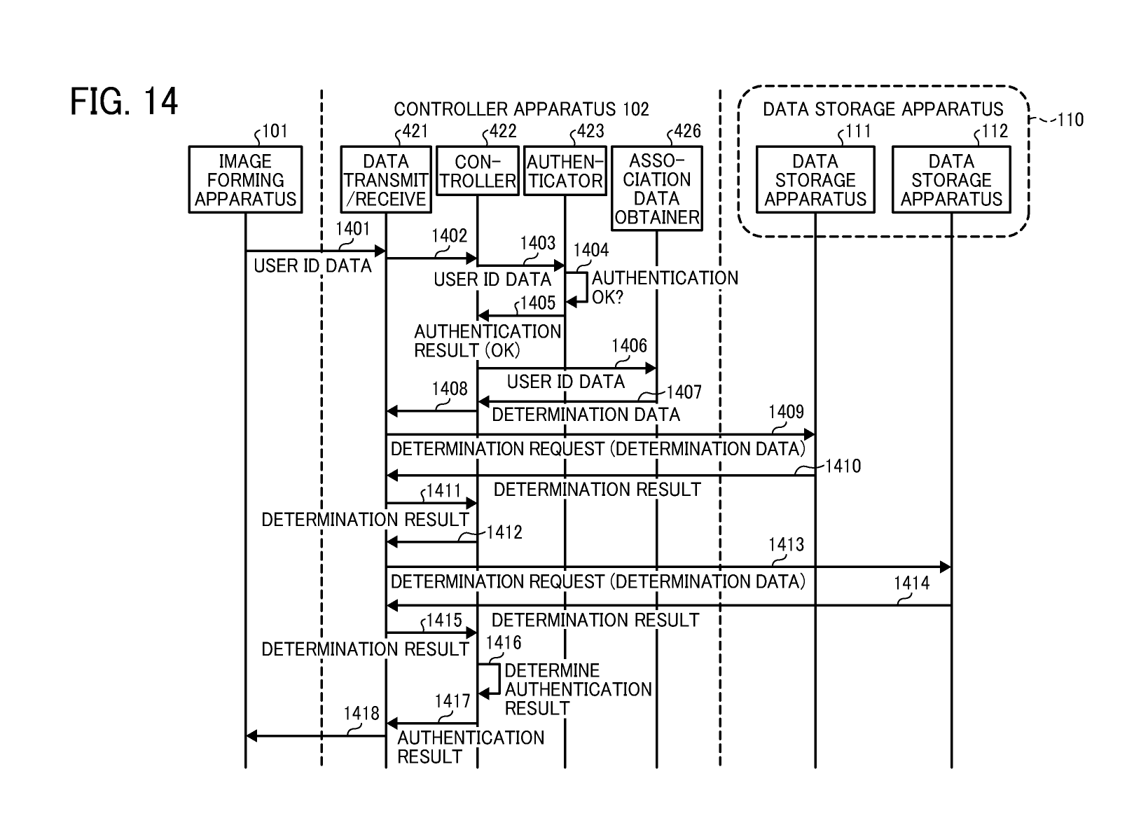

The above-described operations of communicating with a plurality of data storage apparatuses 110 are explained in more detail referring to FIGS. 14, 15, and 16. In the following examples, it is assumed that the controller apparatus 102 communicates with the data storage apparatus 111 and the data storage apparatus 112 (collectively referred to as the data storage apparatus 110). The number of data storage apparatuses 110, however, is not limited to two.

FIG. 14 is a data sequence diagram illustrating operation of authenticating a user, performed by the data control system of FIG. 1, according to an example embodiment of the present invention. More specifically, operation of FIG. 5 is performed by one or more processors of the data control system of FIG. 1, such as the CPU 3111 of the image forming apparatus 101, the CPU 204 of the controller apparatus 102, the CPU 204 of the data storage apparatus 111, and the CPU 204 of the data storage apparatus 112.

The image forming apparatus 101 receives user identification information from the user, in a substantially similar manner as described above referring to S501 to S504 of FIG. 5. At S1401, the image forming apparatus 101 sends the user identification information (“USER ID DATA”) to the controller apparatus 102.

The controller apparatus 102 performs S1402 to S1406 to authenticate the user using the user identification information in a substantially similar manner as described above referring to S506 to S510. It is assumed that user authentication by the authenticator 423 is successful.

At S1407, the association data obtainer 426 of the controller apparatus 102 obtains a plurality of sets of the data storage name 703 and the determination data (the associated user name 704 and the associated password 705), which are associated with the user identification information transmitted from the controller 422, from the association data stored in the association data storage 427. The association data obtainer 426 further transmits the plurality of sets of the data storage name 703 and the determination data to the controller 422.

The controller 422 transmits a determination request for determining whether use of a specific function of the data storage apparatus 110 is allowed, together with the determination data, to each one of the data storage apparatuses 110 that are specified by the data storage names 703.

More specifically, at S1408 and S1409, the controller 422 transmits a determination request to the data storage apparatus 111 through the data transmit/receive 421. The data storage apparatus 111, which receives the determination request, performs operation of generating a determination result as described above referring to S514 to S518 (FIG. 5), and at S1410, transmits the determination result to the controller apparatus 102. At S1411, the data transmit/receive 421 transmits the received determination result to the controller 422.

At S1412 and S1413, the controller 422 of the controller apparatus 102 transmits a determination request to the data storage apparatus 112 through the data transmit/receive 421. The data storage apparatus 112, which receives the determination request, performs operation of generating a determination result as described above referring to S514 to S518 (FIG. 5), and at S1414, transmits the determination result to the controller apparatus 102. At S1415, the data transmit/receive 421 transmits the received determination result to the controller 422.

At S1416, the controller 422 analyzes the determination results that are received from the data storage apparatuses 111 and 112, respectively, to determine whether all determination results each indicate that use of the specific function of the data storage apparatus 110 is not allowed. When it is determined that all determination results each indicate that use of the specific function of the data storage apparatus is not allowed, the controller 422 generates an authentication result indicating that authentication fails. When it is determined that at least one determination result indicates that use of the specific function of the data storage apparatus is allowed, the controller 422 generates an authentication result indicating that authentication is successful together with information indicating the data storage name that is allowed for access. At S1417 and S1418, the controller 422 of the controller apparatus 102 transmits the authentication result to the image forming apparatus 101 through the data transmit/receive 421. The image forming apparatus 101, which receives the authentication result, causes the display 411 to display the screen of FIG. 6B or 6C when authentication is successful. The image forming apparatus 101 causes the display 411 to display the screen of any one of FIGS. 9A to 9D when authentication fails.

When authentication is successful, the image forming apparatus 101 may automatically request the controller apparatus 102 to obtain an electronic data list for each one of the data storage apparatuses 110 that are allowed for access, without displaying the screen of FIG. 6B or 6C.

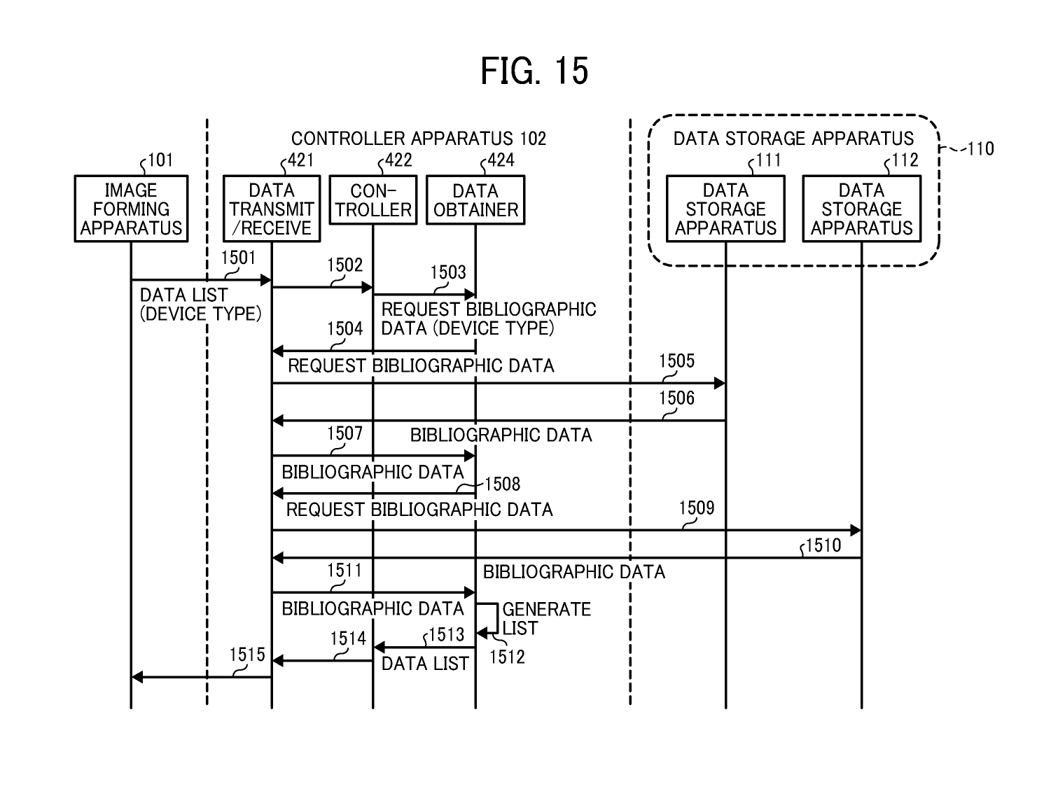

FIG. 15 is a data sequence diagram illustrating operation of requesting a list of electronic data stored in the data storage apparatus 110, performed by the data control system of FIG. 1, according to an example embodiment of the present invention. More specifically, operation of FIG. 15 is performed by one or more processors of the data control system of FIG. 1, such as the CPU 3111 of the image forming apparatus 101, the CPU 204 of the controller apparatus 102, the CPU 204 of the data storage apparatus 111, and the CPU 204 of the data storage apparatus 112. Further, operation of FIG. 15 is performed when the user authentication process of FIG. 14 is successful.

At S1501, the image forming apparatus 101 transmits a request for obtaining an electronic data list for each one of the data storage apparatus 111 and the data storage apparatus 112, to the controller apparatus 102. S1502 and S1503 may be performed in a substantially similar manner as described above referring to S1004 and S1005 of FIG. 10.

The electronic data obtainer 424 of the controller apparatus 102 requests the bibliographic data of the electronic data for each one of the data storage apparatus 111 and the data storage apparatus 112.

At S1504 and S1505, the electronic data obtainer 424 transmits a request for obtaining bibliographic data to the data storage apparatus 111 through the data transmit/receive 421. The data storage apparatus 111, which receives the data list request, performs operation of obtaining bibliographic data in a substantially similar manner as described above referring to S1008 to S1012 of FIG. 10, and, at S1506, transmits the obtained bibliographic data to the controller apparatus 102. At S1507, the data transmit/receive 421 transmits the received bibliographic data to the electronic data obtainer 424.

At S1508 and S1509, the electronic data obtainer 424 transmits a request for obtaining bibliographic data to the data storage apparatus 112 through the data transmit/receive 421. The data storage apparatus 112, which receives the data list request, performs operation of obtaining bibliographic data in a substantially similar manner as described above referring to S1008 to S1012 of FIG. 10, and, at S1510, transmits the obtained bibliographic data to the controller apparatus 102. At S1511, the data transmit/receive 421 transmits the received bibliographic data to the electronic data obtainer 424.

At S1512, the electronic data obtainer 424 generates an electronic data list based on the bibliographic data received from the data storage apparatus 111 and the data storage apparatus 112. For each of electronic data having its bibliographic data transmitted from the data storage apparatus 110, the electronic data obtainer 424 performs operation of determining whether the electronic data is convertible as described above referring to S1015 of FIG. 10 (FIGS. 12A to 12C). For example, the electronic data obtainer 424 may generate the electronic data list such that information regarding electronic data that is convertible and information regarding electronic data that is not convertible are displayed differently. Further, in the electronic data list, information indicating the electronic data is associated with information indicating the data storage apparatus 110 that stores the electronic data.

At S1513, the electronic data obtainer 424 transmits the electronic data list to the controller 422. At S1514 and S1515, the controller 422 transmits the electronic data list to the image forming apparatus 101 through the data transmit/receive 421. The controller 422 may transmit the electronic data list such that the electronic data list generated based on the bibliographic data received from the data storage apparatus 111 can be differentiated from the electronic data list generated based on the bibliographic data received from the data storage apparatus 112.

More specifically, in this example, the controller 422 transmits the electronic data list that is generated based on the bibliographic data received from the data storage apparatus 111 at one time. The controller 422 transmits the electronic data list that is generated based on the bibliographic data received from the data storage apparatus 112 at the other time. The controller 422 may further send a message indicating that transmission of electronic data list for all of the selected data storage apparatuses 110 is completed, to the image forming apparatus 101.

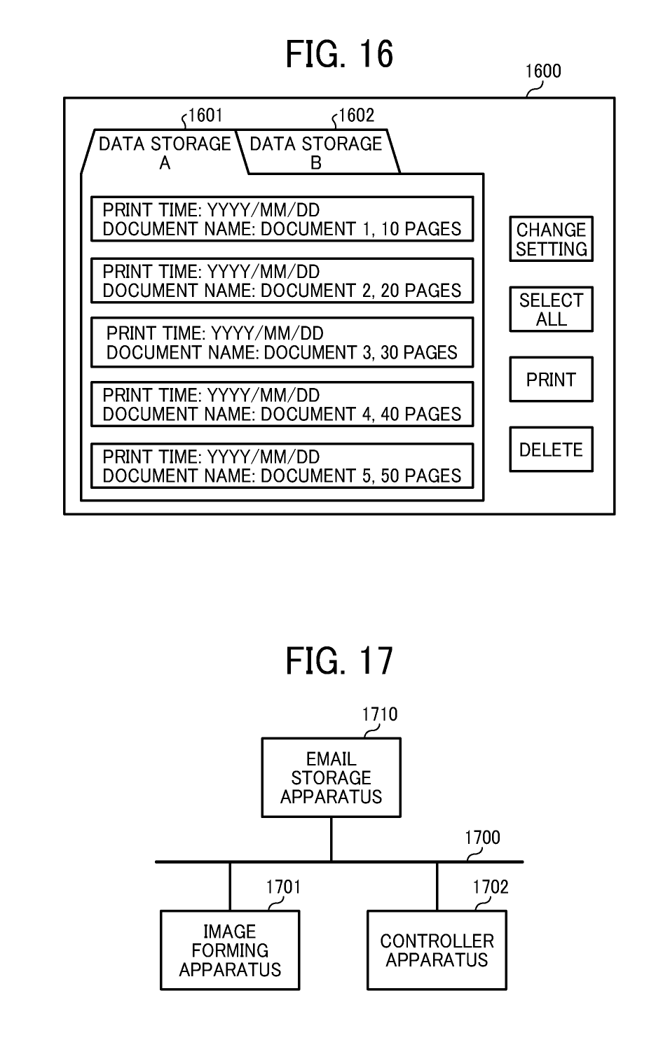

The image forming apparatus 101 stores a plurality of electronic data lists that is received from the controller apparatus 102 in a memory, by the data storage name. Based on the stored electronic data lists, the image forming apparatus 101 causes the display 411 to display a data list screen 1600 illustrated in FIG. 16.

The data list screen 1600 of FIG. 16 displays a list of electronic data files that are available for use by the user for each one of the data storage apparatuses 111 and 112, by data storage name each indicated by a tab. The data list screen 1600 of FIG. 16 displays a list of electronic data files that are stored in the data storage apparatus 111 having the storage name “A” for the print application, under a tab 1601 indicating the data storage “A”. The user may switch the tab 1601 to a tab 1602 indicating the data storage “B” to display an electronic data list for the data storage apparatus 112. More specifically, when the tab 1601 is switched to the tab 1602, the image forming apparatus 101 reads out an electronic data list that is associated with the selected data storage name from the memory, and causes the display 411 to display a list of electronic data files based on the read electronic data list. With this data list screen 1600, the user is able to view a list of electronic data files that are stored in each one of the data storage apparatuses 110.

As described above referring to FIGS. 14 to 16, the user at the image forming apparatus 101 is able to obtain electronic data from a plurality of data storage apparatuses 110 to perform processing such as printing or deleting. More specifically, even when electronic data files are not stored at one place, the user can easily obtain a list of electronic data available to the user or a plurality of electronic data lists available on the network at once.

Referring now to FIGS. 17 to 23, a data control system is explained according to an example embodiment of the present invention. FIG. 17 illustrates a configuration of a data control system according to an example embodiment of the present invention. The data control system of FIG. 17 is substantially similar to the data control system of FIG. 1, except that an email storage apparatus 1710 is provided in replace of the data storage apparatus 110, as one example of data storage apparatuses. More specifically, the data control system of FIG. 17 includes an image forming apparatus 1701, a controller apparatus 1702, and the email storage apparatus 1710, which are connected through a network 1700.

The email storage apparatus 1710, which may be implemented by an email server, stores therein email data transmitted by a user through an information processing apparatus. Examples of the information processing apparatus include, but not limited to, a personal computer (PC), portable phone such as smart phone, tablet such as iPad (Registered Trademark), digital camera, any other personal digital assistant (PDA), an image forming apparatus, a client terminal such as a thin client terminal, and any other desired apparatus. The email storage apparatus 1710 further transmits email data, which is stored, to the controller apparatus 1702 in response to a request received from the controller apparatus 1702. In this example, the email storage apparatus 1710 may be implemented by one or more computers each having a hardware structure similar to the hardware structure described above referring to FIG. 2.

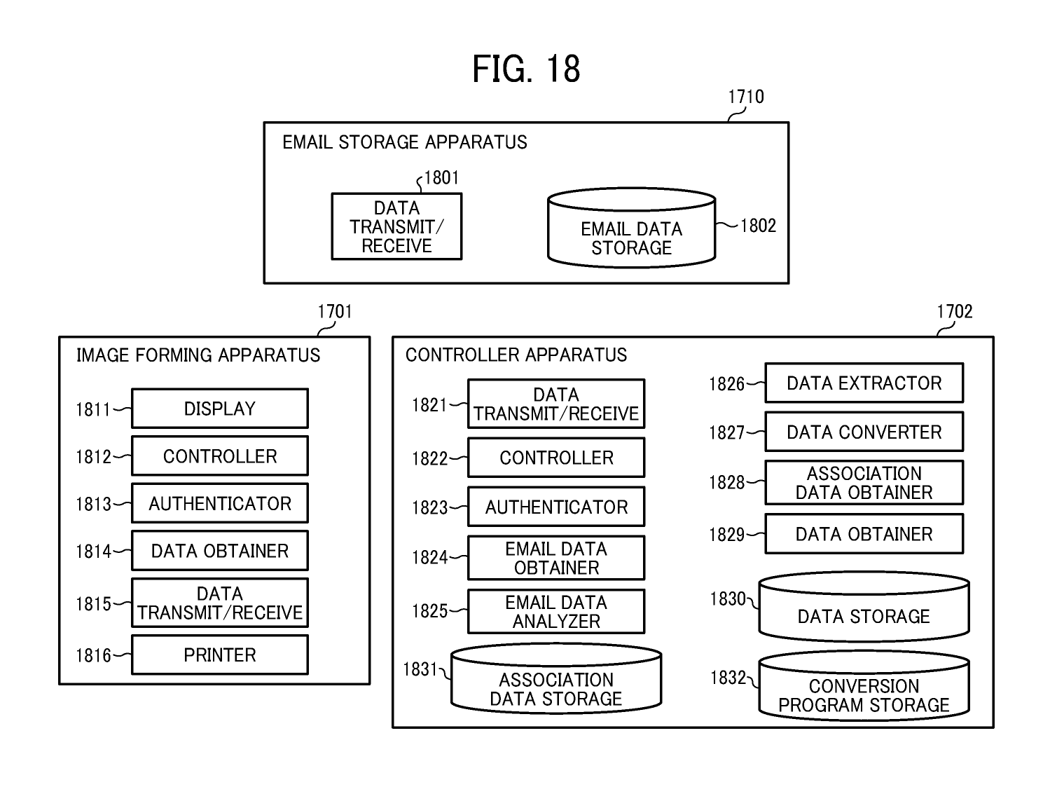

FIG. 18 illustrates a functional structure of the image forming apparatus 1701, the controller apparatus 1702, and the email storage apparatus 1710 of the data control system of FIG. 17, according to an example embodiment of the present invention.

The image forming apparatus 1701 includes a display 1811, a controller 1812, an authenticator 1813, a data obtainer 1814, a data transmit/receive 1815, and a printer 1816, which are substantially similar in function and operation to the display 411, controller 412, authenticator 413, data obtainer 414, data transmit/receive 415, and printer 416 of the image forming apparatus 101 of FIG. 4. These units or devices that are shown in FIG. 18 correspond to a plurality of modules, which are executed according to an instruction of the CPU 3111 (FIG. 3) that is generated according to the control program being loaded from the ROM 3113 or HDD 3114 onto the RAM 3112, in cooperation with one or more hardware circuits or devices of the image forming apparatus 1701.

The controller apparatus 1702 includes a data transmit/receive 1821, a controller 1822, an authenticator 1823, a data converter 1827, an association data obtainer 1828, an electronic data obtainer 1829, an association data storage 1831, and a conversion program storage 1832, which are substantially similar in function and operation to the data transmit/receive 412, controller 422, authenticator 423, data converter 425, association data obtainer 426, electronic data obtainer 424, association data storage 427, and conversion program storage 428 of the controller apparatus 102 of FIG. 4.

The controller apparatus 1702 further includes an email data obtainer 1824, an email data analyzer 1825, a data extractor 1826, and electronic data storage 1830. These units or devices that are shown in FIG. 18 correspond to a plurality of modules, which are executed according to an instruction of the CPU 204 (FIG. 2) that is generated according to the control program being loaded from the supplementary memory 202 onto the memory 203, in cooperation with one or more hardware circuits or devices of the controller apparatus 1702.

The email data obtainer 1824, which may be implemented by the CPU 204, obtains email data stored in the email storage apparatus 1710.

The email data analyzer 1825, which may be implemented by the CPU 204, analyzes the email data obtained by the email data obtainer 1824, and sets various parameters of condition information in processing the electronic data, which is obtainable from the contents of the email data.

The data extractor 1826, which may be implemented by the CPU 204, extracts electronic data to be processed, from the email data obtained by the email data obtainer 1824 or using the email data obtained by the email data obtainer 1824.

The electronic data storage 1830 stores electronic data to be processed. For example, the electronic data storage 1830 may be implemented by an internal memory of the controller apparatus 1702 such as the supplementary memory 202, or any external memory that can be accessed by the controller apparatus 1702 such as a database server. The electronic data to be processed may be electronic data obtained by the data extractor 1826 or electronic data converted by the data converter 1827 based on the condition information that is obtained by the email data analyzer 1825. The electronic data storage 1830 manages the stored electronic data in association with user address information that is included in the email data. The user address information specifies an address of a sender that transmits the email data to the email storage apparatus 1710. In this example, the user address information may be used as data specific information that specifies the electronic data stored in the electronic data storage 1830.

The email storage apparatus 1710 includes a data transmit/receive 1801, and an email data storage 1802. These units or devices that are shown in FIG. 18 correspond to a plurality of modules, which are executed according to an instruction of the CPU 204 (FIG. 2) that is generated according to the control program being loaded from the supplementary memory 202 onto the memory 203, in cooperation with one or more hardware circuits or devices of the email storage apparatus 1710.

The data transmit/receive 1801, which may be implemented by the interface 205, transmits or receives various data or information to or from the other apparatus through the network 1700.

The email data storage 1802 stores email data transmitted from a user using an information processing apparatus through the network 1700. The email data storage 1802 may be implemented by a memory such as the supplementary memory 202.

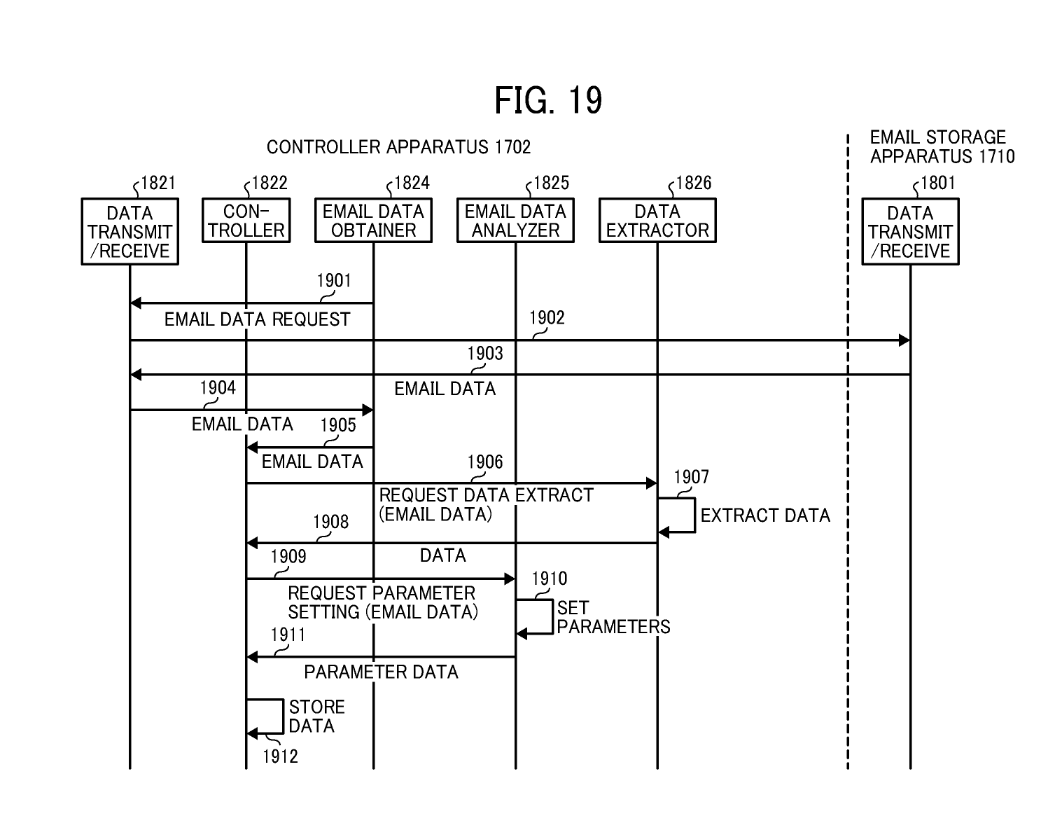

FIG. 19 is a data sequence diagram illustrating operation of obtaining email data and storing electronic data to be processed, performed by the data control system of FIG. 17, according to an example embodiment of the present invention. More specifically, operation of FIG. 19 is performed by one or more processors of the data control system of FIG. 17, such as the CPU 204 of the controller apparatus 1702, and the CPU 204 of the email storage apparatus 1710.

At S1901, the email data obtainer 1824 of the controller apparatus 1702 monitors email data stored in the email storage apparatus 1710. For example, at S1901 and S1902, the email data obtainer 1824 periodically transmits a request for transmitting email data, to the email storage apparatus 1710 through the data transmit/receive 1821.

At S1903, the data transmit/receive 1801 of the email storage apparatus 1710 transmits email data stored in the email data storage 1802, in response to the email data request received from the controller apparatus 1702.

At S1904, the data transmit/receive 1821 of the controller apparatus 1702 transmits the received email data to the email data obtainer 1824. By periodically performing S1901 to S1904, the email data obtainer 1824 accumulates email data in the controller apparatus 1702, which is to be processed by the controller apparatus 1702, as the email storage apparatus 1710 receives email data from one or more information processing apparatuses on the network 1700.

At S1905, the email data obtainer 1824 transmits the received email data to the controller 1822. At S1906, the controller 1822, which receives the email data from the email data obtainer 1824, transmits the received email data to the data extractor 1826 to request the data extractor 1826 to extract, from the email data, electronic data to be processed.

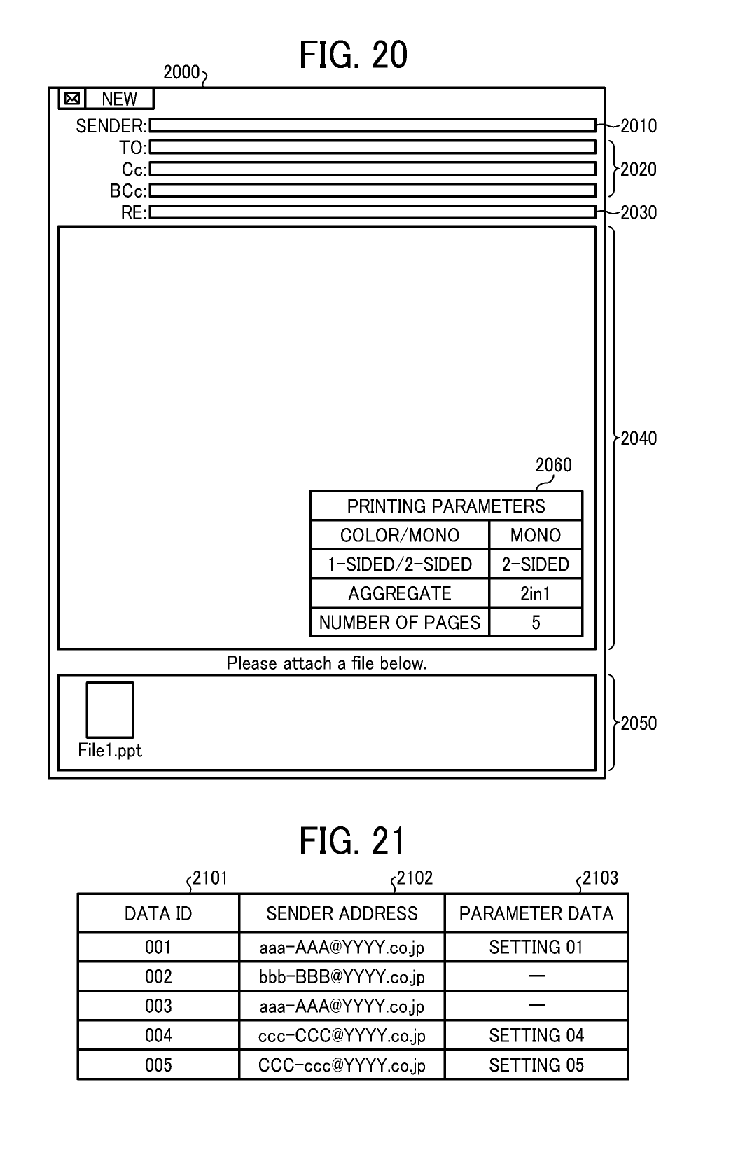

FIG. 20 illustrates a data structure of email data 2000, which is obtained by the email data obtainer 1824 of the controller apparatus 1702. For the descriptive purposes, the email data of FIG. 20 is shown in the form of a window, which may be displayed to the user when creating an email message to be sent to the email storage apparatus 1710. The email data 2000 includes a sender address field 2010, a destination address field 2020, a subject field 2030, a text field 2040, a file attachment field 2050, and a condition information area 2060. For example, the user at the information processing apparatus may execute an email creation program to cause the information processing apparatus to display the window shown in FIG. 20.

The sender address field 2010 is input with an address of a sender who sends email data to the email storage apparatus 1710 using email transmission function of an information processing apparatus. When the information processing apparatus is stored with an address of the user, the information processing apparatus may automatically input such sender address or cause such sender address to be included in the email data, as the information processing apparatus is able to identify the user who logs into the system. Further, the information processing apparatus does not have to display the sender address field 2010 in the window used for creating email data.

The destination address field 2020 is input with an address of a destination to which the email data is transmitted. In this example, it is assumed that the address of the email storage apparatus 1710 is input or selected by the user.

The subject field 2030 is input with a subject such as a title of the email data, which may be arbitrarily input by the user who creates the email data. The text field 2040 is input with text of the email data, such as a message input by the user. The file attachment field 2050 is used to attach an electronic data file thereto. More specifically, the user attaches electronic data to be processed to the file attachment field 2050. In this example illustrated in FIG. 20, it is assumed that the user attaches the electronic data “File1.ppt” to request printing of the electronic data.

The condition information area 2060, which is included in the text field 2040, is input with condition information, which indicates various parameters to be used for processing the electronic data to be processed. More specifically, in this example illustrated in FIG. 20, the condition information area 2060 is input with printing conditions such as various printing parameters to be used for printing the electronic data attached to the file attachment field 2050.

In alternative to the data structure of the email data 2000 of FIG. 20, the email data having any desired data structure may be obtained by the controller apparatus 1702 for further processing. For example, the electronic data file to be processed may be attached to the text field 2040.

Further, in this example illustrated in FIG. 20, the condition information is input according to a predetermined format as specified by the condition information area 2060. Alternatively, a setting file that includes the condition information may be attached to the file attachment field 2050. Alternatively, one or more keywords may be written in the text field 2040, which functions as the condition information. Alternatively, the condition information does not have to be provided. As described below, the email data analyzer 1825 of the controller apparatus 1702 analyzes the condition information according to a predetermined format. As long as the email data analyzer 1825 is able to analyze specific values of a plurality of items of parameters, the condition information indicating specific values of the plurality of items of parameters may be specified in various other ways.

Further, in this example, the sender address of the email data is used to specify the email data or the electronic data to be processed that is obtained from the email data. Since the sender address is used to specify the electronic data to be processed, it may function as the determination data that is described above referring to FIGS. 1 to 16. In alternative to or in addition to the sender address information, any desired data may be used to specify the electronic data to be processed.

Referring back to FIG. 19, at S1907, the data extractor 1826, which receives the request for extracting electronic data to be processed, extracts the electronic data from the email data. At S1908, the data extractor 1826 sends the extracted electronic data to be processed, to the controller 1822.

The extracted electronic data to be processed includes any attachment electronic data file that is attached to the file attachment field 2050 or the text field 2040, a text file in which the text input in the text field 2040 is written, and/or electronic data that is linked to path information that is input in the text field 2040. The path information may be written in URL.

At S1909, the controller 1822 of the controller apparatus 1702 transmits email data to the email data analyzer 1825 to request for analyzing the email data and setting condition information based on the analysis. At S1910, the email data analyzer 1825, which receives the request from the controller 1822, sets the condition information obtained by analyzing the email data such that the condition information can be used for processing the electronic data that is specified at S1907. In the example case of email data 2000 of FIG. 20, the electronic data to be processed “File1.ppt”, which is attached to the file attachment field 2050, is set with printing condition information input to the condition information area 2060. More specifically, in this example, the printing condition information indicates that the electronic data is to be printed in monochrome, double-sided, and “2in1” aggregated, and that a total of 5 sets of the electronic data are to be printed.

At S1911, the email data analyzer 1825 transmits the set condition information to the controller 1822. At S1912, the controller 1822 stores, in the electronic data storage 1830, the electronic data extracted by the data extractor 1826, the condition information set by the email data analyzer 1825, and the sender address information included in the email data, in association with one another, and the operation ends. The information stored in the electronic data storage 1830 is described below referring to FIG. 21.

S1906 to S1908 of extracting the electronic data to be processed, and S1909 to S1911 of setting condition information may be performed in any order or concurrently.

FIG. 21 illustrates an example data structure of electronic data management information stored in the electronic data storage 1830. The electronic data management information of FIG. 21 stores, for each one of electronic data files to be processed, data identification information 2101 (“DATA ID”) that identifies the electronic data to be processed, sender address information 2102 (“SENDER ADDRESS”) that indicates a sender address of email data (electronic data) that is transmitted to the email storage apparatus 1710, and condition identification information 2103 (“PARAMETER DATA”) that identifies condition information set for the electronic data, in association with one another. The data identification information 2101, which identifies the electronic data to be processed, is assigned to each electronic data file that is extracted by the data extractor 1826 and stored in a memory.

For example, it is assumed that the electronic data to be processed includes a text file of the text that is input to the text field 2040 (except for the condition information), and a first attachment data file 1 and a second attachment data file 2 that are respectively extracted from the file attachment field 2050. The data identification information 2101 is assigned to each one of the text file, the first attachment data file, and the second attachment data file.

With this data identification information 2101, any electronic data to be processed, which is stored in the electronic data storage 1830, may be specified such that specific electronic data may be obtained using the data identification information 2101, or any data that is associated with the data identification information 2101 such as the sender address information.

The condition identification information 2103 may be assigned to the condition information extracted by the email data analyzer 1825. With this condition identification information 2103, the condition information to be used for processing the electronic data can be obtained, using the electronic data management information.

More specifically, the electronic data storage 1830 stores therein the electronic data management information such as the information of FIG. 21, the condition information, and the electronic data to be processed. The condition information does not have to be included in the email data. If the condition information is not included in the email data, the electronic data management information indicates that the condition information is not available. In such case, the condition information, which is set by default, may be used.

As described above referring to FIG. 19, the electronic data, which is extracted from the email data obtained from the email storage apparatus 1710, is stored in the electronic data storage 1830 of the controller apparatus 1702 for further processing.

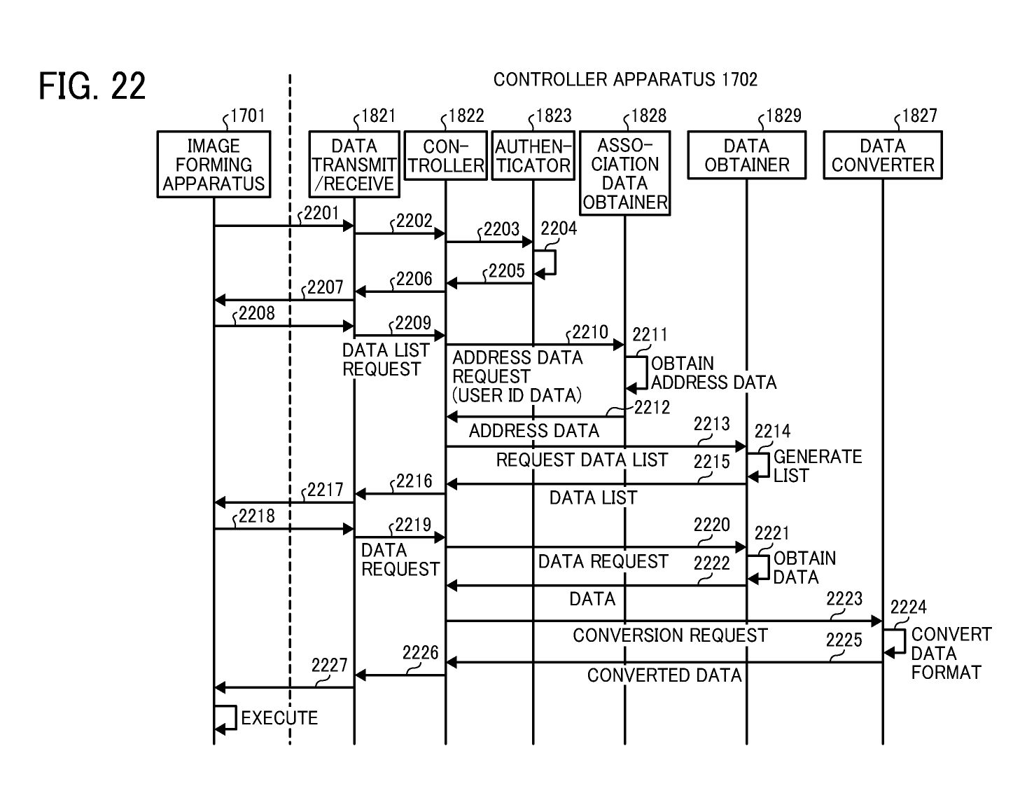

Referring now to FIG. 22, operation of printing electronic data managed by the controller apparatus 1702, performed by the data control system of FIG. 17, is explained according to an example embodiment of the present invention. Operation of FIG. 22 may be performed by one or more processors of the data control system of FIG. 17, such as the CPU 3111 of the image forming apparatus 1701, and the CPU 204 of the controller apparatus 1702.

At S2201, the image forming apparatus 1701 performs operation of obtaining user identification information of a user in a substantially similar manner as described above referring to S501 to S504 of FIG. 5, and transmits the obtained user identification information of the user to the controller apparatus 1702. For example, the user name or the user ID, and the password may be transmitted as the user identification information.

At S2202, the data transmit/receive 1821 of the controller apparatus 1702, which receives the user identification information from the image forming apparatus 1701, transmits the user identification information to the controller 1822 of the controller apparatus 1702. S2203 to S2205 are performed in a substantially similar manner as described above referring to S507 to S509 of FIG. 5. In this example, it is assumed that an authentication result generated by the authenticator 1823 indicates that authentication is successful.

At S2206 and S2207, the controller 1822, which receives the authentication result indicating that authentication is successful, transmits the authentication result to the image forming apparatus 1701 through the data transmit/receive 1821. The image forming apparatus 1701, which receives the authentication result, performs operation of displaying a screen based on the authentication result in a substantially similar manner as described above referring to S523 to S525 of FIG. 5. In this example, it is assumed that the screen of FIG. 6B or 6C is displayed to the user.

The image forming apparatus 1701 further performs operation of requesting an electronic data list in a substantially similar manner as described above referring to S1000 to S1002 of FIG. 10. At S2208, the image forming apparatus 101 sends a data list request for obtaining an electronic data list to the controller apparatus 1702, together with device type information of the image forming apparatus 1701.

At S2209, the data transmit/receive 1821 of the controller apparatus 1702, which receives the data list request, transmits the data list request to the controller 1822. At S2210, the controller 1822, which receives the data list request, transmits the user identification information to the association data obtainer 1828 to request for obtaining address information of the user using association data stored in the association data storage 1828. The address information may be used as data specific information that identifies specific electronic data.

Alternatively, the controller apparatus 1702 may automatically proceed to operation of obtaining an electronic data list without waiting for a request for an electronic data list from the user. In such case, S2206 to S2209 may not be performed such that the controller 1822, which receives the authentication result, automatically requests for address information that is associated with the user identification information. Further, in such case, the image forming apparatus 1701 sends device type information to the controller apparatus 1702, with the user identification information at S2201.

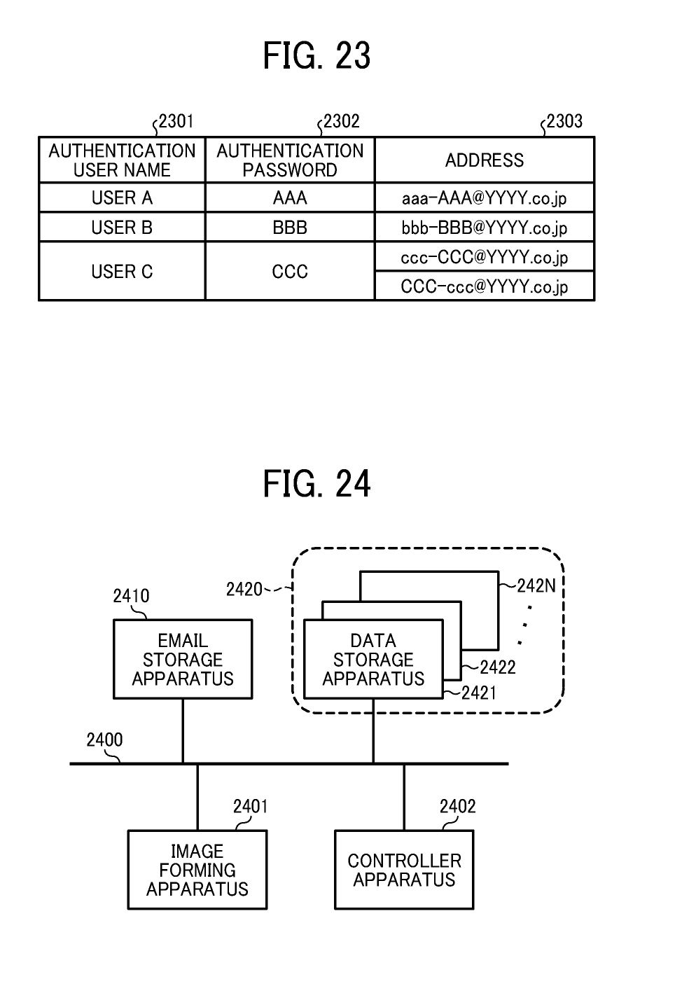

FIG. 23 illustrates an example data structure of the association data stored in the association data storage 1831. The association data storage 1831 includes, for each one of the users who registered in the data control system of FIG. 17, an authentication user name 2301, an authentication password 2302, and address information 2303, which are associated with one another. The authentication user name 2301 and the authentication password 2302 may be collectively used as authentication information to authenticate the user. More specifically, when the user name and the password that are received from the image forming apparatus 1701 matches the authentication user name 2301 and the authentication password 2302, the user is authenticated.

The address information 2303 may be implemented by an email address assigned to the user identified by the authentication information. The address information 2303 is used to select specific electronic data, from electronic data files to be processed that are stored in the electronic data storage 1830. The address information 2303 is previously stored, for example, by a user using the controller apparatus 1702 or any other desired information processing apparatus. More than one address information 2303 may be associated with authentication information including the authentication user name 2301 and the authentication password 2302.

Referring back to FIG. 22, at S2211, the association data obtainer 1828 obtains the address information, based on the user identification information received from the controller 1822, and the association data obtained from the association data storage 1831. More specifically, the association data obtainer 1828 specifies the authentication user name 2301 and the authentication password 2302, which match the received user identification information, from the association data stored in the association data storage 1831. The association data obtainer 1828 further obtains the address information 2303, which is associated with the authentication information (the authentication user name 2301 and the authentication password 2302).

At S2212, the association data obtainer 1828 transmits the obtained address information to the controller 1822. At S2213, the controller 1822 transmits the address information received from the association data obtainer 1828 and the device type information of the image forming apparatus 1701, to the electronic data obtainer 1829 to request for an electronic data list. The association data obtainer 1828 sends a request for obtaining an electronic data list based on the device type information and the address information, to the electronic data obtainer 1829.

At S2214, the electronic data obtainer 1829, which receives the data list request, generates an electronic data list based on the device type information and the address information. More specifically, in order to specify electronic data to be processed, which matches the address information received from the controller 1822, the electronic data obtainer 1829 searches the electronic data management information stored in the electronic data storage 1830 (FIG. 21) for the sender address information 2102 that matches the received address information. The electronic data obtainer 1829 further obtains data identification information 2101 that is associated with the sender address information 2102 that matches the received address information. The electronic data obtainer 1829 obtains bibliographic data of the electronic data that is specified by the obtained data identification information 2101, from the electronic data storage 1830. Using the obtained bibliographic data of the electronic data, the electronic data obtainer 1829 generates an electronic data list for specific application, based on the obtained bibliographic data of the electronic data. As described above, specific application can be determined using the device type information. For example, the electronic data list for specific application is generated after performing operation of determining whether the electronic data is convertible in a substantially similar manner as described above referring to FIGS. 12A, 12B, and 12C.

For example, the electronic data list may be generated so as to include information indicating a title of the email data, or bibliographic data such as a number of pages of electronic data. The bibliographic data of electronic data may be obtained, for example, when the email data analyzer 1825 analyzes the email data or when the data extractor 1826 extracts the electronic data to be processed. The controller 1822 may store the bibliographic data in association with the electronic data to be processed, in the electronic data storage 1830.

At S2215, the electronic data obtainer 1829 transmits the electronic data list, which is generated in response to the data list request, to the controller 1822. At S2216 and S2217, the controller 1822, which receives the electronic data list from the electronic data obtainer 1829, transmits the electronic data list to the image forming apparatus 1701 through the data transmit/receive 1821.

The image forming apparatus 1701, which receives the electronic data list, causes the display 1811 to display a data list screen as described above referring to S1019 to S1021 of FIG. 10.

The image forming apparatus 1701 further performs operation of requesting printing of electronic data, as described above referring to S1301 to S1304 of FIG. 13. At S2218, the image forming apparatus 1701 sends a request for obtaining electronic data to the controller apparatus 1702, together with application specific information and data specific information. The data specific information may be any information that can identify the electronic data to be processed such as a file name obtained from the bibliographic data.

At S2219, the data transmit/receive 1821 transmits the request for obtaining electronic data to the controller 1822. At S2220, the controller 1822, which receives the data request, transmits the data request to the electronic data obtainer 1829 together with the data specific information of the electronic data. At S2221, the electronic data obtainer 1829 obtains the electronic data to be processed from the electronic data storage 1830, using the data specific information.

More specifically, the electronic data obtainer 1829 obtains the electronic data that is associated with the obtained data specific information. For example, when a part or all of bibliographic data is used as the data specific information, the electronic data obtainer 1829 specifies bibliographic data, which is managed in association with the electronic data, using the part or all of the bibliographic data. The electronic data obtainer 1829 further obtains the electronic data that is associated with the specified bibliographic data.

At S2222, the electronic data obtainer 1829, which obtains the electronic data, transmits the electronic data to be processed to the controller 1822. At S2223, the controller 1822, which receives the electronic data, transmits the electronic data and application specific information to the data converter 1827 to request for converting the electronic data to have a data format compatible with specific application.

At S2224, the data converter 1827, which receives the data format conversion request, converts the electronic data from an original data format to a data format compatible with specific application indicated by the application specific information. In this example, the data converter 1827 converts the electronic data to print data for printing. At S2225, the data converter 1827 transmits the converted electronic data to the controller 1822. At S2226 and S2227, the controller 1822, which receives the converted electronic data, sends the converted electronic data to the image forming apparatus 1701 through the data transmit/receive 1821. The image forming apparatus 1701 performs operation of printing the electronic data in a substantially similar manner as described above referring to S1323 to S1326 of FIG. 13 to output a printed image, and the operation ends.

As described above referring to FIGS. 17 to 23, the user is able to transmit the email data to the email storage apparatus 1710 to perform processing such as printing of electronic data using the image forming apparatus 1701.

The above-described operation may be performed in various other ways. For example, some steps of the above-described operations referring to FIGS. 19 and 22 may be performed concurrently. For example, the controller apparatus 1702, which obtains email data to be processed, may perform data format conversion on the electronic data that is obtained using the email data without waiting for a request for obtaining specific electronic data from a user. In such case, according to the electronic data management information of FIG. 21 indicating a list of electronic data to be processed, the controller 1822 of the controller apparatus 1702 may send a data format conversion request to the data converter 1827, to perform data format conversion as described above referring to S2223 to S2225 of FIG. 22. In this manner, the data control system of FIG. 17 is able to concurrently perform data format conversion as email data indicating electronic data to be processed is obtained.

Referring now to FIGS. 24 to 27, a data control system is explained according to an example embodiment of the present invention. FIG. 24 illustrates a configuration of a data control system according to an example embodiment of the present invention. The data control system of FIG. 24 includes an image forming apparatus 2401, a controller apparatus 2402, one or more email storage apparatuses 2410 (“the email storage apparatus 2410”), and one or more data storage apparatuses 2421 to 242N (“the data storage apparatus 2420”), which are connected through a network 2400. The image forming apparatus 2401, the controller apparatus 2402, the email storage apparatus 2410, and the data storage apparatus 2420 are substantially similar in hardware structure to the image forming apparatus 101, the controller apparatus 102, the email storage apparatus 1710, and the data storage apparatus 110.

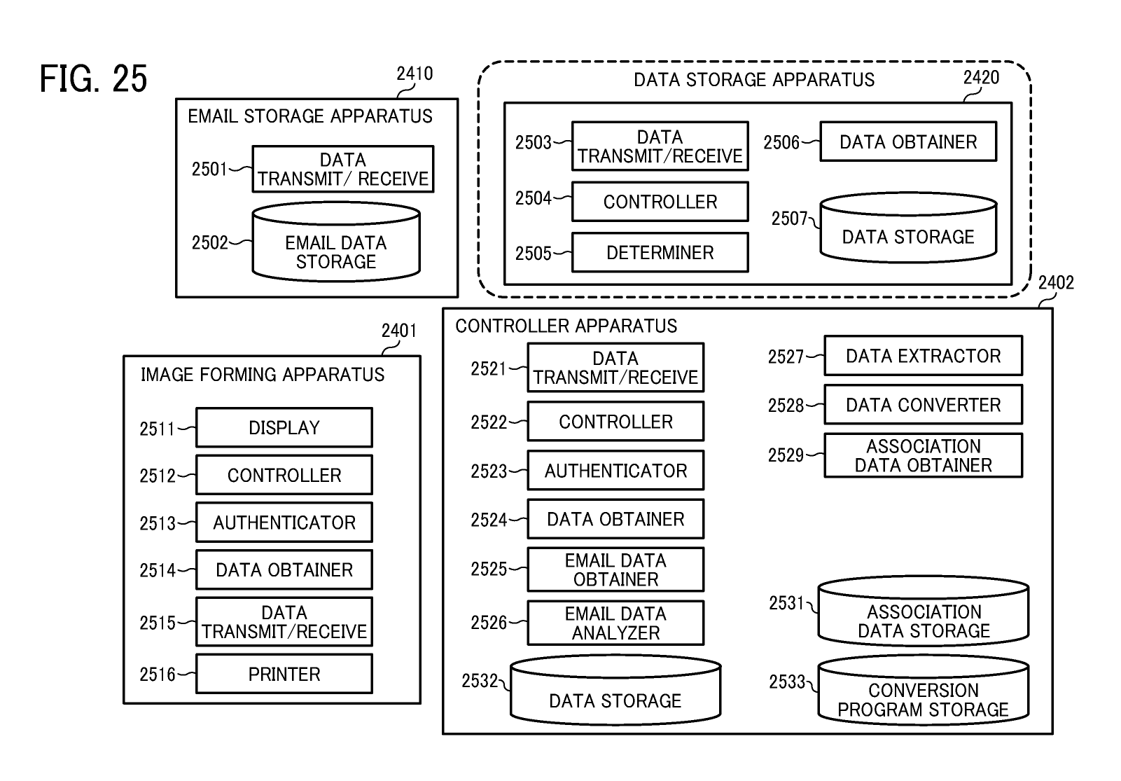

FIG. 25 illustrates a functional structure of the image forming apparatus 2401, the controller apparatus 2402, the email storage apparatus 2410, and the data storage apparatus 2420 of the data control system of FIG. 24, according to an example embodiment of the present invention. The image forming apparatus 2401, the controller apparatus 2402, the email storage apparatus 2410, and the data storage apparatus 2420 are substantially similar in functional structure to the image forming apparatus 101, the controller apparatus 102, the email storage apparatus 1710, and the data storage apparatus 110, such that description thereof is omitted.

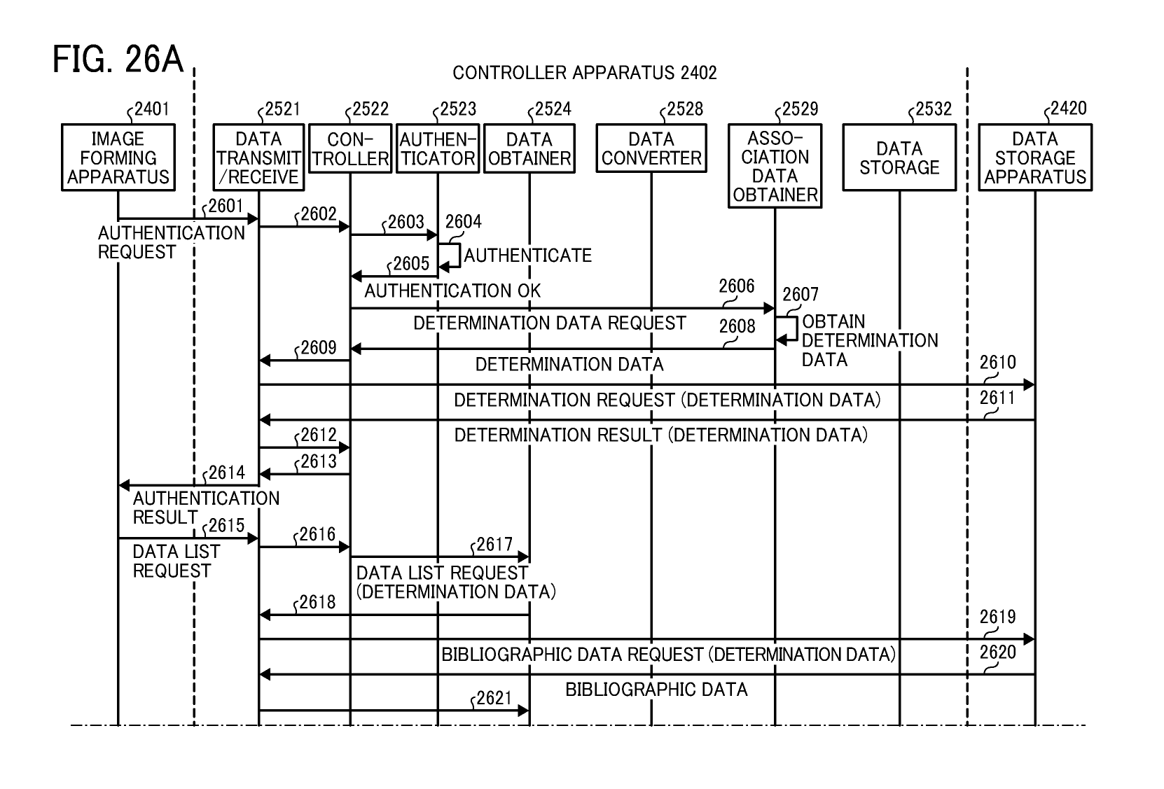

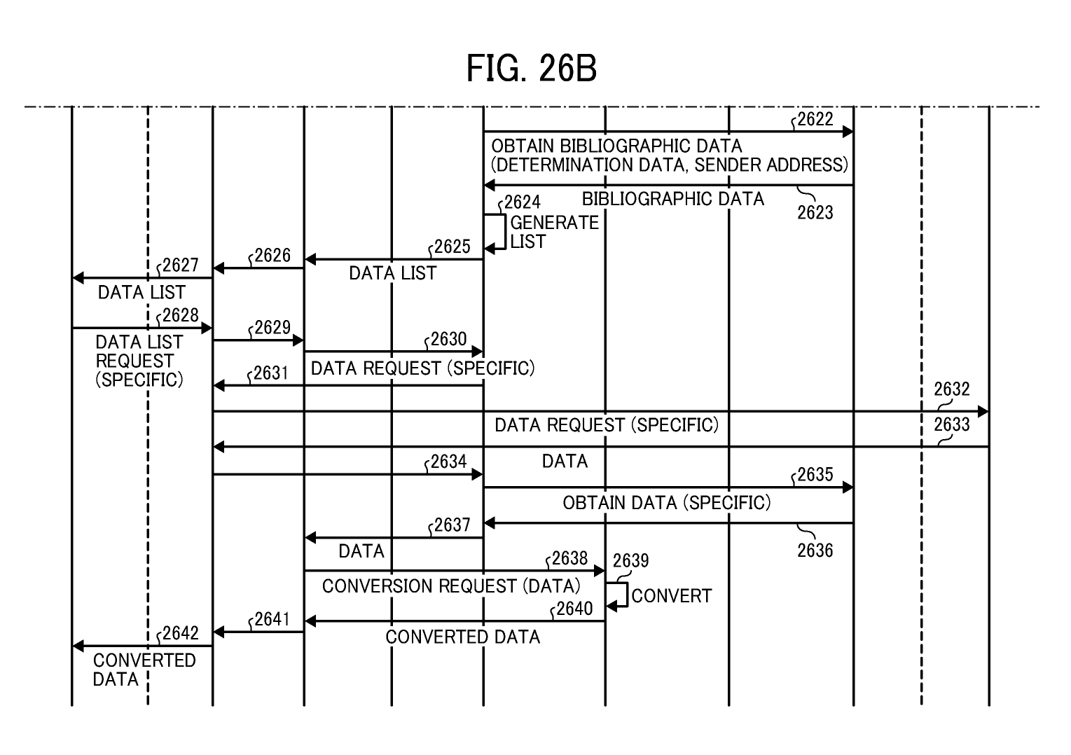

FIGS. 26A and 26B (FIG. 26) are a data sequence diagram illustrating operation of authenticating a user, requesting an electronic data list, and obtaining electronic data, performed by the data control system of FIG. 24, according to an example embodiment of the present invention. Further, in this example, it is assumed that operation of storing email data and electronic data to be processed is performed at any desired time, for example, periodically, as described above referring to FIG. 19. Accordingly, the electronic data storage 2532 (FIG. 25) of the controller apparatus 2402 stores therein electronic data to be processed, which is obtained using the email data obtained from the email storage apparatus 2410.

At S2601, the image forming apparatus 2401 sends user identification information input by the user at the image forming apparatus 2401, to the controller apparatus 2402 to request for authentication of the user. The image forming apparatus 2401 performs operation of receiving user identification information in a substantially similar manner as described above referring to S501 to S504 of FIG. 5.

At S2602, the data transmit/receive 2521 of the controller apparatus 2402 transmits the authentication request, together with the received user identification information, to the controller 2522. At S2603, the controller 2522 sends the authentication request to the authenticator 2523, which requests for authenticating the user using the received user identification information. At S2604, the authenticator 2523 authenticates the user using the user identification information in response to the authentication request. The user authentication process is performed by the authenticator 2523 in a substantially similar manner as described above referring to S508 of FIG. 5.

At S2605, the authenticator 2523 sends the authentication result to the controller 2522. When the authentication result indicates that authentication fails, the controller 2522 transmits the authentication result indicating that authentication fails to the image forming apparatus 2401 through the data transmit/receive 2512. When the authentication result indicates that authentication is successful, the operation proceeds to S2606 as illustrated in FIG. 26A.

At S2606, the controller 2522, which receives the authentication result indicating that authentication is successful, transmits the user identification information to the association data obtainer 2529 to request for obtaining determination data that is associated with the user identification information. At S2607, the association data obtainer 2529, which receives the request for obtaining the determination data, uses the association data stored in the association data storage 2531 to obtain the determination data that is associated with the user identification information received from the controller 2522.

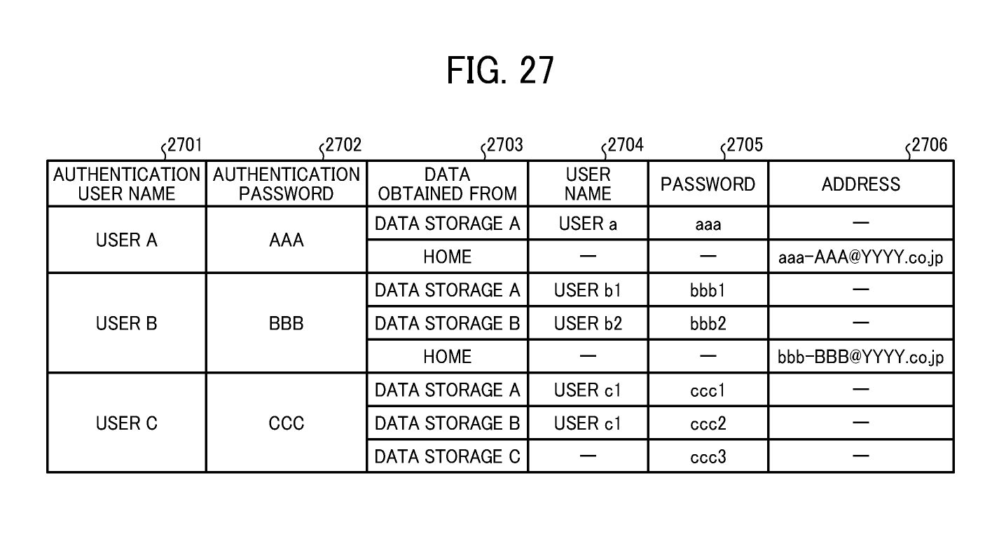

FIG. 27 illustrates an example data structure of the association data that is stored in the association data storage 2531. The association data storage 2531 stores therein user identification information (authentication user name 2701 and authentication password 2702), data storage information 2703 (“DATA OBTAINED FROM”), and determination data (associated user name 2704 and associated password 2705, or address information 2706), in association with one another, for each of the users who registered in the data control system of FIG. 24.

The association data of FIG. 27 differs from the association data of FIG. 7 such that the data storage name 703 is replaced with the data storage information 2703, and that the determiantion data further includes the address information 2706. The data storage information 2703 includes identification information that identifies specific place where the electronic data that is available to the user is stored. For example, the data storage information 2703 includes the data storage name such as the data storage “A” or the data storage “B”, or “HOME” indicating that the electronic data is stored in the controller apparatus 2402 such as in the electronic data storage 2532.

Using the data storage information 2703, the controller apparatus 2402 is able to determine whether the electronic data is stored in one of the data storage apparatus 2420 or the electronic data storage 2532 of the controller apparatus 2402. More specifically, when the electronic data is stored in the outside data storage apparatus 2420, the data storage name is entered as the data storage information 2703. In such case, the address information 2706 is not entered, while the user name 2704 and the password 2705 are entered. When the electronic data is stored in the electronic data storage 2532 using the email transmission function, the value “HOME” is entered. In such case, the address information 2706 is entered, while the user name 2704 and the password 2705 are not entered.

The association data obtainer 2529 obtains the association data, such as the association data illustrated in FIG. 27. More specifically, the association data obtainer 2529 specifies the user identification information (the authentication user name 2701 and the authentication password 2702) in the association data, which matches the user identification information received from the controller 252. The association data obtainer 2529 further obtains the data storage specification 2703 that is associated with the specified user identification information, and the determination data (the user name 2704 and the password 2705, or the address information 2706) that is associated with the obtained data storage information 2703.

At S2608, the association data obtainer 2529 sends the data storage information 2703 and the determination data to the controller 2522. At S2609 and S2610, the controller 2522 transmits a determination request to the data storage apparatus 2420 through the data transmit/receive 2521, based on the data storage information 2703 and the determiantion data. More specifically, the controller 2522 specifies a data storage apparatus 2420 using the data storage information 2703, and sends a determination request to the specified data storage apparatus 2420 to request for determining whether use of a specific function of the data storage apparatus 2420 is allowed by the user using the determination data. When the obtained data storage information 2703 does not indicate any data storage apparatus 2420, the controller 2522 does not generate a determination request to be transmitted to the data storage apparatus 2420. In such case, S2610 to S2612 are not performed.

At S2611, the data storage apparatus 2420 determines whether use of the specific function of the data storage apparatus 2420 is allowed by the user using the determination data in response to the determination request, and transmits the determination result to the controller apparatus 2402, in a substantially similar manner as described above referring to S514 to S519 of FIG. 5.

At S2612, the data transmit/receive 2521 of the controller apparatus 2402 transmits the determination result received from the data storage apparatus 2420 to the controller 2522. At S2613 and S2614, the controller 2522 generates an authentication result based on the determination result, and transmits the authentication result to the image forming apparatus 2401 through the data transmit/receive 2521 in response to the authentication request. In case the determination request for the data storage apparatus 2420 is not generated at S2610, the controller 2402 transmits the authentication result generated by the authenticator 2523 at S2604 to the image forming apparatus 2401. In this example, the authentication result includes information indicating a specific apparatus that stores the electronic data, such as whether the data storage apparatus 2420 or the controller apparatus 2402 stores the electronic data.

Assuming that the authentication result indicates that authentication result is successful, at S2615, the image forming apparatus 2401 further transmits a request for obtaining a list of electronic data to the controller apparatus 2402, in a substantially similar manner as described above referring to S1000 to S1003 of FIG. 10.

At S2616, the data transmit/receive 2521 of the controller apparatus 2402, which receives the data list request from the image forming apparatus 2401, transmits the data list request to the controller 2522. The controller 2522 starts operation of obtaining an electronic data list of electronic data stored in the data storage apparatus 2420 or the controller 2402 as specified by the data storage information 2703, in response to the data list request.

Assuming that the data storage information 2703 specifies the data storage apparatus 2420, at S2617, the controller 2522 sends the data list request to the electronic data obtainer 2524 to obtain a list of electronic data stored in the data storage apparatus 2420.

At S2618 and S2619, the electronic data obtainer 2524 transmits a request for bibliographic data of the electronic data to the data storage apparatus 2420 specified by the data storage information 2703, through the data transmit/receive 2521. At S2620, the data storage apparatus 2420, which receives the bibliographic data request, transmits the bibliographic data of the electronic data to the controller apparatus 2402, in a substantially similar manner as described above referring to S1008 to S1012 of FIG. 10.

At S2621, the electronic data obtainer 2524 of the controller apparatus 2402 receives the bibliographic data through the data transmit/receive 2521. In case the bibliographic data is obtained from each one of a plurality of data storage apparatuses 2420, the controller apparatus 2402 performs operation of S2618 to S2621 for each one of the plurality of data storage apparatuses 2420. In one example, the electronic data obtainer 2524 may generate an electronic data list for each one of the data storage apparatuses 2420 based on the bibliographic data, as the bibliographic data is received from the data storage apparatus 2420. The electronic data lists may be merged into an electronic data list after all of electronic data lists are obtained. In another example, the electronic data obtainer 2524 may generate an electronic data list reflecting electronic data stored in all of the selected data storage apparatuses 2420, after obtaining the bibliographic data from all of the selected data storage apparatuses 2420.

Assuming that the data storage information 2703 specifies the controller apparatus 2402, at S2622 and S2623, the electronic data obtainer 2524 obtains the bibliographic data from the electronic data storage 2532 using the address information that is obtained at S2608. At S2624, the electronic data obtainer 2524 generates an electronic data list based on the bibliographic data obtained from the data storage apparatus 2420 and the electronic data storage 2523. At S2625, the electronic data obtainer 2524 transmits the electronic data list to the controller 2522.

The electronic data obtainer 2524 manages the electronic data lists, such that the electronic data list generated based on the bibliographic data obtained from the data storage apparatus 2420 can be differentiated from the electronic data list generated based on the bibliographic data obtained from the electronic data storage 2532. For example, the electronic data obtainer 2524 manages the electronic data list in association with information indicating the place where the electronic data is stored such as whether the data storage apparatus 2420 or the electronic data storage 2532.

In this manner, when a request for obtaining specific electronic data is received from the image forming apparatus 2401, the electronic data obtainer 2524 is able to determine from which apparatus (the data storage apparatus 2420 or the electronic data storage 2532) the electronic data should be obtained.

When the controller 2522 obtains the electronic data lists from all of the apparatuses specified by the data storage information 2703, at S2626 and S2627, the controller 2522 transmits the electronic data list to the image forming apparatus 2401 through the data transmit/receive 2521. The image forming apparatus 2402 causes the display 2511 to display a data list screen, in a substantially similar manner as described above referring to S1019 to S1021 of FIG. 10.

At S2628, the image forming apparatus 2401 further transmits a request for obtaining specific electronic data that is selected by the user from the electronic data list to the controller apparatus 2402, together with application specific information, in a substantially similar manner as described above referring to S1301 to S1305 of FIG. 13.

At S2629, the data transmit/receive 2521 of the controller apparatus 2402 transmits the data request received from the image forming apparatus 2401 to the controller 2522. At S2630, the controller 2522 transmits the data request for obtaining electronic data to the electronic data obtainer 2524. In this example, any number of files of electronic data may be specified, which may be stored in any one of the data storage apparatus 2420 and the electronic data storage 2532.

At S2631, the electronic data obtainer 2524, which receives the data request, determines whether the electronic data that is requested is stored in the data storage apparatus 2420. When it is determined that the electronic data is stored in the data storage apparatus 2420, at S2631 and S2632, the electronic data obtainer 2524 transmits the data request for obtaining specific electronic data to the data storage apparatus 2420 through the data transmit/receive 2521. At S2633, the data storage apparatus 2420 obtains the electronic data as specified by the data request, and transmits the electronic data to the controller apparatus 2402. At S2634, the data transmit/receive 2521 of the controller apparatus 2402 transmits the received electronic data to the electronic data obtainer 2524.

At S2635 and S2636, the electronic data obtainer 2524 determines whether specific electronic data that is requested by the data request is stored in the electronic data storage 2532. When the electronic data is stored in the electronic data storage 2532, at S2635 and S2636, the electronic data obtainer 2524 obtains specific electronic data from the electronic data storage 2532.

When all of electronic data files that are requested by the data request are obtained, at S2637, the electronic data obtainer 2524 sends the electronic data to the controller 2522. At S2638, the controller 2522 transmits a data format conversion request to the data converter 2528, which requests the data converter 2528 to convert the electronic data to have a data format compatible with specific application. At S2639, the data converter 2528 converts an original data format of the electronic data to a data format compatible with specific application, using a conversion program that is specified using the application information and the conversion data list of the conversion program storage 2533. At S2640, the data converter 2528 transmits the converted electronic data to the controller 2522.

When the converted electronic data is received, at S2641 and S2642, the controller 2522 transmits the converted electronic data to the image forming apparatus 2401 through the data transmit/receive 2521. In case there is any electronic data that cannot be obtained, the controller 2402 sends an error message indicating specific electronic data that is not obtained, to the image forming apparatus 2401.

The image forming apparatus 2401, which receives the electronic data having a data format compatible with specific application, performs specific processing as requested by the user.

As described above referring to FIGS. 24 to 27, the user is able to process electronic data that is available in the data control system of FIG. 24, such as electronic data that is stored in the data storage apparatus 2420 or obtained using email data stored in the email storage apparatus 2410, irrespective of an apparatus through which the user sends a request.

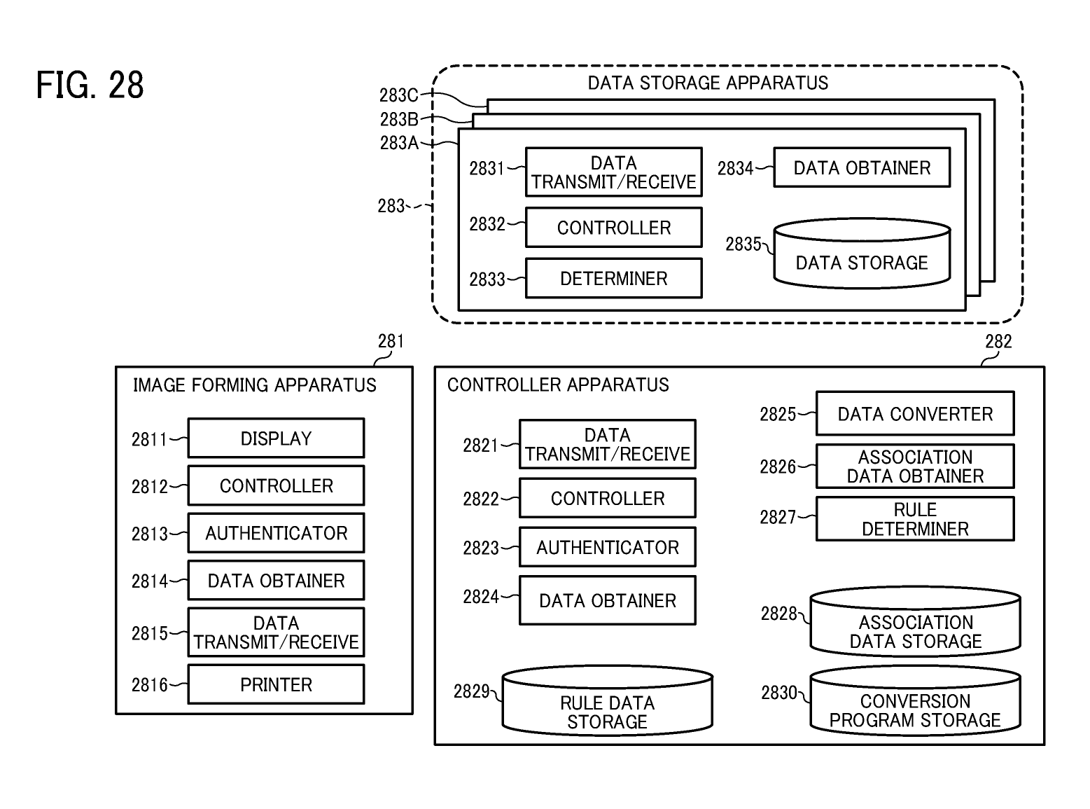

Referring now to FIGS. 28 to 30, a data control system is explained according to an example embodiment of the present invention. The data control system of FIG. 28 is substantially similar in configuration or hardware structure to the data control system of FIG. 1, which includes an image forming apparatus 281, a controller apparatus 282, and a data storage apparatus 283. In addition to or in replace of the data storage apparatus 283, an email storage apparatus may be provided in the data control system of FIG. 28. The differences between the data control system of FIG. 28 and any one of the above-described data control systems of FIGS. 1, 17, and 24 include a communication process between the controller apparatus and each one of the data storage apparatuses to obtain a determination result. More specifically, each data storage apparatus performs the determination process differently according to its own rule.

For example, in the above-described examples, the controller apparatus uses the user identification information (user name and password) of the user, which is received from the image forming apparatus, to determine whether use of a specific function of the data storage apparatus is allowed by the user. As long as determination data that is associated with the user identification information is obtained using the association data, electronic data that is stored in the data storage apparatus is made available for use by the user.

In reality, however, the data storage apparatus does not always perform the determination process as described above, depending on a type of the data storage apparatus. For example, some data storage apparatuses may require authentication of a specific device that sends a determination request before processing the determination request. Some data storage apparatuses may require authentication of connection with a specific device that sends a determination request before processing the determination request. In the following example, the data control system of FIG. 28 takes into account these differences in determination process among different storage services of the data storage apparatus 283.

For example, for some data storage apparatuses 283, to authenticate the controller apparatus 282 that sends the determination request, the data storage apparatus 283 requests the controller apparatus 282 to transmit identification information that identifies the controller apparatus 282 to the data storage apparatus 283. When the data storage apparatus 283 determines that the controller apparatus 282 is an apparatus that is registered as an authenticated apparatus, the data storage apparatus 283 allows the controller apparatus 282 to communicate with the data storage apparatus 283.

In another example, for some data storage apparatuses 283, to authenticate connection with the controller apparatus 282 that sends the determination request, the data storage apparatus 283 requests the controller apparatus 282 to transmit authentication information such as a password to the data storage apparatus 283. In this example, the password is set common to users, who may use services of the data storage apparatus 283. When the data storage apparatus 283 determines that the connection with the controller apparatus 282 is authenticated based on the password, the data storage apparatus 283 allows the controller apparatus 282 to communicate with the data storage apparatus 283.

The data storage apparatus 283 may perform authentication process in various other ways, depending on services that are provided by the data storage apparatus 283.

Further, the determination data to be used for determining whether access or use of the data storage apparatus 283 may differ among the data storage apparatuses 283. In one example, for some data storage apparatuses 283, the user identification information that identifies a user is used as the determination data, such as a user name and a password. Alternatively or additionally, organization identification information that identifies a specific organization, such as a company, may be used as the determination data, such as an organization code. Alternatively, some data storage apparatuses 283 may not require any determination process such that no determination data is required.

FIG. 28 illustrates a functional structure of the image forming apparatus 281, the controller apparatus 282, and the data storage apparatus 283 of the data control system according to an example embodiment of the present invention. The image forming apparatus 281 and the data storage apparatus 283 are in a substantially similar to the image forming apparatus 101 and the data storage apparatus 110 of FIG. 4.

The controller apparatus 282 includes a data transmit/receive 2821, a controller 2822, an authenticator 2823, an electronic data obtainer 2824, a data converter 2825, an association data obtainer 2826, an association data storage 2828, and a conversion program storage 2830, which are substantially similar to the data transmit/receive 412, controller 422, authenticator 423, electronic data obtainer 424, data converter 425, association data obtainer 426, association data storage 427, and conversion program storage 428 of FIG. 4.

The controller apparatus 282 further includes a rule determiner 2827 and a rule data storage 2829.

The rule determiner 2827 of the controller apparatus 282 obtains determination rule information, which is specific to the data storage apparatus 283, from the rule data storage 2829. The rule determiner 2827 transmits the obtained rule information to the other unit or device of the controller apparatus 282 in response to a request from the other unit or device.

The rule data storage 2829 of the controller apparatus 282 stores determination rule information for each one of the data storage apparatuses 283 that are registered.

The data storage apparatus 283 includes a determiner 2833. The determiner 2833 determines whether an outside apparatus is authenticated, in response to a communication request received from the outside apparatus. The communication request may be a device authentication request that requests for authentication of the outside apparatus, or a connection authentication request that requests for authentication of connection with the outside apparatus. In this example, it is assumed that a plurality of data storage apparatuses 283A, 283B, and 283C is provided on the network. Alternatively, any desired number of data storage apparatus 283 may be made available on the network.

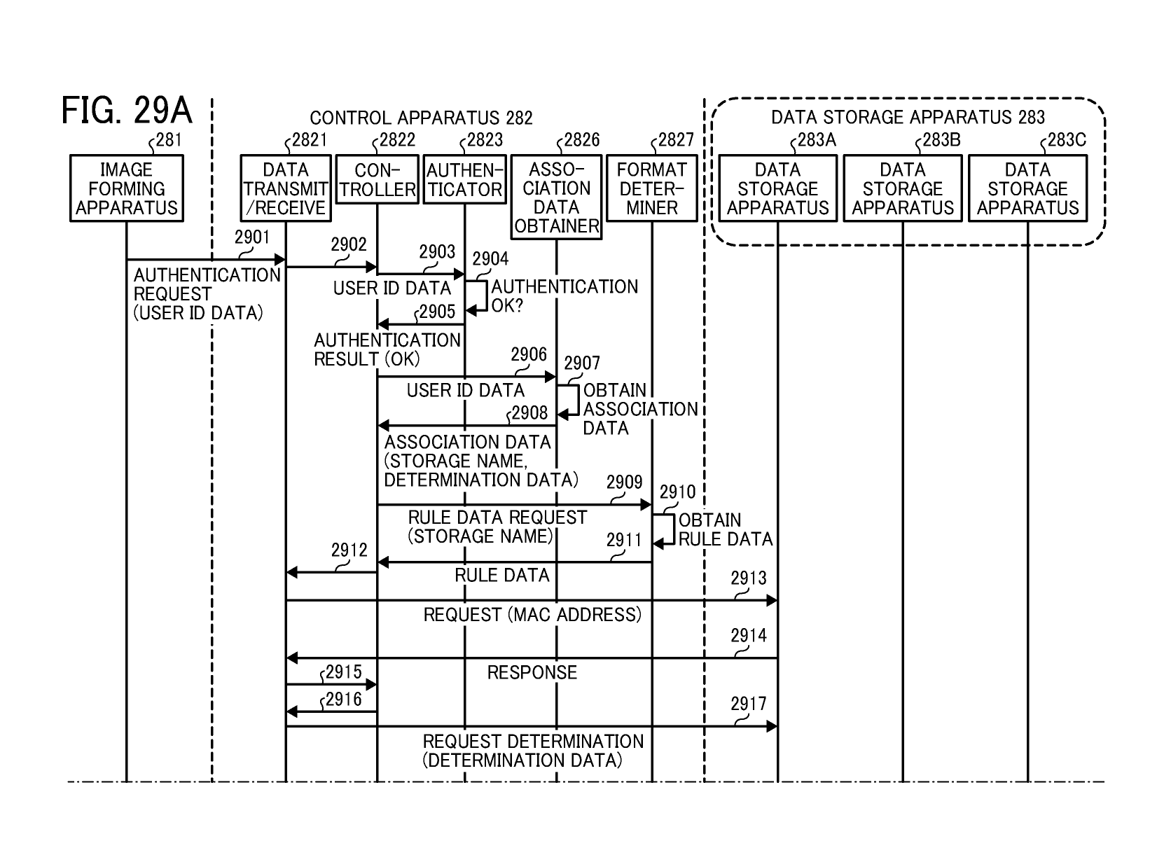

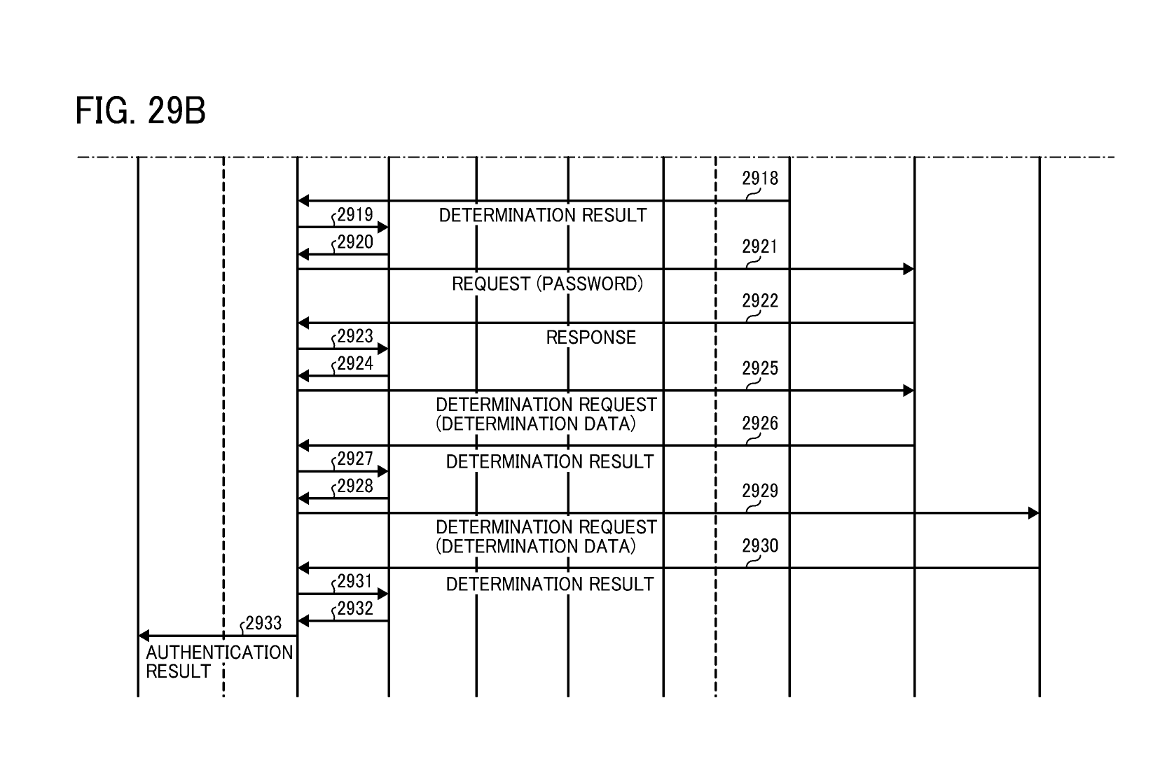

FIGS. 29A and 29B illustrate a data sequence diagram illustrating operation of authenticating a user, performed by the data control system of FIG. 28, according to an example embodiment of the present invention. More specifically, operation of FIG. 29 is performed by one or more processors of the data control system of FIG. 28, such as the CPU 3111 of the image forming apparatus 281, the CPU 204 of the controller apparatus 282, the CPU 204 of the data storage apparatus 283A, the CPU 204 of the data storage apparatus 283B, and the CPU 204 of the data storage apparatus 283C. Further, the CPU 204 of the controller apparatus 102 executes authentication program to function as the authenticator 2823. The CPU 204 of the data storage apparatus 110 executes determination program to function as the determiner 2833.

At S2901, the image forming apparatus 281 transmits an authentication request to the controller apparatus 282, together with user identification information input by the user. At S2902, the data transmit/receive 2821 of the controller apparatus 282 transmits the authentication request, with the user identification information, to the controller 2822. At S2903, the controller 2822 sends the authentication request, with the user identification information, to the authenticator 2823. At S2904, the authenticator 282, which receives the authentication request, authenticates the user using the user identification information. At S2905, the authenticator 2823 sends an authentication result to the controller 2822. In this example, it is assumed that authentication of the user is successful.

At S2906, the controller 2822, which receives the altercation result indicating that authentication is successful, sends the user identification information to the association data obtainer 2826 to request for association data that is associated with the user identification information. At S2907, the association data obtainer 2826 refers to the association data storage 2828 to obtain information that is associated with the received user identification information, such as the data storage name and the determination data. At S2908, the association data obtainer 2826 transmits the obtained association data to the controller 2822. In this example, it is assumed that information that is associated with the authentication user name “USER C” is obtained using the association data having a data structure that is similar to the data structure illustrated in FIG. 7. More specifically, the association data obtainer 2826 obtains the data storage name “A” and determination data for the data storage apparatus 283A, the data storage name “B” and determination data for the data storage apparatus 283B, and the data storage name “C” and determination data for the data storage apparatus 283C.

At S2909, the controller 2822 transmits the data storage name to the rule determiner 2827 to request for obtaining determination rule information for each one of the data storage apparatuses 283. At S2910, the rule determiner 2827 refers to the rule data storage 2829 to obtain determination rule information that is associated with the data storage name received from the controller 2822.

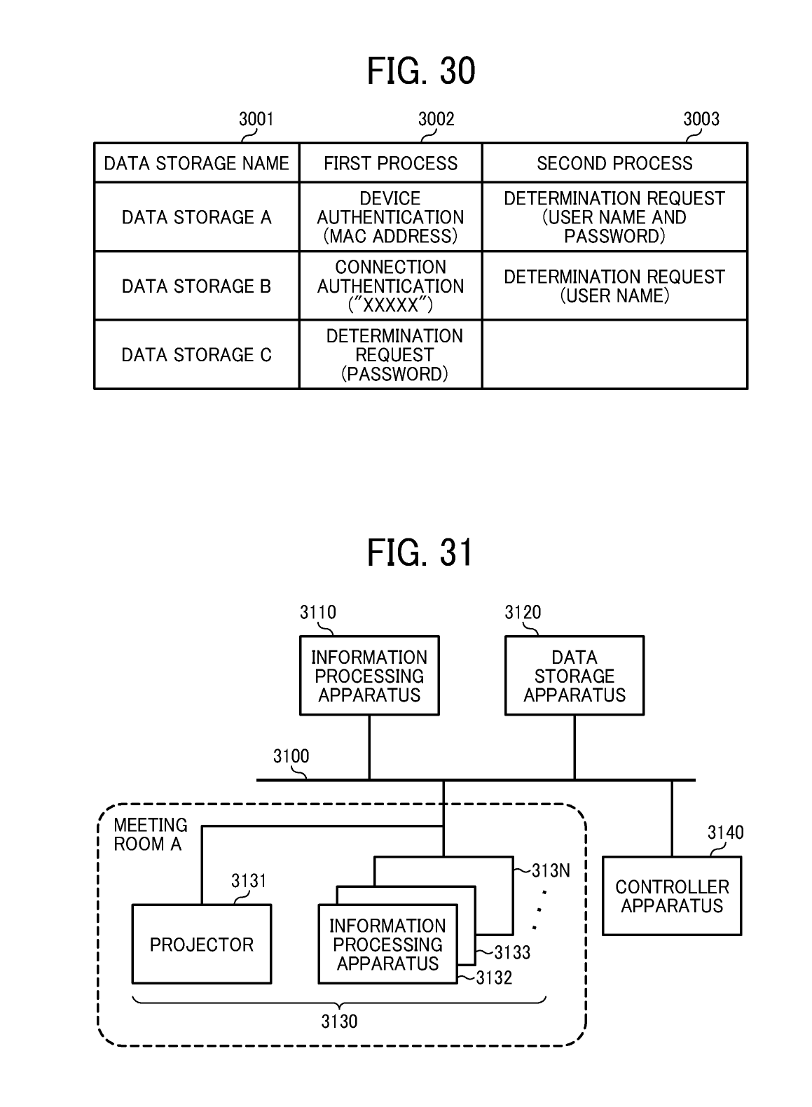

FIG. 30 illustrates an example data structure of determination rule information stored in the determination data storage 2829. The determination rule information of FIG. 30 may be previously set by the user using any desired information processing apparatus, or registered based on information that is obtained by the controller apparatus 282 from the outside apparatus.

The rule information storage 2829 manages various information regarding a specific rule that is required for a specific data storage apparatus to authenticate the outside apparatus, for each one of data storage apparatuses that are registered. The authenticated outside apparatus is allowed for communicating with the data storage apparatus. The rule information storage 2829 further manages various information regarding a specific rule that is required for a specific data storage apparatus to allow the outside apparatus to use a specific function of the data storage apparatus, for each one of data storage apparatuses that are registered. More specifically, the rule information storage 2829 stores, for each one of the data storage names 3001, a first process 3002 and a second process 3003 in association with each other. In addition to the first process and the second process, any desired number of processes may be stored depending on a specific determination rule of the data storage apparatus.

The first process 3002 is stored with information indicating a first authentication process to be performed by the data storage apparatus with respect to the outside apparatus. The second process 3003 is stored with information indicating a second authentication process to be performed by the data storage apparatus with respect to the outside apparatus, when the first process is successfully performed. The determination rule information stored in the rule data storage 2829 indicates the association between a specific data storage apparatus and information indicating one or more specific authentication processes to be performed and an order of performing the authentication processes.

Referring to FIG. 30, in the example case of the data storage “A”, the first process is “device authentication” performed using “MAC address”, and the second process is “determination request” performed using “user name and password”. In the example case of the data storage “B”, the first process is “connection authentication” performed using the password “XXXXX”, and the second process is “determination request” performed using “user name”. In the example case of the data storage “C”, the first process is “determination request” performed using “password”.

Further, in this example, the data or information required for the authentication process may be expressed in various ways, for example, in the form of property information including “MAC address”, “user name”, “user name and password”, etc., or the actual value such as the password “XXXXX”. In alternative to entering data indicating the process such as “device authentication”, “connection authentication”, and “determination request”, only data or information that is required for the authentication process may be entered. The other examples of information that may be used for the device authentication process include, but not limited to, a serial number assigned to the device, an IP address of the device, or any other identification information that uniquely specifies the device. The other examples of information that may be used for the determination data include, but not limited to, a user ID, an organization ID, or a user's email address.

Referring back to FIG. 29, at S2911, the rule determiner 2827 transmits the determination rule information obtained from the determination data storage 2829 to the controller 2822. In this example, since the data storage apparatuses 283A, 283B, and 283C are respectively stored in association with the user C, the rule determiner 2827 transmits the rule determination information for all of the data storage apparatuses 283A, 283B, and 283C to the controller 2822. According to the received determination rule information, the controller 2822 performs specific processing with each one of the data storage apparatuses 283 to establish connection to start communicating with the data storage apparatus 283 or using a specific function of the data storage apparatus 283.

At S2912 and S2913, the controller 2822 transmits the MAC address of the controller apparatus 282 and a communication request (device authentication request) to the data storage apparatus 283A, according to the determination rule of the data storage apparatus 283A, through the data transmit/receive 2821.

The determiner 2833 of the data storage apparatus 283A authenticates the controller apparatus 282 using the received MAC address in any desired authentication method. For example, the data storage apparatus 283A may store a list of device identification information for each one of the authenticated outside apparatuses in a predetermined memory area. When any one of the device identification information matches device identification information that is received, it is determined that the outside apparatus is authenticated to allow communication with the outside apparatus. Alternatively, the data storage apparatus 283A may store a list of device identification information for each one of the unauthenticated outside apparatuses in a predetermined memory area. When any one of the device identification information matches device identification information that is received, it is determined that the outside apparatus is not authenticated, such that communication with the outside apparatus is not allowed.

At S2914, the data storage apparatus 283A transmits a communication response (device authentication result) generated by the authenticator 2833 to the controller apparatus 282 in response to the communication request (device authentication request). In this example, it is assumed that the device authentication request indicating that authentication of the controller apparatus 282 is successful is received.

At S2915, the data transmit/receive 2821 of the controller apparatus 282 transmits the received device authentication result to the controller 2822. At S2916 and S2917, the controller 2822 sends a determination request to the data storage apparatus 283A through the data transmit/receive 2821, together with the determination data (user name and password) according to the determination rule of the data storage apparatus 283A. At S2918, the data storage apparatus 283A sends a determination result, which is generated by the determiner 2833 using the determination data, to the controller apparatus 282. The determination processing using the determination data may be performed in a substantially similar manner as described above referring to S514 to S518 of FIG. 5.

At S2919, the data transmit/receive 2821 of the controller apparatus 282 transmits the determination result to the controller 2822. With this determination result, the controller apparatus 282 is able to know whether use of a specific function of the data storage apparatus 283A is allowed.

At S2920 and S2921, the controller 2822 transmits the password “XXXXX” and a communication request (connection authentication request) to the data storage apparatus 283B, according to the determination rule of the data storage apparatus 283B, through the data transmit/receive 2821.

The determiner 2833 of the data storage apparatus 283B authenticates the controller apparatus 282 using the received password “XXXXX” in any desired authentication method. For example, the determiner 283 determines whether the received password “XXXXX” matches a password that is stored as the authenticated password. At S2922, the data storage apparatus 283B transmits a communication response (connection authentication result) generated by the determiner 2833 to the controller apparatus 282 in response to the communication request (connection authentication request). In this example, it is assumed that the connection authentication request indicating that authentication of the controller apparatus 282 is successful is received.

At S2923, the data transmit/receive 2821 of the controller apparatus 282 transmits the received connection authentication result to the controller 2822. At S2924 and S2925, the controller 2822 sends a determination request to the data storage apparatus 283B through the data transmit/receive 2821, together with the determination data (user name) according to the determination rule of the data storage apparatus 283B. At S2926, the data storage apparatus 283B sends a determination result, which is generated by the determiner 2833 using the determination data, to the controller apparatus 282. The determination processing using the determination data may be performed in a substantially similar manner as described above referring to S514 to S518 of FIG. 5.

At S2927, the data transmit/receive 2821 of the controller apparatus 282 transmits the determination result to the controller 2822. With this determination result, the controller apparatus 282 is able to know whether use of a specific function of the data storage apparatus 283B is allowed.

At S2928 and S2929, the controller 2822 transmits a determination request, with the determination data (password) of the data storage “C”, to the data storage apparatus 283C, according to the determination rule of the data storage apparatus 283C, through the data transmit/receive 2821. At S2930, the data storage apparatus 283C transmits a determination result generated by the determiner 2833, to the controller apparatus 282.

At S2931, the data transmit/receive 2821 of the controller apparatus 282 transmits the determination result to the controller 2822. With this determination result, the controller apparatus 282 is able to know whether use of a specific function of the data storage apparatus 283C is allowed.

At S2932 and S2933, the controller 2822 generates an authentication result based on the determination results obtained from the data storage apparatuses 283, and transmits the authentication result to the image forming apparatus 281 through the data transmit/receive 2821, in response to the authentication request.

The image forming apparatus 281 may cause the display 2811 to display a screen based on the authentication result, and the operation ends. The image forming apparatus 281 may further perform operation of obtaining an electronic data list, or operation of obtaining specific electronic data for further processing.

As described above referring to FIGS. 28 to 30, the user at the image forming apparatus 281 is able to use the electronic data stored in the data storage apparatus 283 to perform processing such as obtaining an electronic data list, obtaining electronic data in a data format compatible with specific application, and printing or deleting the obtained electronic data, etc.

Further, the controller apparatus 282 manages information regarding a specific rule set by each one of the data storage apparatuses 283, and communicates with each one of the data storage apparatuses 283 according to the specific rule. The user, at the image forming apparatus 281, does not have to worry about the differences in rule among the data storage apparatuses 283 to use the electronic data stored in any one of the data storage apparatuses 283.

For the descriptive purposes, in the examples described above referring to FIGS. 1 to 16, 17 to 23, 24 to 27, and 28 to 30, it is assumed that the user sends various requests to the controller apparatus through the image forming apparatus. Alternatively, the user may use any other information processing apparatus to send a request to the controller apparatus. Examples of the information processing apparatus include, but not limited to, a personal computer (PC), portable phone such as smart phone, tablet such as iPad (Registered Trademark), digital camera, any other personal digital assistant (PDA), an image forming apparatus, a client terminal such as a thin client terminal, and any other desired apparatus.

For example, the user may use a tablet, such as iPad (Trademark), to send a request to the controller apparatus such as a request for obtaining electronic data stored in the data storage apparatus. In such case, when a data format of the electronic data stored in the data storage apparatus is “.ppt”, and when the “.ppt” electronic data format cannot be viewed by the tablet, the controller apparatus may convert the electronic data to html-based electronic data such that the tablet is able to display the electronic data using a web browser. For example, the controller apparatus may determine whether the tablet is able to open the .ppt electronic data, based on a list of application programs that are installed onto the tablet. Alternatively, the tablet may send data format specific information indicating a desired data format to the controller apparatus.

Referring now to FIGS. 31 to 40, a data control system is explained according to an example embodiment of the present invention. FIG. 31 illustrates a configuration of a data control system according to an example embodiment of the present invention. The data control system of FIG. 31 includes an information processing apparatus 3110, one or more data storage apparatuses 3120 (“the data storage apparatus 3120), one or more information processing apparatuses 3131, 3132, . . . , 313N (“the information processing apparatus 3130”), and a controller apparatus 3140, which are connection through a network 3100.

Further, in this example, the information processing apparatus 3131 is provided in a meeting room “A”, which functions as a space in the office building that is used for meeting.

The information processing apparatus 3110 sets various settings information regarding use of electronic data that is stored in the data storage apparatus 3120, and sends the settings information to the controller apparatus 3140. Examples of the information processing apparatus 3110 include, but not limited to, a personal computer (PC), a portable phone such as smart phone, tablet such as iPad (Registered Trademark), digital camera, any other personal digital assistant (PDA), and any other desired apparatus. The information processing apparatus 3110 may be implemented by one or more computers each having a hardware structure that is substantially similar to the hardware structure of FIG. 2. In this example, it is assumed that a display such as a LCD and an input device such as a keyboard and a mouse are provided as the user interface.

The information processing apparatus 3130 sends a request for obtaining electronic data stored in the data storage apparatus 3120 to the controller apparatus 3140, and receives the electronic data from the controller apparatus 3140. Examples of the information processing apparatus 3130 include, but not limited to, a personal computer (PC), a portable phone such as smart phone, tablet such as iPad (Registered Trademark), digital camera, any other personal digital assistant (PDA), an image forming apparatus, a projector, and any other desired apparatus. The information processing apparatus 3130 may be implemented by one or more computers each having a hardware structure that is substantially similar to the hardware structure of FIG. 2. In this example, it is assumed that a display such as a LCD and an input device such as a keyboard and a mouse are provided as the user interface. However, a specific hardware structure of the information processing apparatus 3130 differs depending on a device type of the information processing apparatus 3130.

The controller apparatus 3140 obtains electronic data, which is stored in the data storage apparatus 3120 according to a request received from the information processing apparatus 3130, converts a data format of the electronic data to a data format applicable to the information processing apparatus 3130, and sends the converted electronic data to the information processing apparatus 3130. The controller apparatus 3140 may be implemented by one or more computers each having a hardware structure that is substantially similar to the hardware structure of FIG. 2.

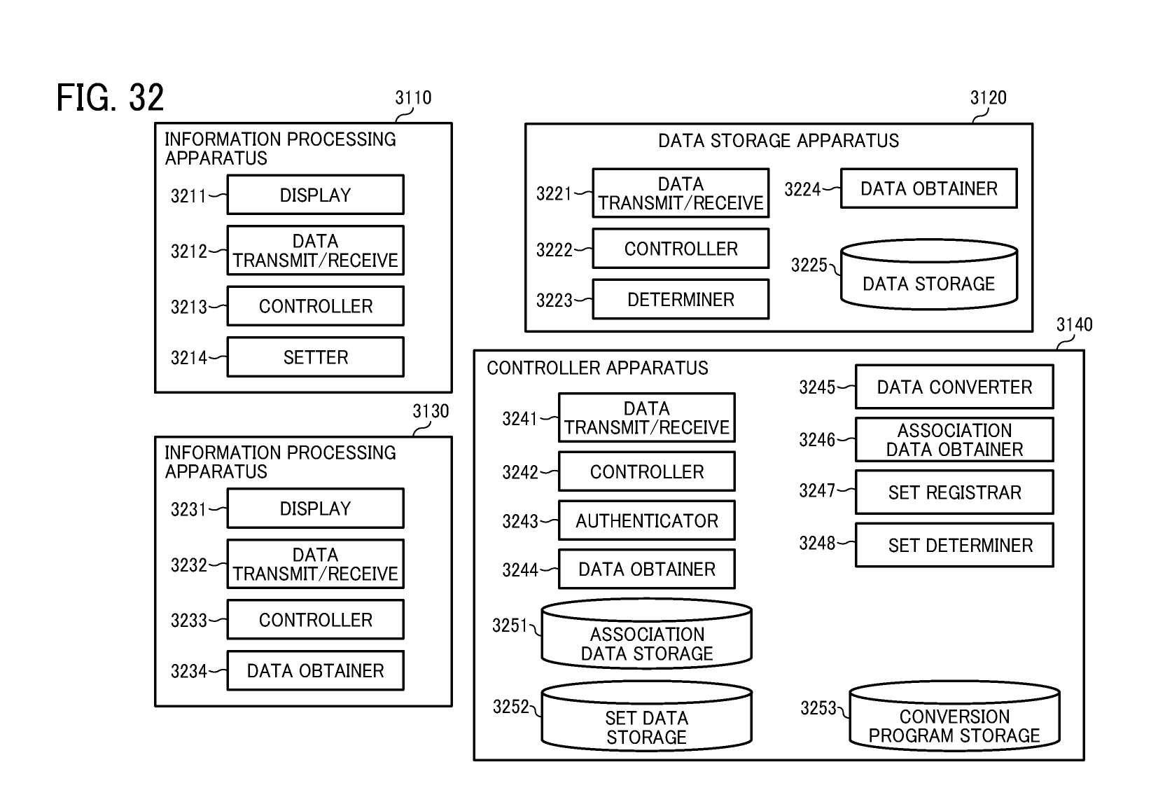

FIG. 32 illustrates a functional structure of the information processing apparatus 3110, the data storage apparatus 3120, the information processing apparatus 3130, and the controller apparatus 3140 of the data control system of FIG. 31, according to an example embodiment of the present invention.

The information processing apparatus 3110 includes a display 3211, a data transmit/receive 3212, a controller 3213, and a setter 3214. These units or devices that are shown in FIG. 32 correspond to a plurality of modules, which are executed according to an instruction of the CPU 204 (FIG. 2) that is generated according to the control program being loaded from the supplementary memory 202 onto the memory 203, in cooperation with one or more hardware circuits or devices of the information processing apparatus 3110.

The display 3211, which may be implemented by an LCD, displays various information to the user, such as a screen that allows the user to input settings information. The data transmit/receive 3212 may be implemented by the network interface 316. The data transmit/receive 3212 transmits or receives various data or information to or from the other device or apparatus through the network.

The controller 3213, which corresponds to the controller 311 (FIG. 3), controls processing performed by various devices in the information forming apparatus 3110. For example, the controller 3213 sends a processing request to a specific device, or controls processing in response to a response received from the specific device.

The setter 314 of the information processing apparatus 3110 obtains, from the controller apparatus 3140, setting items information, which specifies a plurality of items of settings information that the information processing apparatus 3130 can set with respect to electronic data that may be used at the information processing apparatus 3130. Using the obtained setting items information, the setter 314 sets various settings information regarding the electronic data that may be used at the information processing apparatus 3130.

The information processing apparatus 3130 includes a display 3231, a data transmit/receive 3232, a controller 3233, and an electronic data obtainer 3234. These units or devices that are shown in FIG. 32 correspond to a plurality of modules, which are executed according to an instruction of the CPU 204 (FIG. 2) that is generated according to the control program being loaded from the supplementary memory 202 onto the memory 203, in cooperation with one or more hardware circuits or devices of the information processing apparatus 3130.

The display 3231 of the information processing apparatus 3130 may display an image of electronic data, using a display device of the information processing apparatus 3130 such as a liquid crystal display (LCD) or a projector. The electronic data obtainer 3234 requests the controller apparatus 3140 to obtain electronic data.

The controller 3233, which corresponds to the controller 311 (FIG. 3), controls processing performed by various devices in the information forming apparatus 3130. For example, the controller 3233 sends a processing request to a specific device, or controls processing in response to a response received from the specific device. The data transmit/receive 3232 may be implemented by the network interface 316. The data transmit/receive 3232 transmits or receives various data or information to or from the other device or apparatus through the network.

The controller apparatus 3140 includes a data transmit/receive 3241, a controller 3242, an authenticator 3243, an electronic data obtainer 3244, a data converter 3245, an association data obtainer 3246, a set registrar 3247, a set determiner 3248, an association data storage 3251, a set data storage 3252, and a conversion program storage 3253. These units or devices that are shown in FIG. 32 correspond to a plurality of modules, which are executed according to an instruction of the CPU 204 (FIG. 2) that is generated according to the control program being loaded from the supplementary memory 202 onto the memory 203, in cooperation with one or more hardware circuits or devices of the controller apparatus 3140.

The data transmit/receive 3241, controller 3242, authenticator 3243, electronic data obtainer 3244, data converter 3245, association data obtainer 3246, association data storage 3251, and conversion program storage 3253 are substantially similar to the data transmit/receive 421, controller 422, authenticator 423, electronic data obtainer 424, data converter 425, association data obtainer 426, association data storage 427, and conversion program storage 428 of FIG. 1.

The set registrar 3247 of the controller apparatus 3140 transmits various information that may be needed for setting (“setting items information”) that is obtained from the set data storage 3252, in response to a request for obtaining setting items information that is received from the information processing apparatus 3110. The set registrar 3247 registers settings information, which is received from the information processing apparatus 3110, in the set data storage 3252.

The set determiner 3248 of the controller apparatus 3140 reads out settings information from the set data storage 3252, in response to a request for obtaining electronic data that is received from the information processing apparatus 3130, and determines electronic data to be obtained from the data storage apparatus 3120.

The set data storage 3252 stores a part or all of the setting items information and settings information.

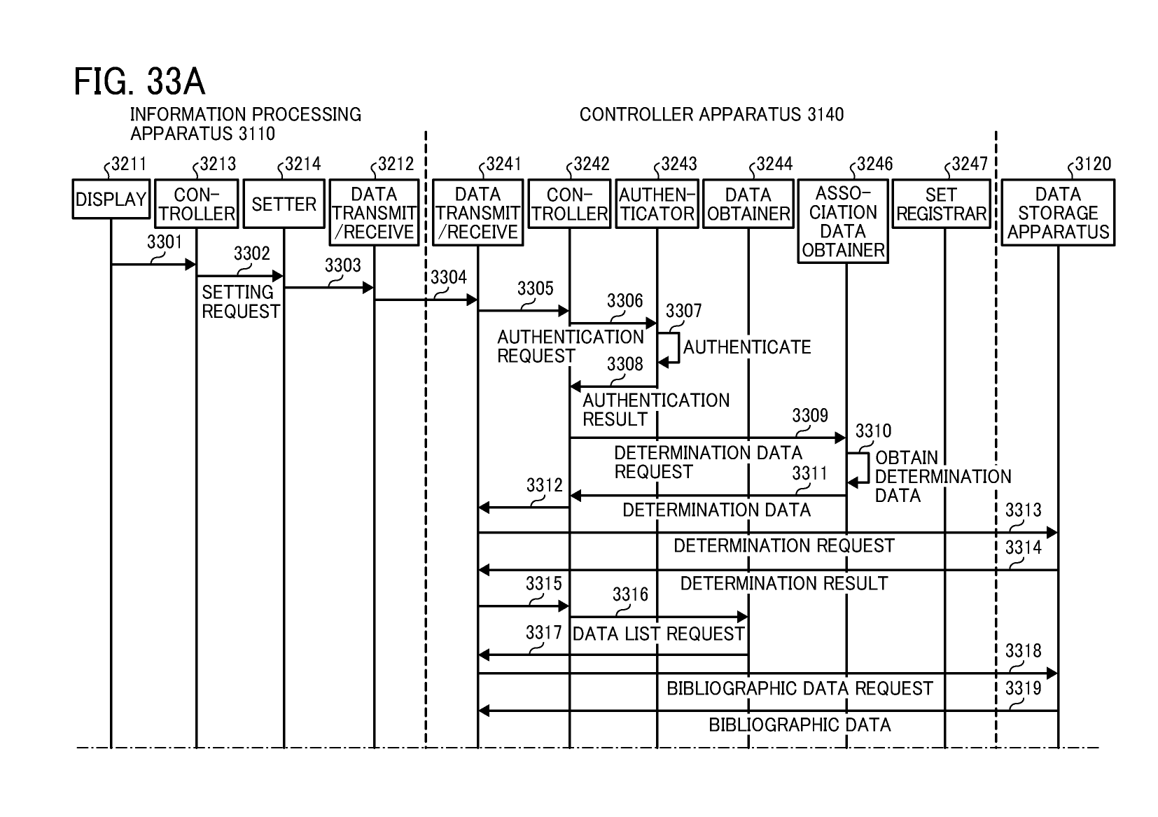

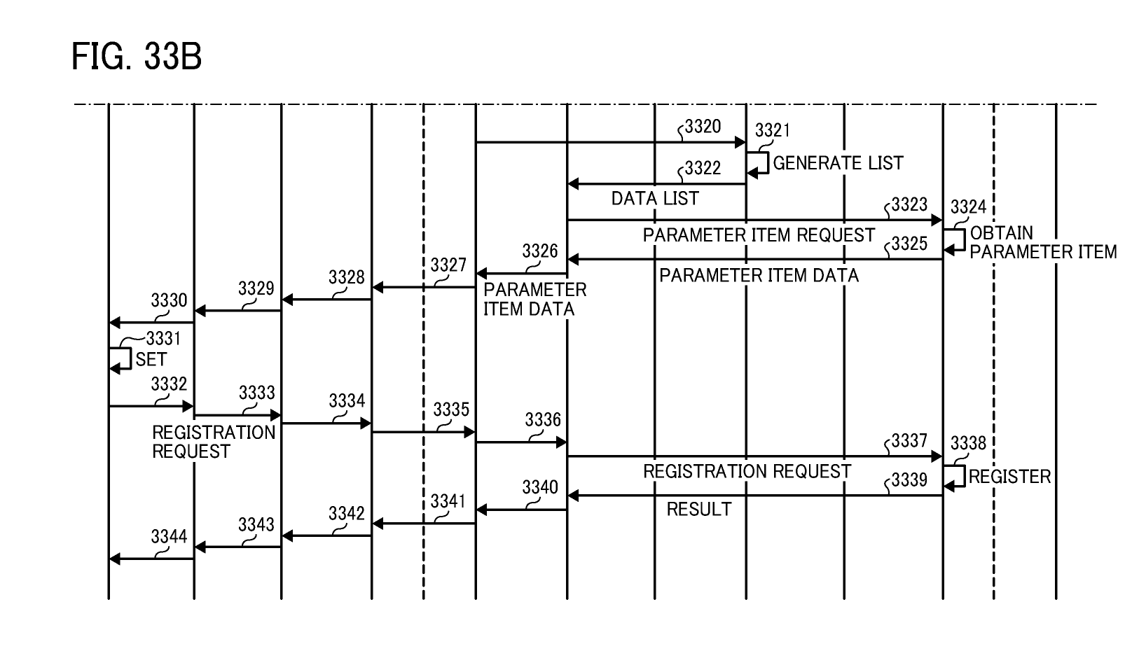

Referring now to FIGS. 33A and 33B (FIG. 33), operation of registering settings information, performed by the data control system of FIG. 31, is explained according to an example embodiment of the present invention. More specifically, operation of FIG. 33 is performed by one or more processors of the data control system of FIG. 31, such as the CPU 204 of the information processing apparatus 3110, the CPU 204 of the controller apparatus 3140, and the CPU 204 of the data storage apparatus 3120.

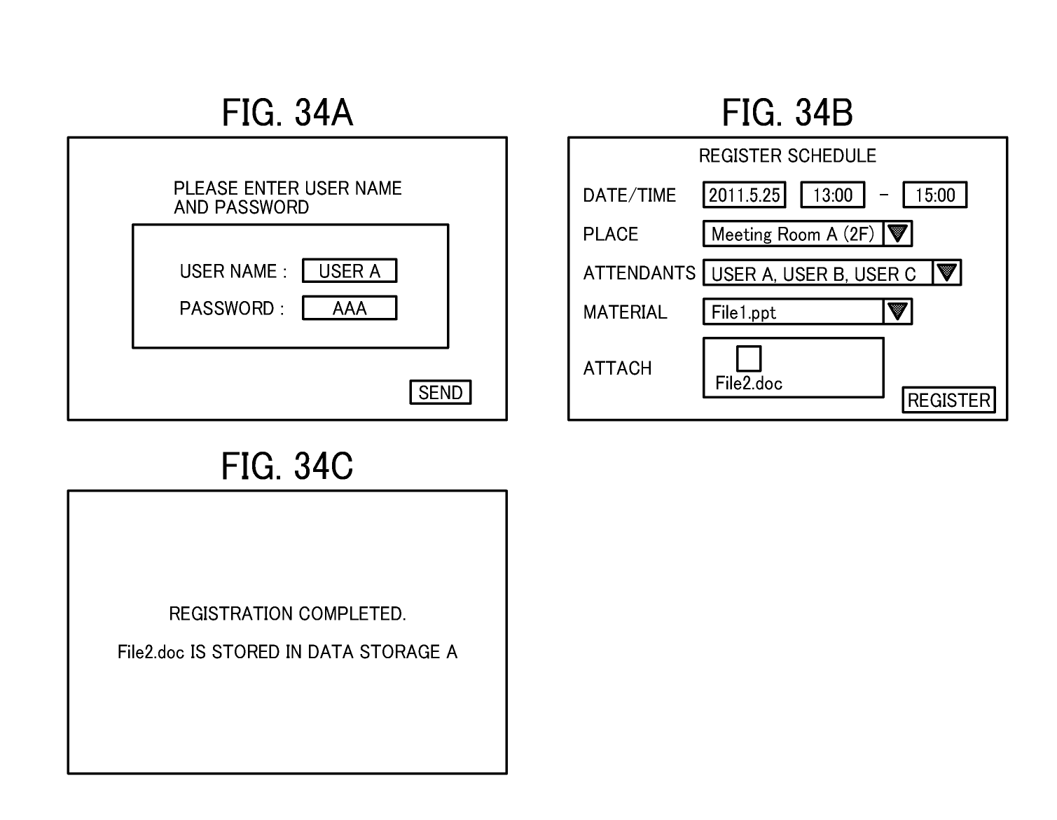

At S3301, the information processing apparatus 3110 causes the display 3211 to display a login screen, which allows the user to input authentication information such as user identification information. FIG. 34A illustrates an example login screen displayed to the user.

At S3301, the display 3211 sends the user identification information, which is input by the user, to the controller 3213. At S3302, the controller 3213, which receives the user identification information, sends the user identification information to the setter 3214 to request for obtaining setting items information (“setting request”).

At S3303, the setter 3214 sends a request for obtaining the setting items information, together with the user identification information, to the controller apparatus 3140 through the data transmit/receive 3241.

At S3305 and S3306, the controller 3242 receives the request for setting items information from the data transmit/receive 3214 of the controller apparatus 3140, and sends an authentication request to the authenticator 3243 with the user identification information received from the information processing apparatus 3110.

At S3307, the authenticator 3243 authenticates the user using the user identification information and association data stored in the association data storage 3251 to generate an authentication result. More specifically, the authenticator 3243 determines whether any authentication information stored in the association data matches the received user identification information. When there is authentication information that matches the user identification information, it is determined that authentication is successful. At S3308, the authenticator 3243 transmits the authentication result to the controller 3243.

When the authentication result indicates that authentication fails, the controller 3242 transmits the authentication result indicating that authentication fails to the information processing apparatus 3110 through the data transmit/receive 3241. When the authentication result indicates that authentication is successful, the operation proceeds to S3309 to S3322. S3309 to S3314 of obtaining a determination result is performed in a substantially similar manner as described above referring to S510 to S520 of FIG. 5. S3315 to S3322 of obtaining an electronic data list is performed in a substantially similar manner as described above referring to S1005 to S1016 of FIG. 10.

At S3323, the controller 3242 sends a request for obtaining setting items information (“parameter item request”) to the set registrar 3247. At S3324, the set registrar 3247 obtains the setting items information (“parameter item data”) from the set data storage 3252. At S3325, the set registrar 3247 transmits the set items information to the controller 3242.

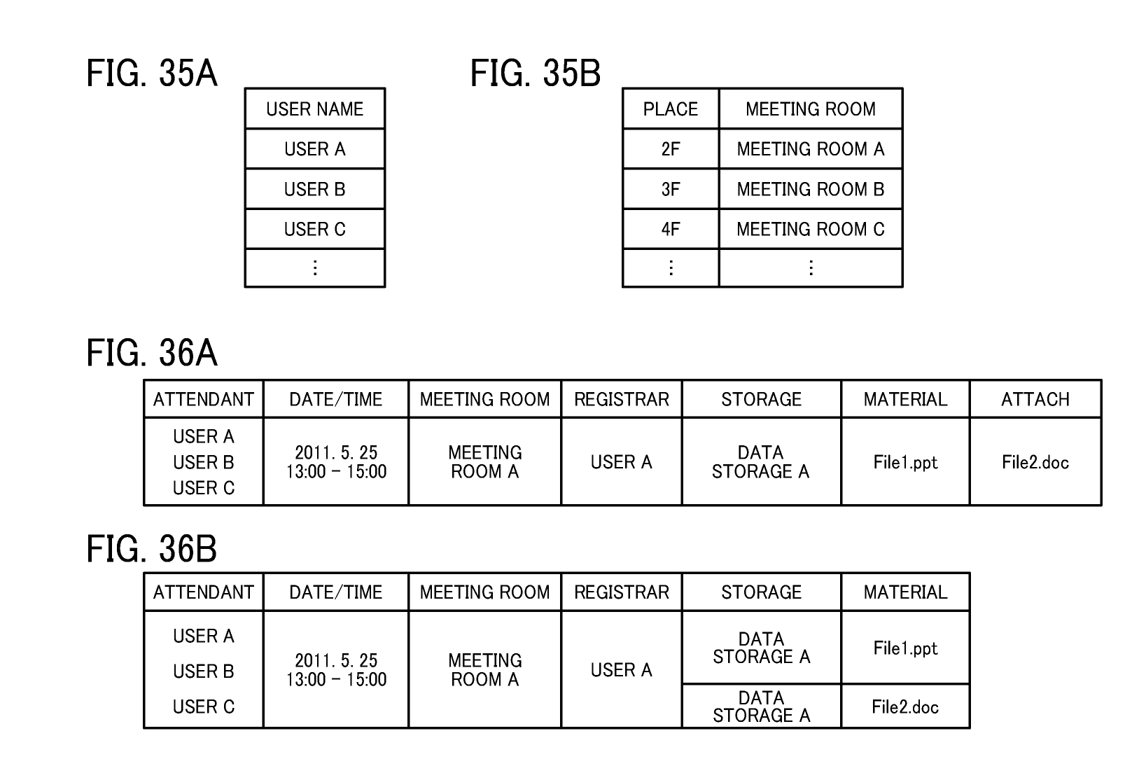

FIGS. 35A and 35B illustrate an example data structure of the setting items information, which is stored in the set data storage 3252. The user list of FIG. 35A registers therein a user name, as one example of user identification information that is used to identify a user, for each of the users who are registered in the data control system of FIG. 31. The meeting room list of FIG. 35B registers information regarding a meeting room, such as a name of the meeting room and a place of the meeting room, in association with each other, for each of the meeting rooms that are available for use and registered in the data control system of FIG. 31. The setting items information may be previously stored in the set data storage 3252 by the user, such as an administrator, using an information processing apparatus.

Referring back to FIG. 33B, at S3326 and S3327, the controller 3242 sends the setting items information including the electronic data list that is obtained at S3322, to the information processing apparatus 3110 through the data transmit/receive 3241.

At S3328, the data transmit/receive 3212 of the information processing apparatus 3110 sends the received setting items information to the setter 3214. At S3329, the setter 3214 sends the received setting items information and screen data that is used to generate a setting screen, to the controller 3213.

At S3330, the controller 3213 causes the display 3211 to display a setting screen based on the received setting items information and the screen data. At S3331, the display 3211 allows the user to enter various settings information that may be related to at least one specific electronic data file selected from the electronic data list.

FIG. 34B illustrates an example setting screen, which may be displayed to the user through the display 3211. The setting screen of FIG. 34B includes various setting items including the “date/time” item, the “place” item, the “attendant” item, the “material” item, and the “attach” item.

The date/time item allows the user to select specific date and time at which specific electronic data is used. In this example, the date/time of a meeting at which specific electronic data is used is registered. The place item allows the user to select a specific place, i.e., the meeting room, at which the specific electronic data is used. The user may select one of the meeting rooms from a list of meeting rooms that are displayed based on the meeting room list of FIG. 35B. The attendant item allows the user to select one or more users, who may use the specific electronic data. The user may select one or more users from a list of users that are displayed based on the user list of FIG. 35A. In this example, meeting attendants are selected by the user. Further, in this example, the attendant item may be caused to automatically include the login user by default.

The material item allows the user to select one or more electronic data files to be used, which may be selected from the electronic data list, as the specific electronic data file. In this example, a file name of each one of the electronic data files that are listed in the electronic data list is displayed, based on the electronic data list. The attach item allows the user to attach one or more electronic data files to be used, which may be stored in the information processing apparatus 3110.

In this example illustrated in FIG. 34B, the user enters that electronic data “file1.ppt” and electronic data “file2.doc” are used by the users A, B, and C, at the meeting room A of the second floor, for the time 13:00 to 15:00 on May 25, 2011.

In this example, it is assumed that the information processing apparatus 3110 obtains the setting items information including the meeting room list of FIG. 35B and the user list of FIG. 35A from the controller apparatus 3140 when generating a setting screen. Alternatively, the information processing apparatus 3110 may previously store the setting items information including the meeting room list of FIG. 35B and the user list of FIG. 35A in a memory. In such case, at 3327, the controller apparatus 3140 transmits the electronic data list to the information processing apparatus 3110, as the setting items information.

Referring back to FIG. 33B, when the “Register” key of the setting screen of FIG. 34B is selected, at S3332, the display 3211 sends a registration request based on the selected “Register” key to the controller 3213. At S3333, the controller 3213 sends a registration request for registering the entered values of setting items, i.e., settings information, to the setter 3214.

At S3334 and S3335, the setter 3214, which receives the registration request, sends the settings information and a registration request to the controller apparatus 3140 through the data transmit/receive 3212. At S3336, the data transmit/receive 3241 of the controller apparatus 3140 sends the registration request to the controller 3242. At S3337, the controller 3242 sends the registration request for registering the settings information, to the set registrar 3247.

At S3338, the set registrar 2347, which receives the registration request, registers the settings information in the setting data storage 3252. For the attached electronic data as specified by the attach item, the set registrar 2347 may store the attached electronic data in a memory area, such as a HDD of the controller apparatus 3140, in association with the user identification information used for the login process. Alternatively, the attached electronic data may be stored in the data storage apparatus 3120, using the user identification information used for the login process.

When the attached electronic data is to be stored in the data storage apparatus 3120, the controller apparatus 3140 may be provided with an electronic data registrar, which sends the attached electronic data to the data storage apparatus 3120 through the data transmit/receive 3241 to request for storing the attachment electronic data. The data storage apparatus 3120 stores the attached electronic data, for example, in association with the determination data of the login user, and sends a message indicating that storing of the attached electronic data is completed to the controller apparatus 3140. Based on this message, the electronic data registrar of the controller apparatus 3140 is able to know that storing of the attached electronic data is completed.

FIGS. 36A and 36B each illustrate an example structure of settings information registered in the setting data storage 3252 by the set registrar 3247. FIG. 36A corresponds to the example case where the attached electronic data is stored in a memory area of the controller apparatus 3140. FIG. 36B corresponds to the example case where the attached electronic data is stored in the data storage apparatus 3120.

As illustrated in FIGS. 36A and 36B, in addition to the settings information of the setting items that are set at the information processing apparatus 3110, the set registrar 3247 registers the “registrar” item and/or the “storage” item. The registrar item indicates a user who registers settings information, such as a user name of the login user. The storage item indicates the data storage apparatus 3120 storing the electronic data specified by the material item, such as identification information (storage name) of the data storage apparatus 3120 storing the electronic data having a file name registered in the material item.

Referring back to FIG. 33B, when the setting information is registered, at S3339, the set registrar 3247 sends a registration result indicating that registration is completed to the controller 3242. When the attached electronic data is stored in the data storage apparatus 3120, the set registrar 3247 sends information indicating the data storage apparatus 3120 storing the attached electronic data, as the registration result.

At S3340 and S3341, the controller 3242 sends the registration result to the information processing apparatus 3110 through the data transmit/receive 3241.

At S3342, the data transmit/receive 3212 of the information processing apparatus 3110 transmits the registration result to the setter 3214. At S3343, the setter 3214 sends the registration result to the controller 3213. At S3344, the controller 3213 causes the display 3211 to display a screen based on the registration result, and the operation ends.

FIG. 34C illustrates an example screen, which may be displayed to the user through the display 3211, based on the registration result. In this example, the attached electronic data is stored in the data storage apparatus with the name “A”.

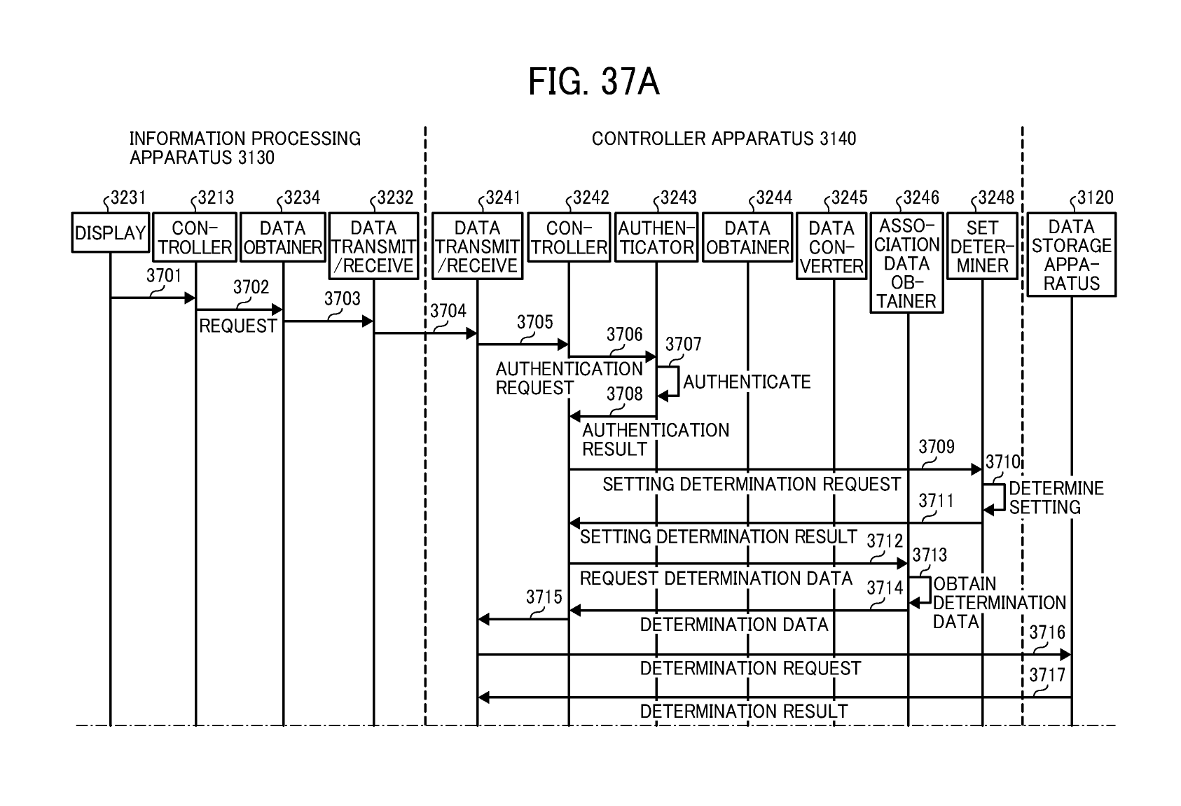

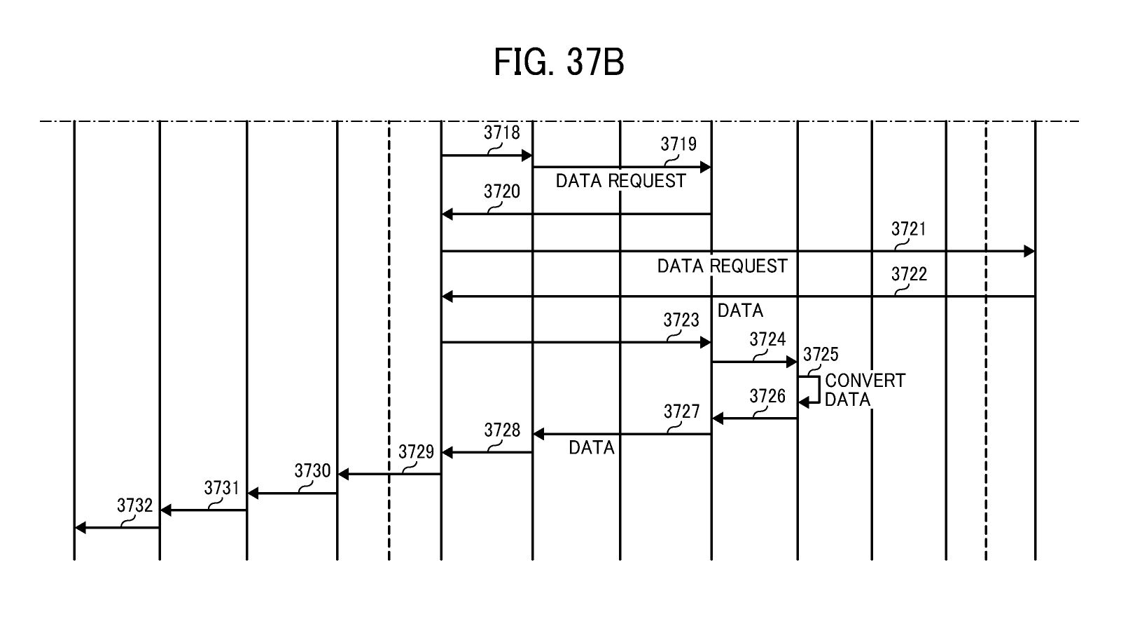

Referring now to FIGS. 37A and 37B (FIG. 37), operation of obtaining electronic data based on the settings information, performed by the data control system of FIG. 31, is explained according to an example embodiment of the present invention. More specifically, operation of FIG. 37 is performed by one or more processors of the data control system of FIG. 31, such as the CPU 204 of the information processing apparatus 3130, the CPU 204 of the controller apparatus 3140, and the CPU 204 of the data storage apparatus 3120.

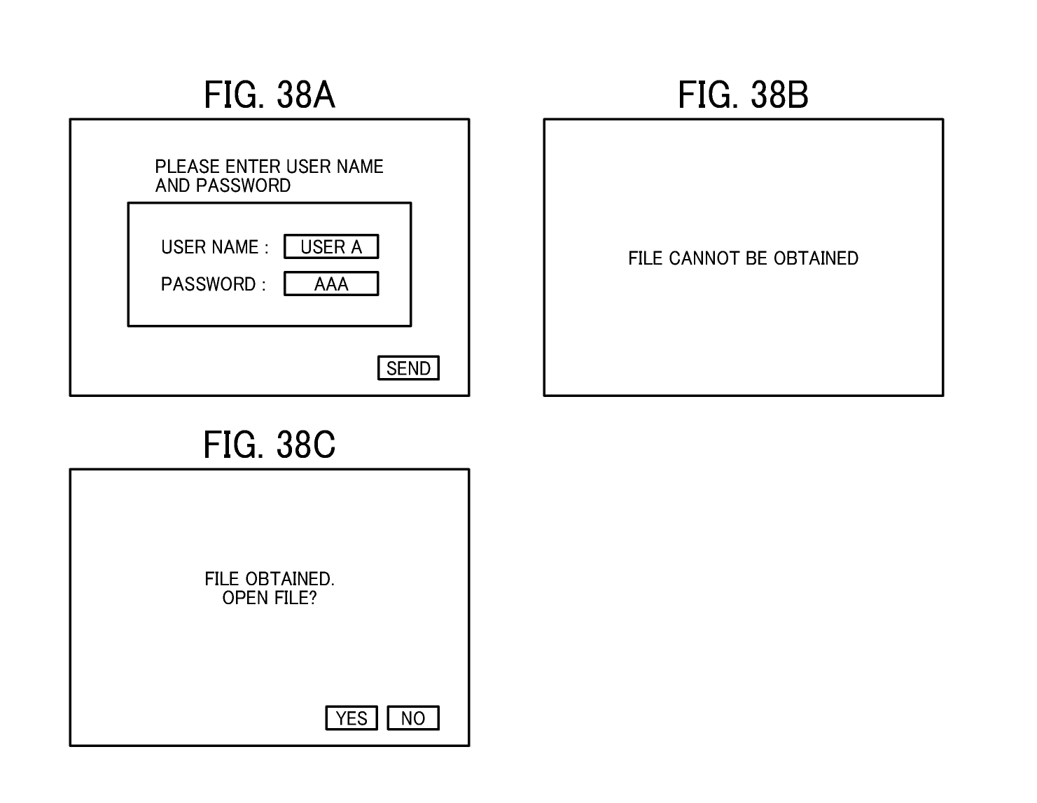

In this example, it is assumed that the information processing apparatus 3130 displays a login screen, which allows the user to input authentication information, through the display 3231. For example, the display 3231 may display a login screen of FIG. 38A to allow the user to input user identification information such as a user name and a password.

At S3701, the display 3211 transmits the user identification information input by the user to the controller 3213. At S3702, the controller 3213, which receives the user identification information, transmits the user identification information to the electronic data obtainer 3234 to request for obtaining electronic data.

At S3703 and S3704, the electronic data obtainer 3234 sends the user identification information and the data request for obtaining electronic data, to the controller apparatus 3140 through the data transmit/receive 3232.

At S3705 and S3706, the controller 3242 of the controller apparatus 3140, which receives the data request, sends an authentication request with the user identification information to the authenticator 3243. At S3707, the authenticator 3243 authenticates the user using the user identification information and association data stored in the association data storage 3251 to generate a determination result. At S3708, the authenticator 3243 sends the authentication result to the controller 3242.

When the authentication result indicates that authentication fails, the controller 3242 sends the authentication result indicating that authentication fails to the information processing apparatus 3130 through the data transmit/receive 3241. FIG. 38B illustrates an example screen, which may be displayed to the user through the display 3231 when the authentication result indicating that authentication fails is received.

When the authentication result indicates that authentication is successful, at S3709, the controller 3242 sends a setting determination request to the set determiner 3248, which requests the set determiner 3248 to determine whether there is any electronic data to be processed based on the settings information stored in the setting data storage 3252.

At S3710, the set determiner 3248 determines whether there is any electronic data to be processed, based on the settings information stored in the setting data storage 3252.

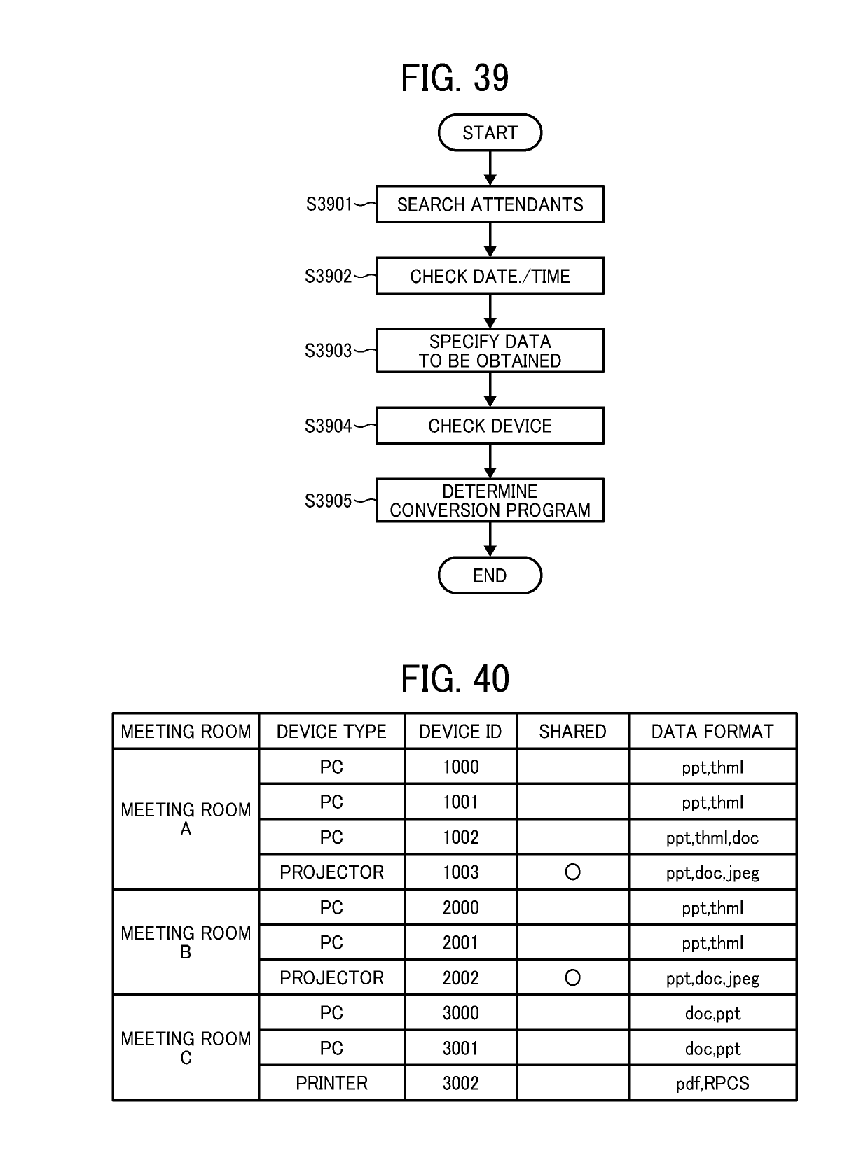

FIG. 39 is a flowchart illustrating operation of determining whether there is any electronic data to be processed, based on the settings information stored in the setting data storage 3252, performed by the set determiner 3248 at S3710, according to an example embodiment of the present invention.

At S3901, the set determiner 3248 refers to the attendant item of the settings information, which is stored in the setting data storage 3252, to determine whether there is any user name in the attendant item that matches the user name of the user identification information received from the information processing apparatus 3130. When there is no user name that matches the user name of the user identification information, it is determined that there is no electronic data to be processed, and the operation ends.

When there is at least one user name that matches the user name of the user identification information, at S3902, the set determiner 3248 refers to the date/time item of the settings information having the matched user name, and determines whether a data/time value of the date/time item is within a range specified by the current date/time. The value of date/time item is checked for each of the settings information having the matched user name. When there is no setting information having the date/time item value that is within the determined range, it is determined that there is no electronic data to be processed.

In this example, the range determined by the current date/time may be previously set. In one example, the set determiner 3248 may determine whether the current date/time falls within a range determined by a time period of the date/time specified by the settings information. In another example, the set determiner 3248 may determine whether the current date/time falls within a range that is slightly longer than a time period of the date/time specified by the settings information.

For example, even when the meeting time is scheduled to start at 13:00, the user may want to use the electronic data, i.e., the material, before the meeting starts to prepare for the meeting. In view of this, when the current date/time is 5 minutes before the meeting starts, the electronic data is determined to be processed.

Assuming that there is at least one set of settings information that includes the date/time item having the date/time in which the current date/time falls, the operation proceeds to S3903. At S3903, the set determiner 3248 obtains the electronic data to be processed, using the specified settings information. More specifically, referring to FIG. 36A or 36B, the set determiner 3248 obtains a file name of the electronic data stored in the material item or the attach item, a storage name that is stored in the storage item, and/or a user name stored in the registrar item. Using the extracted data of the settings information, the set determiner 3248 obtains a file of electronic data to be processed, for each one of the electronic data files that are specified.

At S3904, the set determiner 3248 specifies one or more devices that correspond to the meeting room name of the specified settings information, based on associated device information indicating the association between a meeting room name and a device that is placed in the meeting room. The set determiner 3248 further determines whether the information processing apparatus 3130, which sends a request, is included in the specified device.

FIG. 40 illustrates an example data structure of the associated device information, which is stored in the association data storage 3252. In this example, it is assumed that the associated device information is previously stored in the association data storage 3252, for example, using an information processing apparatus.

The associated device information of FIG. 40 includes a meeting room name, a device type, a device ID, a shared use (“SHARED”), and a data format, which are stored in association with one another for each of the meeting rooms that are registered.

The meeting room name of FIG. 40 corresponds to the meeting room name, which may be stored as the settings information or setting items information. The device type indicates a type of each device, such as a PC, projector, MFP, etc., which is provided in the meeting room. The device ID is device identification information that is assigned to each of the devices, such as identification information that identifies an information processing apparatus that sends a request for obtaining electronic data. Examples of the device identification information include, but not limited to, a manufacturing number, an IP address, a MAC address, and an application ID of an application that is installed on the device to request for electronic data.

The shared use indicates whether sharing of the electronic data is allowed or expected. In the example case illustrated in FIG. 40, electronic data that is displayed by a device having the device type of projector is allowed or expected to be shared by a plurality of devices.

The data format indicates a data format of electronic data that may be applicable to the device or desirable to the device. The controller apparatus 3140 transmits electronic data to be processed after converting the electronic data to have a data format compatible with the data format specified by the associated device information of FIG. 40.

The associated device information may be previously registered by a user, such as by an administrator of the data control system of FIG. 31. Alternatively, any part of the associated device information may be obtained from the outside apparatus. For example, when electronic data obtaining application is installed onto the information processing apparatus 3130 to cause the information processing apparatus 3130 to have the electronic data obtainer 3234, the information processing apparatus 3130 may send information to the controller apparatus 3140. For example, the device type, device ID, and data format may be automatically obtained by the information processing apparatus 3130, and transmitted to the controller apparatus 3140. The data format may be automatically obtained, based on one or more application programs that are installed onto the information processing apparatus 3130, for example, by specifying an extension code of a file that can be deployed at the information processing apparatus 3130.

Referring back to FIG. 39, at S3904, the set determiner 3248 refers to the associated device information of FIG. 40 to specify a device ID of each one of the devices, which are stored in association with the meeting room name that matches the meeting room name of the specified settings information. The set determiner 3248 further determines whether the specified device ID matches a device ID that is sent from the information processing apparatus 3130. The device ID of the information processing apparatus 3130 may be obtained at S3704 of FIG. 37A, that is, when the information processing apparatus 3130 sends the user identification information. Alternatively, the device ID of the information processing apparatus 3130 may be obtained at any desired time.

When there is no device ID that matches the received device ID, the set determiner 3248 determines that there is no electronic data to be processed. When there is a device ID that matches the received device ID, at S3905, the set determiner 3248 obtains information indicating a data format that is associated with the device ID, and determines a data format of the electronic data to be transmitted to the information processing apparatus 3130 and a conversion program that converts the electronic data, and the operation ends.

When there is no conversion program that is capable of converting the electronic data to have the data format that is registered for the specific device, it is determined that there is no electronic data to be processed. When there is at least one conversion program that is capable of converting the electronic data to have the data format that is registered for the specific device, it is determined that there is electronic data to be processed.

In the above-described example, when the data format that is registered for a specific device is only one, the set determiner 3248 selects the registered data format as a data format of the electronic data to be transmitted to the specific device. When there is a plurality of data formats that are registered for a specific device, the set determiner 3248 selects one data format in various ways. For example, the data format may be assigned with priority information indicating a priority level. The data format to be used may be determined in the order having a highest priority level.

In another example, when the electronic data is to be shared among a plurality of devices in the meeting room, the set determiner 2348 may determine whether there is any conversion program capable of converting the electronic data having a data format that is applicable to all of the devices that may share the electronic data. When there is any conversion program capable of converting the electronic data to have a data format that is common to data formats of the devices, the set determiner 2348 may select such conversion program to convert the electronic data. For example, when an image of the electronic data is to be projected by the projector that is connected to the PC, the electronic data may be converted to have a data format applicable to the projector and the PC.

In another example, the set determiner 2348 may select any data format, for example, according to the user preference. In such case, the information processing apparatus 3130 may display a list of data formats that are available for selection by the user.

Referring back to FIG. 37A, at S3711, the set determiner 3248 sends the setting determination result, which is generated at S3710, to the controller 3242. When the setting determination result indicates that there is not electronic data to be processed, the controller 3242 sends an error message to the information processing apparatus 3130 through the data transmit/receive 3241. Based on the received message, the information processing apparatus 3130 may display a screen of FIG. 38B. When the set determiner 3248 determines that there is at least one electronic data file to be processed, the set determiner 3248 sends the setting determination result including, for example, information indicating a file name of the electronic data, the storage name of the data storage apparatus 3120 storing the electronic data, the registrar, and the conversion program, etc.

At S3712, the controller 3242 sends information regarding the registrar, which is obtained as the setting determination result, to the association data obtainer 3246 to request for association data that is associated with the user identification information of the registrar. At S3713, the association data obtainer 3246 refers to the association data stored in the association data storage 3251 to obtain determination data that is associated with the authentication user name, which matches the registrar name. At S3714, the association data obtainer 3246 sends the determination data to the controller 3242.

At S3715 to S3727, the controller apparatus 3140 obtains the electronic data to be processed from the data storage apparatus 3120 using the determination data, and converts the electronic data to have a data format compatible with the information processing apparatus 3130 using the conversion program. The conversion program may be determined based on the data format, which is determined using the associated device information.

When the electronic data to be processed is stored in a memory of the controller apparatus 3140, the controller apparatus 3140 may obtain electronic data having a file name and a user name, which respectively match the file name and the registrar name of the settings information.

At S3728 and S3729, the controller 3242 transmits the converted electronic data to the information processing apparatus 3130 through the data transmit/receive 3241. At S3730, the data transmit/receive 3232 of the information processing apparatus 3130 sends the electronic data to the electronic data obtainer 3234. At S3731, the electronic data obtainer 3234 sends the electronic data to the controller 3233.

At S3732, the controller 3233 stores the electronic data in a predetermined memory area, such as the HDD, and causes the display 3231 to display a screen indicating that obtaining of the electronic data is completed.

FIG. 38C illustrates an example screen, which may be displayed through the display 3231 when the electronic data is obtained. In case there is more than one electronic data that is obtained, the screen may list a plurality of electronic data files, while allowing the user to select which one of the electronic data files is to be opened.

In the above-described example, it is assumed that the information processing apparatus 3130 is a device that is not shared by a plurality of devices. Now, operation of obtaining electronic data, using the information processing apparatus 3130 that can be shared, such as the projector 3131, is explained according to an example embodiment of the present invention.

The projector 3131 does not necessarily require the user to input user identification information. Further, the projector 3131 may not be provided with an operation device that allows the user to input user identification information. In such case, when the projector 3131 is turned on, or when a predetermined time elapses after the projector 3131 is turned on, the projector 3131 transmits a request for obtaining electronic data to the controller apparatus 3140. Alternatively, when the projector 3131 can be remotely controlled using a remote controller, the projector 3131 may transmit a data request when an instruction is received from the remote controller.

The controller apparatus 3140, which receives the data request, causes the set determiner 3248 to determine whether the associated device information that matches the device ID received from the projector 3131 indicates whether the electronic data can be shared. When the electronic data can be shared, S3706 to S3708 of authenticating the user is not performed. The set determiner 3248 specifies the settings information using the meeting room name that is specified by the device ID and the current date/time, to obtain various information such as the file name of electronic data to be processed, the registrar name, and the storage name. The set determiner 3248 further determines a conversion program that converts the electronic data to have a data format applicable to the specific device. The controller apparatus 3140 converts the electronic data to have the specified data format, and transmits the converted electronic data to the projector 3131 or the PC that is connected to the projector 3131, and the operation ends.

Alternatively, the controller apparatus 3140 may keep log information such as a device ID of a device that sends electronic data or user identification information of a user (attendant), in a predetermined memory area. When the controller apparatus 3140 determines that a device sending a data request allows sharing of the electronic data, the set determiner 3248 may refer to the log information to determine whether the electronic data to be processed has been transmitted to at least one device that sharing of the electronic data is not allowed. When it is determined that the electronic data has been transmitted to such device, the set determiner 3248 allows the requesting device to obtain the electronic data. In this manner, the data control system of FIG. 31 authenticates at least one use before transmitting the electronic data to the projector, thus improving the security even when the projector is set as a device having electronic data that can be shared.

As described above referring to FIGS. 31 to 40, the user at any desired apparatus is able to use the electronic data that is stored in the data control system to perform processing such as displaying the electronic data in a data format applicable to the desired apparatus currently operated by the user.

For example, at a meeting, the user may want to use electronic data stored in the data storage apparatus or electronic data stored in a local memory of an information processing apparatus that the user usually operates. In such case, the user usually reserves a meeting room by inputting various information such as a date/time of the meeting, beforehand. At the time of registering meeting information, the user may specify one or more electronic data to be used at the meeting. As long as the user specifies the date/time and the meeting room beforehand, the data control system automatically obtains the electronic data specified by the user when the system recognizes that the user is in the meeting room, and transmits the electronic data to a device currently operated by the user in a data format compatible with the currently-operated device and/or application that may be requested by the user using the currently-operated device. Accordingly, the user can easily obtain electronic data that is stored in the cloud, in a data format that is compatible with the currently-operated device or application to be performed at the currently-operated device. Further, since the data control system performs user authentication before transmitting the electronic data, the security level is kept high.

In any one of the examples described above referring to FIGS. 1 to 16, 17 to 23, 24 to 27, 28 to 30, and 31 to 40, authentication of a user is performed by the authenticator of the controller apparatus, which is implemented by a processor that operates in cooperation with a memory. Alternatively, authentication of a user may be performed by one or more computers or processors that function as an authentication server. In such case, the controller of the controller apparatus transmits authentication information such as user identification information, which is received from the information processing apparatus, to the authentication server to cause the authentication server to authenticate the user. The authentication server uses the association data stored in a memory functioning as the association data storage to authenticate the user to generate an authentication result. The controller of the controller apparatus receives the authentication result from the authenticating server, and transmits the authentication result to the information processing apparatus such as the image forming apparatus.

The authenticating server may be implemented by one or more computers each having a hardware structure described above referring to FIG. 2. More specifically, when executed by the authenticating control program, a processor of the general-purpose computer is caused to function as the authenticating server. The authenticating server may further include a memory, which functions as the association data storage that stores first authentication information and second authentication information in association with each other for each one of the users of the data control system.

Further, the authentication information that is used for authenticating a user is not limited to the user name and the password, but may additionally include an organization code of an organization to which the user belongs. For example, in case of communicating with the controller apparatus provided on the public network, the information processing apparatus provided on the private network may send authentication information including the organization code, the user name, and the password to the controller apparatus via a proxy server.

Further, data format conversion may be performed by any conversion program, which may be available on the network including one or more conversion programs that may be installed onto any devices or apparatuses provided outside the controller apparatus. In such case, the controller apparatus transmits a data format conversion request to the outside apparatus, with the electronic data to be processed or identification information indicating the electronic data to be processed. The controller apparatus receives converted electronic data, and sends the converted electronic data to the information processing apparatus.

For example, the data converter of the controller apparatus may be implemented by one or more computers that function as a rendering server, provided with a data transmit/receive, a conversion manager, and different types of conversion programs. When the data transmit/receive receives a data format conversion request, which includes data specific information of electronic data to be processed, and information indicating a conversion program that converts an original data format to a specific data format, the conversion manager manages the conversion process such that the original data format is converted to the specific data format using one or more conversion programs. Assuming that word document data in .doc format is converted to print data in PRCS, the conversion manager causes the electronic data to convert from doc to PDF using the “doc to PDF” conversion program, and further causes the electronic data to convert from PDF to PRCS using the “PDF to PRCS” conversion program. The conversion manager stores the converted electronic data in a memory, and transmits notification indicating that conversion is completed to the controller apparatus. In alternative to providing the conversion manager, any conversion program may be provided with the function of managing data format conversion.

Further, any one of the apparatuses included in the data control system may be provided within a country, or outside the country, as long as the data control system is able to process a request received from the user. Further, any one of the apparatuses included in the data control system may be provided by more than one services provider. For example, the data storage apparatuses including the email storage apparatus may be managed by different services providers. The authentication server may be provided by a services provider different from a services provider that provides the controller of the controller apparatus. The conversion programs, or the converters, may be managed by different services providers.

In any one of the examples described above referring to FIGS. 1 to 16, 17 to 23, 24 to 27, 28 to 30, and 31 to 40, one or more functions of the data control system may be performed by one or more modules, devices, or apparatuses that may be distributed over a network, such that one or more processors functioning as controllers, which may be distributed over the network, may together perform the functions of the data control system.

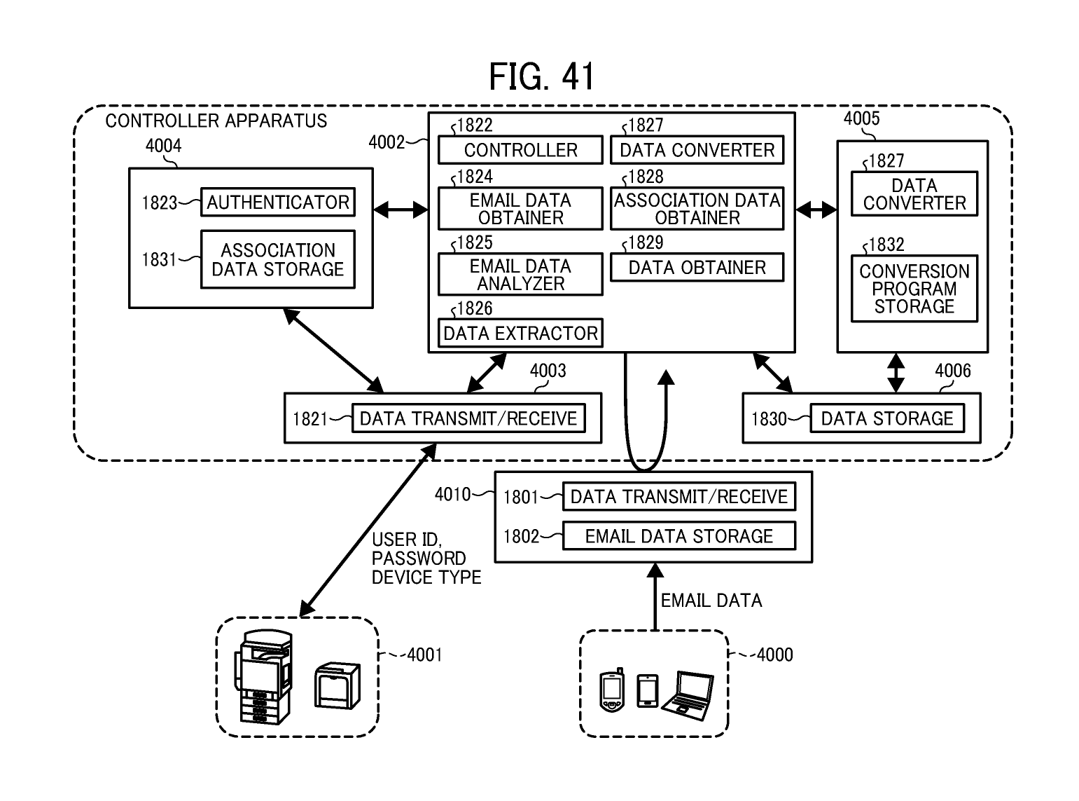

For example, the controller apparatus may be implemented by a plurality of computers each functioning as a server that performs specific function. Referring now to FIG. 41, an example configuration of the data control system of FIGS. 17 to 23, when the controller apparatus 1702 is implemented by a plurality of servers, is explained according to an example embodiment of the present invention. The data control system of FIG. 41 includes information processing apparatuses 4000 and 4001, an email server 4010, a data processing server 4002, an access control server 4003, an authentication server 4004, a rendering server 4005, and a database server 4006.

The email server 4010 functions as the email data storage apparatus 1710 (FIG. 18). More specifically, the email server 4010 is provided with a processor, a memory, and a network interface, which function as the data transmit/receive 1801 and the email data storage 1802.

The first information processing apparatus 4000 functions as an information processing apparatus through which the user transmits email data to the email server 4010. The second information processing apparatus 4001 functions as the image forming apparatus 1701 to which the user requests for electronic data. Examples of the information processing apparatus include, but not limited to, a personal computer (PC), portable phone such as smart phone, tablet such as iPad (Registered Trademark), digital camera, any other personal digital assistant (PDA), an image forming apparatus such as a MFP, and any other desired apparatus.

The data processing server 4002, the access control server 4003, the authentication server 4004, the rendering server 4005, and the database server 4006 together function as the controller apparatus 1702.

The data processing server 4002 is provided with a processor, a memory, and a network interface, which function as the controller 1822, the email data obtainer 1824, the email data analyzer 1825, the email data extractor 1826, at least a part of the data converter 1827, the association data obtainer 1829, and the electronic data obtainer 1829. The access control server 4003, which functions as the data transmit/receive 1821, may be implemented by, for example, a login user interface, a reverse proxy, and a relay API.

The authentication server 4004 is provided with a processor, a memory, and a network interface, which function as the authenticator 1823 and the association data storage 1831. The rendering server 4005 is provided with a processor, a memory, and a network interface, which function as at least a part of the data converter 1827 and the conversion program storage 1832. The database server 4006 is provided with a processor, a memory, and a network interface, which function as the electronic data storage 1830.

In example operation, the user transmits email data to the email server 4010 through the information processing apparatus 4000. The email data specifies electronic data to be processed and application to be applied to the electronic data. The email server 4010 stores the email data, which is received through the data transmit/receive 1801, in the email data storage 1802.

The email data obtainer 1824 of the data processing server 4002 periodically polls the email data from the email server 4010 as described above referring to S1901 to S1904 of FIG. 19. The email data extractor 1826 of the data processing server 4002 extracts electronic data to be processed, from the email data obtained by the email data obtainer 1824, as described above referring to S1907 of FIG. 19. The electronic data to be processed may be attached or linked to the email data.

The email data analyzer 1825 analyzes the email data to set condition information of the electronic data that may be used to process the electronic data, as described above referring to S1910 of FIG. 19. In case there is no condition information in the email data, the email data analyzer 1825 may determine to use default parameter values, which may be previously set by the user and stored in association with the user identification information. For example, the user may previously send the default settings information to the data processing server 4002. The data processing server 4002 may store the default settings information in association with the user authentication information.

The controller 1822 stores, in the electronic data storage 1830 of the database server 4006, information regarding the electronic data to be processed, and the electronic data to be processed in association with each other. More specifically, the electronic data storage 1830 stores, for the electronic data to be processed, the sender address information and data identification information in association with each other. The sender address information of the user who sends the email data may be obtained from the email data.

The data transmit/receive 1821 of the access control server 4003 receives the user authentication information, such as the user identification information including the user ID and the password, from the user at the information processing apparatus 4001 through a network, and sends an authentication request to the authentication server 4004 with the user authentication information.

The authenticator 1832 of the authentication server 4004 determines whether the user is an authenticated user, using the association data stored in the association data storage 1831. When the user is authenticated, the authentication server 4004 sends an authentication result to the data transmit/receive 1821 of the access control server 4003. Based on the authentication result indicating that authentication is successful, the data transmit/receive 1821 of the access control server 4003 transmits a request for obtaining a data list to the controller 1822 of the data processing server 4002 with the user authentication information received from the user at the information processing apparatus 4001.

The controller 1822 of the data processing server 4002 instructs the association data obtainer 1828 to obtain the user address information that is associated with the user authentication information obtained from the data transmit/receive 1821. More specifically, the association data obtainer 1828 of the data processing server 4002 sends a request for the user address information that matches the received user authentication information to the authentication server 4004. The authentication server 4004 sends the user address information that matches the received user authentication information to the association data obtainer 1828 of the data processing server 4002.

The controller 1822, which receives the user address information, instructs the electronic data obtainer 1829 to obtain one or more data files of the electronic data that are stored in the electronic data storage 1830 of the database server 4006 in association with the user address information. The controller 1822 generates a data list, which lists information regarding the obtained data files, and sends the data list to the information processing apparatus 4001 through the data transmit/receive 1821 of the access control server 4003.

As described above, the data list may include information regarding a data format of the electronic data that is compatible with the information processing apparatus 4001 that sends the request. For example, at any desired time after storing the electronic data to be processed in the electronic data storage 1830 of the database server 4006, the controller 1822 of the data processing server 4002 instructs the data converter 1827 to determine a data format of the electronic data, which is compatible with the information processing apparatus 4001. The data format compatible with the information processing apparatus 4001 may be determined based on the device specific information of the information processing apparatus 4001, such as the device type information. Alternatively or additionally, the data format compatible with the information processing apparatus 4001 may be determined based on information obtainable from the email data to which the electronic data is attached or linked. The data converter 1827 controls a process of converting the obtained electronic data to cause the obtained electronic data to have the determined data format. For example, the data converter 1827 further selects a conversion program, which is capable of converting the electronic data to have the determined data format, for example, by referring to information stored in the conversion program storage 1832. This process of determining a data format compatible with the information processing apparatus 4001 and selecting a conversion program may be performed in a substantially similar manner as described above referring to FIGS. 12A to 12C.

When the information processing apparatus 4001 receives a user request that specifies at least one electronic data file from the data list, the information processing apparatus 4001 sends a request for obtaining the specified electronic data file to the data processing server 4002 through the access control server 4003. The request may further include information regarding a specific data format of the electronic data. The controller 1822 of the data processing server 4002 requests the data converter 1827 to obtain the specified electronic data file from the database server 4006, and convert the specific electronic data to have a data format requested by the information processing apparatus 4001 using the selected conversion program. The controller 1822 of the data processing server 4002 sends the converted electronic data to the information processing apparatus 4001 through the data transmit/receive 1821 of the access control server 4003.

In alternative to converting the specific electronic data when the user request is received, the controller 1822 of the data processing server 4002 may instruct the data converter 1827 to convert the electronic data to have the determined data format at any desired time after the electronic data to be processed is stored in the database server 4006. In such case, the data converter 1827 requests the data converter 1827 of the rendering server 4005 to convert specific electronic data to have a specific data format, one by one, in an order that the electronic data is stored. The rendering server 4005 converts the electronic data to have the determined data format using the selected conversion program, and stores the converted electronic data in the electronic data storage 1830 in association with information indicating the electronic data to be processed such as the data identification information.

For example, assuming that the data processing server 4002 applies print processing to the electronic data, the rendering server 4005 may convert the electronic data in .doc format to the electronic data in .pdf format, and the electronic data in .pdf format to the electronic data in .prcs format.

In any one of the above-described examples, any one of the above-described memories or storage devices may be provided anywhere on the network as long as various data stored therein is available to one or more processors that perform operations.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, any of the above-described devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in: a control system including a data storage apparatus that stores one or more files of electronic data, an information processing apparatus, and a controller apparatus that transmits electronic data obtained from the data storage apparatus to the information processing apparatus, which are connected through a network. The information processing apparatus includes specific data transmitting means for transmitting application specific information that specifies application of the electronic data and data specific information that specifies the electronic data. The controller apparatus includes electronic data receiving means for receiving information regarding one or more files of electronic data stored in the data storage apparatus; specific data receiving means for receiving the application specific information and the data specific information that are transmitted from the information processing apparatus; data conversion requesting means for requesting data converting means to convert the electronic data that is specified using the data specific information received by the specific data receiving means to have a data format that is determined based on the application specific information; electronic data obtaining means for obtaining converted electronic data having the converted data format converted by the data converting means; and electronic data transmitting means for transmitting the converted electronic data to the information processing apparatus.

For example, the specific data transmitting means of the information processing apparatus corresponds to a data transmit/receive of the information processing apparatus, such as a network interface. The electronic data receiving means of the controller apparatus corresponds to a data transmit/receive and an electronic data obtainer, such as a network interface that operates under control of a processor such as a CPU. The specific data receiving means corresponds to the data transmit/receive such as the network interface. The data conversion requesting means of the controller apparatus corresponds to the controller, such as the CPU. The data converting means corresponds to a data converter, which may be implemented by a processor such as the CPU. The electronic data obtaining means corresponds to the controller, such as the CPU. The electronic data transmitting means corresponds to the data transmit/receive such as the network interface.

In another example, the present invention may reside in a controller apparatus, which is connected to a data storage apparatus provided with data storage means for storing one or more files of electronic data, and an information processing apparatus provided with specific data transmitting means for transmitting application specific information specifying application of electronic data and data specific information specifying the electronic data, through a network. The controller apparatus includes: electronic data receiving means for receiving one or more files of electronic data stored in the data storage apparatus; specific data receiving means for receiving the application specific information and the data specific information that are transmitted by the specific data transmitting means of the information processing apparatus; data conversion requesting means for requesting data converting means to convert the electronic data that is specified using the data specific information received by the specific data receiving means to have a data format that is determined based on the application specific information; electronic data obtaining means for obtaining converted electronic data having a data format converted by the data converting means; and electronic data transmitting means for transmitting the converted electronic data to the information processing apparatus.

In another example, the controller apparatus further includes: storing means for storing conversion data format information indicating the association between a type of the information processing apparatus and a data format that is applicable to the type of the information processing apparatus; and a data format specifying means for specifying a data format to which the electronic data is converted based on the conversion data format information. The specific data receiving means receives information regarding the type of the information processing apparatus. The data conversion requesting means requests the data converting means to convert the electronic data to have the data format specified by the data format specifying means.

For example, the storing means corresponds to a conversion program storage, which may be implemented by any desired memory of the controller apparatus. The data format specifying means corresponds to the electronic data obtainer, which may be implemented by the processor such as the CPU.

In another example, the controller apparatus includes storing means for storing convertible data format information regarding a data format to which the data format of the electronic data can be converted; and conversion determination means for determining whether the electronic data can be converted to a data format applicable to the information processing apparatus based on the conversion data format information and the convertible data format information. When the conversion determination means determines that the electronic data can be converted to the data format applicable to the information processing apparatus, the data conversion requesting means requests the data converting means to convert the electronic data.

For example, the storing means corresponds to a conversion program storage, which may be implemented by any desired memory of the controller apparatus. The conversion determination means corresponds to the electronic data obtainer, which may be implemented by the processor such as the CPU.

The controller apparatus further includes electronic data extracting means for extracting the electronic data to be converted by the data converting means using data transmitted from the data storage apparatus. The data conversion requesting means requests the data converting means to convert a data format of the extracted electronic data extracted by the electronic data extracting means. For example, the electronic data extracting means corresponds to a data extractor, which may be implemented by the processor such as the CPU.

The controller apparatus further includes condition obtaining means for analyzing the data transmitted from the data storage apparatus and obtaining condition information indicating conditions under which the converted electronic data is generated. The data conversion requesting means requests the data converting means to convert the electronic data to the converted data based on the condition information. For example, the condition obtaining means of the controller apparatus corresponds to an email data analyzer, which may be implemented by the processor such as the CPU.

The controller apparatus further includes authentication information receiving means for receiving first identification information to be used for user authentication from the information processing apparatus. The data conversion requesting means requests the data converting means to convert the electronic data specified based on the first identification information. For example, the authentication information receiving means corresponds to the data transmit/receive of the controller apparatus, such as network interface.

The controller apparatus further includes: association data storing means for storing association data indicating the association between the first identification information and second identification information that specifies electronic data that is available to the user; and data specific information obtaining means for obtaining the second identification information that is associated with the first identification information received from the information processing apparatus based on the association data. The data conversion requesting means requests the data converting means to convert the electronic data identified based on the second identification information. For example, the storing means corresponds to the association data storage, which may be implemented by any desired memory of the controller apparatus. The data specific information obtaining means corresponds to an association data obtainer, the controller, and the data transmit/receive of the controller apparatus.

The controller apparatus further includes: authenticating means for authenticating a user based on the first identification information; determination request transmitting means for transmitting the second identification information that is associated with the first identification information when an authentication result generated by the authenticating means indicates that authentication is successful and requesting the data storage apparatus to determine whether the electronic data can be obtained; determination result receiving means for receiving a determination result from the data storage apparatus; and notifying means for notifying the information processing apparatus of authentication failure when the authentication result indicates that authentication by the authenticating means fails or when the determination result indicates that the electronic data cannot be obtained. The association data stored in the associated data storing means further stores storage information indicating a place from which the electronic data is obtained in association with the second identification information that specifies the first electronic data. The electronic data obtaining means obtains the electronic data from the data storage apparatus that transmits the determination result indicating that the electronic data can be obtained.

For example, the authenticating means corresponds to an authenticator, which may be implemented by the processor such as the CPU. The determination request transmitting means corresponds to the controller and the data transmit/receive of the controller apparatus, which may be implemented by the network interface that operates under control of the processor such as the CPU. The determination result receiving means corresponds to the controller and the data transmit/receive of the controller apparatus, which may be implemented by the network interface that operates under control of the processor such as the CPU. The notifying means corresponds to the controller and the data transmit/receive of the controller apparatus, which may be implemented by the network interface that operates under control of the processor such as the CPU.

The present invention may reside in a control program, which is installed onto a computer, connected to a data storage apparatus provided with data storage means for storing one or more files of electronic data and an information processing apparatus provided with specific data transmitting means for transmitting application specific information indicating application of the electronic data and data specific information indicating the electronic data, through a network. The control program, when executed by the computer, causes the computer to perform: receiving information regarding one or more files of electronic data stored in the data storage apparatus; receiving the application specific information and the data specific information from the specific data transmitting means of the information processing apparatus; requesting for conversion of the electronic data that is specified by the data specific information to have a data format determined based on the application specific information; obtaining converted electronic data having the converted data format; and transmitting the converted electronic data to the information processing apparatus.

In another example, the present invention may reside in a first controller configured to communicate with at least a second controller such that the first and second controllers are cooperatively configured to: obtain first authentication information of at least one of a plurality of users from an information processing apparatus through a network; obtain second authentication information of the at least one of the plurality of users using association data indicating an association between first authentication information and second authentication information for each of the plurality of users, the second authentication information being associated with the obtained first authentication information of the at least one of the plurality of users; obtain electronic data associated with the second authentication information of the at least one of the plurality of users using electronic data stored in a storage apparatus; determine a data format of the obtained electronic data, the determined data format of the obtained electronic data being compatible with the information processing apparatus; and control a process of converting the obtained electronic data to cause the obtained electronic data to have the determined data format.

The at least first and second controllers are cooperatively configured to send information indicating the obtained electronic data having the determined data format to the information processing apparatus for display to the user.

The at least first and second controllers are cooperatively configured to obtain data specific information indicating specific electronic data selected from the obtained electronic data, and application specific information indicating specific application of the specific electronic data requested by the information processing apparatus, and transmit converted electronic data having a data format compatible with the specific application, the converted electronic data being generated by converting the specific electronic data using a conversion program that is previously selected.

The at least first and second controller are cooperatively configured to request the selected conversion program to convert the obtained electronic data to have the determined data format, before receiving the data specific information and the application specific information.

The electronic data stored in the storage apparatus is email data transmitted from the at least one of the plurality of users through an information processing apparatus, and the at least first and second controllers are cooperatively configured to extract electronic data attached to or linked to the email data stored in the storage apparatus and to store the extracted electronic data in association with the second authentication information of the at least one of the plurality of users who sends the email data to the email storage apparatus, the stored extracted electronic data being obtained for data format conversion.

The second authentication information of the at least one of the plurality of users is sender address information indicating an email address of the plurality of users.

The at least first and second controllers are cooperatively configured to extract, from the email data, condition information indicating parameter values to be used for processing the extracted electronic data, and to store the condition information in association with the second authentication information of the at least one of the plurality of users.

The at least first and second controller are cooperatively configured to receive device type information indicating a device type of the information processing apparatus, from the information processing apparatus, and specify a data format compatible with the information processing apparatus using the device type information to determine the data format of the obtained electronic data.

In one example, the present invention may reside in a controller apparatus, comprising: a first network interface configured to exchange data with an authentication apparatus; a second network interface configured to exchange data with a data storage apparatus that stores electronic data; and a first processor configured to share processing with a second processor of the authentication apparatus, each processor performing a portion of the processing so that together the first and second processors are configured to: (1) obtain first authentication information of at least one of a plurality of users from an information processing apparatus through a network; and (2) obtain second authentication information of the at least one of the plurality of users using association data indicating an association between first authentication information and second authentication information for each of the plurality of users, the second authentication information being associated with the obtained first authentication information of the at least one of the plurality of users, wherein the first processor is further configured to share processing with a third processor of the data storage apparatus, each processor performing a portion of the processing so that together the first and third processors are configured to: (3) obtain electronic data associated with the second authentication information of the at least one of the plurality of users using the electronic data stored in the storage apparatus; (4) determine a data format of the obtained electronic data, the determined data format of the obtained electronic data being compatible with the information processing apparatus; and (5) control a process of converting the obtained electronic data to cause the obtained electronic data to have the determined data format.

In one example, the present invention may reside in: a data control system, comprising: a storage apparatus configured to store electronic data; and a controller apparatus connected to the storage apparatus through a network, the controller apparatus including: a network interface configured to obtain first authentication information of the at least one of the plurality of users from an information processing apparatus through the network; and a processor. The processor is configured to: obtain second authentication information of the at least one of the plurality of users using association data indicating an association between first authentication information and second authentication information for each of the plurality of users, the second authentication information being associated with the obtained first authentication information of the at least one of the plurality of users; obtain electronic data associated with the second authentication information of the at least one of the plurality of users using the electronic data stored in the storage apparatus; determine a data format of the obtained electronic data, the determined data format of the obtained electronic data being compatible with the information processing apparatus; and control a process of converting the obtained electronic data to cause the obtained electronic data to have the determined data format.

The data control system may further include: an authentication apparatus connected to the controller apparatus, wherein the authentication apparatus includes: a memory configured to store the association data indicating the association between the first authentication information and the second authentication information; and a processor configured to determine whether the user at the information processing apparatus is authenticated using the first authentication information of the user that is received from the controller apparatus, and to send the second authentication information of the user to the controller apparatus when the first authentication information of the user indicates that the user is authenticated.

The data storage apparatus includes: a memory to store the electronic data in association with the second authentication information of the user; and a processor to determine whether use of the electronic data stored in the data storage apparatus or use of the data storage apparatus is allowed by the user, using the second authentication information of the user.

In one example, the present invention may reside in: a data control system, including: a data receiving device configured to receive first authentication information of at least one of a plurality of users from an information processing apparatus through a network; a first processing device configured to obtain second authentication information of at least one of the plurality of users using association data indicating an association between first authentication information and second authentication information for each of the plurality of users, the second authentication information being associated with the obtained first authentication information of the at least one of the plurality of users; a second processing device configured to obtain electronic data associated with the second authentication information of the at least one of the plurality of users using electronic data stored in a storage apparatus; and a third processing device configured to determine a data format of the obtained electronic data being compatible with the information processing apparatus, and to control a process of converting the obtained electronic data to cause the obtained electronic data to have the determined data format.

In one example, the present invention may reside in a non-transitory recording medium storing a plurality of instructions which, when executed by a processor, cause the processor to perform a method of controlling electronic data stored in a storage apparatus, the method comprising: obtaining first authentication information of the at least one of the plurality of users from an information processing apparatus through a network; obtaining second authentication information of the at least one of the plurality of users using association data indicating an association between first authentication information and second authentication information for each of the plurality of users, the second authentication information being associated with the obtained first authentication information of the at least one of the plurality of users; obtaining electronic data associated with the second authentication information of the at least one of the plurality of users using the electronic data stored in the storage apparatus; determining a data format of the obtained electronic data, the determined data format of the obtained electronic data being compatible with the information processing apparatus; and controlling a process of converting the obtained electronic data to cause the obtained electronic data to have the determined data format.

What is claimed is:

1. A controller apparatus connected to a storage apparatus that stores electronic data, the controller apparatus comprising:
a network interface configured to obtain first authentication information of the at least one of the plurality of users from an information processing apparatus through a network; and
a processor configured to:
obtain second authentication information of the at least one of the plurality of users using association data indicating an association between first authentication information and second authentication information for each of the plurality of users, the second authentication information being associated with the obtained first authentication information of the at least one of the plurality of users;
obtain electronic data associated with the second authentication information of the at least one of the plurality of users using the electronic data stored in the storage apparatus;
determine a data format of the obtained electronic data, the determined data format of the obtained electronic data being compatible with the information processing apparatus; and
control a process of converting the obtained electronic data to cause the obtained electronic data to have the determined data format.

2. The controller apparatus of claim 1, wherein
the network interface sends information indicating the obtained electronic data having the determined data format to the information processing apparatus for display to the user.

3. The controller apparatus of claim 2, wherein
the network interface is further configured to obtain data specific information indicating specific electronic data selected from the obtained electronic data, and application specific information indicating specific application of the specific electronic data requested by the information processing apparatus, and
the processor is further configured to transmit converted electronic data having a data format compatible with the specific application, the converted electronic data being generated by converting the specific electronic data using a conversion program that is previously selected by the processor.

4. The controller apparatus of claim 3, wherein the processor is further configured to,
request the selected conversion program to convert the obtained electronic data to have the determined data format, before the network interface receives the data specific information and the application specific information.

5. The controller apparatus of claim 3, wherein
the electronic data stored in the storage apparatus is email data transmitted from the at least one of the plurality of users through an information processing apparatus, and
the processor is further configured to extract electronic data attached to or linked to the email data stored in the storage apparatus and to store the extracted electronic data in association with the second authentication information of the at least one of the plurality of users who sends the email data to the email storage apparatus, the stored extracted electronic data being obtained by the processor for data format conversion.

6. The controller apparatus of claim 5, wherein the second authentication information of the at least one of the plurality of users is sender address information indicating an email address of the at least one of the plurality of users.

7. The controller apparatus of claim 5, wherein
the processor is further configured to extract, from the email data, condition information indicating parameter values to be used for processing the extracted electronic data, and to store the condition information in association with the first authentication information or the second authentication information of the at least one of the plurality of users.

8. The controller apparatus of claim 3, wherein
the network interface is further configured to receive device type information indicating a device type of the information processing apparatus, from the information processing apparatus, and
the processor is further configured to specify a data format compatible with the information processing apparatus using the device type information to determine the data format of the obtained electronic data.

9. A data control system comprising:
at least a first controller and a second controller, the at least first and second controllers configured to communicate such that the at least first and second controllers are cooperatively configured to,
obtain first authentication information of at least one of a plurality of users from an information processing apparatus through a network,
obtain second authentication information of the at least one of the plurality of users using association data indicating an association between first authentication information and second authentication information for each of the plurality of users, the second authentication information being associated with the obtained first authentication information of the at least one of the plurality of users,
obtain electronic data associated with the second authentication information of the at least one of the plurality of users using electronic data stored in a storage apparatus,
determine a data format of the obtained electronic data, the determined data format of the obtained electronic data being compatible with the information processing apparatus, and
control a process of converting the obtained electronic data to cause the obtained electronic data to have the determined data format.

10. A method of controlling electronic data stored in a storage apparatus, the method comprising:
obtaining first authentication information of the at least one of the plurality of users from an information processing apparatus through a network;
obtaining second authentication information of the at least one of the plurality of users using association data indicating an association between first authentication information and second authentication information for each of the plurality of users, the second authentication information being associated with the obtained first authentication information of the at least one of the plurality of users;
obtaining electronic data associated with the second authentication information of the at least one of the plurality of users using the electronic data stored in the storage apparatus;
determining a data format of the obtained electronic data, the determined data format of the obtained electronic data being compatible with the information processing apparatus; and
controlling a process of converting the obtained electronic data to cause the obtained electronic data to have the determined data format.

11. The method of claim 10, further comprising:
sending information indicating the obtained electronic data having the determined data format to the information processing apparatus for display to the user.

12. The method of claim 11, further comprising:
obtaining data specific information indicating specific electronic data selected from the obtained electronic data, and application specific information indicating specific application of the specific electronic data requested by the information processing apparatus; and
transmitting converted electronic data having a data format compatible with the specific application, the converted electronic data being generated by converting the specific electronic data using a conversion program that is previously selected.

13. The method of claim 12, further comprising:
requesting the selected conversion program to convert the obtained electronic data to have the determined data format, before the step of receiving receives the data specific information and the application specific information.

14. The method of claim 12, wherein the electronic data stored in the storage apparatus is email data transmitted from the at least one of the plurality of users through an information processing apparatus, the method further comprising:
extracting electronic data attached to or linked to the email data; and
storing the extracted electronic data in association with the second authentication information of the at least one of the plurality of users who sends the email data to the email storage apparatus, the stored extracted electronic data being obtained for data format conversion.

15. The method of claim 14, wherein the second authentication information of the at least one of the plurality of users is sender address information indicating an email address of the at least one of the plurality of users.

16. The method of claim 14, further comprising:
extracting, from the email data, condition information indicating parameter values to be used for processing the extracted electronic data; and
storing the condition information in association with the first authentication information or the second authentication information of the at least one of the plurality of users.

17. The method of claim 12, further comprising:
obtaining device type information indicating a device type of the information processing apparatus, from the information processing apparatus; and
specifying a data format compatible with the information processing apparatus using the device type information to determine the data format of the obtained electronic data.
